(19) United States
(12) Patent Application Publication
(10) Pub. No.: US 2024/0413330 A1
(43) Pub. Date: Dec. 12, 2024

(54) FUNCTIONALIZED PRE-LITHIATION PARTICLES FOR LITHIUM-ION BATTERIES

(71) Applicant: Sila Nanotechnologies, Inc., Alameda, CA (US)

(72) Inventors: Sung Hyun LIM, Mountain View, CA (US); Thomas Robert PORTER, Alameda, CA (US); Gleb Nikolayevich YUSHIN, Atlanta, GA (US)

(21) Appl. No.: 18/738,353

(22) Filed: Jun. 10, 2024

Related U.S. Application Data
(60) Provisional application No. 63/507,192, filed on Jun. 9, 2023.

(51) Int. Cl. H01M 4/583; H01M 4/02; H01M 4/04; H01M 4/1393; H01M 4/1395; H01M 4/38; H01M 10/0525; H01M 10/058; H01M 10/44

(52) U.S. Cl. CPC H01M 4/583; H01M 4/0404; H01M 4/0471; H01M 4/1393; H01M 4/1395; H01M 4/386; H01M 10/0525; H01M 10/058; H01M 10/446; H01M 2004/027

(57) ABSTRACT

An anode dispersion, which may be used in forming an anode of a lithium-ion battery, is disclosed. The anode dispersion includes: (1) primary anode active particles (PAAPs) that each include silicon (Si) and carbon (C), (2) functionalized pre-lithiation particles (FPLiPs) including lithium (Li), and (3) a solvent composition in which the PAAPs and FPLiPs are dispersed. In some embodiments, a mass ratio of the PAAPs to the FPLiPs is in a range of about 10:1 to about 200:1. In some embodiments, each of the FPLiPs includes a core and an outer protective coating around the core, with the outer protective coating including an oligomeric and/or a polymeric dispersant. Additionally, methods of making an anode, methods of making a lithium-ion battery, methods of making an anode-separator laminate, anodes, lithium-ion batteries, and anode-separator laminates are disclosed.

### CROSS-REFERENCE TO RELATED APPLICATIONS

The present application for patent claims the benefit of U.S. Provisional Application No. 63/507,192, entitled “FUNCTIONALIZED PRE-LITHIATION PARTICLES FOR LITHIUM-ION BATTERIES WITH SILICON-CARBON COMPOSITE MATERIALS,” filed Jun. 9, 2023, which is assigned to the assignee hereof, and expressly incorporated herein by reference in its entirety.

### BACKGROUND

### Field

Aspects of the present disclosure relate generally to energy storage devices, and more particularly to battery technology and the like.

### Background

Advanced rechargeable batteries are highly sought after for various applications, including consumer electronics, electric vehicles, grid storage, and more. In particular, Li-ion batteries have become a dormant technology in many applications. This is due in part to their high energy densities, lightweight design, potential for long lifetimes, and relatively high specific energy.

However, despite their increasing commercial prevalence, further development is necessary for wider adoption in a variety of applications, such as low- or zero-emission hybrid, electric vehicles, consumer electronics, wearable devices, energy-efficient cargo ships and locomotives, drones, aerospace applications, and power grids. In particular, further improvements are desired for various rechargeable batteries, such as rechargeable Li and Li-ion batteries, rechargeable Na and Na-ion batteries, and rechargeable K and K-ion batteries, to name a few.

Currently, Li-ion batteries mainly use carbon-based materials, such as graphite, as the primary anode material. Graphite has a theoretical maximum specific Li capacity of approximately 372 milliampere hours per gram (mAh/g). In addition, some of the Li is irreversibly lost during formation cycling. This limited performance of carbon-based anode materials is a notable disadvantage in conventional Li-ion batteries.

Researchers have investigated various higher-capacity materials to overcome these limitations. Among them, silicon-based materials have received significant attention as potential anode materials due to their specific capacities that are an order of magnitude greater than that of conventional graphite. Silicon has the highest theoretical specific capacity of all non-Li elements, reaching approximately 3600 mAh/g. However, silicon also suffers from significant drawbacks of its own.

In certain types of Li metal and Li-ion rechargeable batteries, charge storing anodes may comprise silicon (Si)-comprising anode particles with gravimetric capacities in the range from about 800 mAh/g to about 3000 mAh/g (per mass of Si-comprising anode particles in a Li-free state, whereby “Li-free” means free of electrochemically-active lithium that is available for cycling, such that Li that is not electrochemically-active or electrochemically-active Li that is contained in a shell and is not yet released into the cell may be included without an associated material losing an otherwise Li-free characterization). A subset of such anodes includes anodes with an electrode layer exhibiting capacity in the range from about 400 mAh/g to about 2800 mAh/g (per mass of the electrode layer, not counting the mass of the current collector, in a Li-free state). Such a class of charge-storing anodes offers great potential for increasing gravimetric and volumetric energy of rechargeable batteries.

In certain types of rechargeable batteries, charge storing anode active material particles may be produced as high-capacity (nano)composite (e.g., dry) powders (e.g., comprising active material nanomaterials or nanostructures that may be embedded on and/or in a porous structure, such as a C-comprising matrix material), which exhibit moderately high volume changes (e.g., about 8-240 vol. % or about 8-180 vol. %) during the first charge-discharge cycle and moderate volume changes (e.g., about 5-70 vol. % or about 5-50 vol. %) during the subsequent charge-discharge cycles, as measured using thickness measurements of the battery. At least a subset of such charge-storing anode particles includes anode particles with an average size (e.g., diameter or thickness) in the range of about 0.2 to about 40 microns (micrometers, or μm), as measured using laser particle size distribution analysis (LPSA), laser image analysis, electron microscopy, optical microscopy, or other suitable techniques. Such a class of charge-storing particles offers great promises for scalable manufacturing and achieving high cell-level energy density and other performance characteristics.

One of the main limitations of using Si-based anode materials is the significant volume expansion and contraction that occurs during lithium-ion alloying and dealloying, when the battery is charged and discharged, respectively. In some cases, the volume of the silicon-based anode may increase by up to about 400% and then decrease. The high level of strain placed on the anode material may result in irreversible mechanical damage, leading to mechanical stress, structural degradation, and poor cycling performance. In some designs, a Si-dominant composite anode (e.g., dry) powder which is designed to accommodate the expansion and contraction that occurs during charging and discharging cycles may be utilized. In some designs, a Si-dominant composite anode powder may be utilized to reduce or minimize irreversible first cycle capacity losses and improve the stability and cycle life of the battery, while also increasing its energy density and rate performance.

Despite the advancements in anode materials, however, there is a demand to further improve Li-ion battery performance, including further improving stability and energy density (or reversible capacity).

To increase the capacity of the lithium-ion battery cell, additives (also known as lithium supplements) may be utilized to increase the amount of electrochemically active lithium in the battery (also known as lithium inventory), thereby increasing the cell energy density. Electrochemically active lithium is defined as lithium which may be transported to different electrodes of the battery via an applied voltage.

In some cases, electrochemically active lithium may be added to the cell by mixing or electrochemically alloying or adding (by means other than alloying) lithium metal directly onto the anode of the battery, where the lithium may react with the anode and form lithiated material. This process is known as a pre-lithiation of the anode. However, this approach requires a complicated setup, including production and handling of metallic lithium in powdered form, which is highly unstable against water (e.g., moisture) in ambient conditions. Due to the low potential of the lithium insertion reaction into silicon-comprising or carbon-comprising anodes (as measured via an open circuit potential measurement at a given lithium concentration in an electrochemical cell with lithium metal (Li/Li⁺) as a reference electrode), there exists very few materials which allow for spontaneous transfer of lithium atoms from the supplemental material to the anode. Because of the difficulties of adding lithium chemically to the anode, alternative approaches are needed to obtain the benefits of added lithium inventory.

Lithium metal has attractive properties for use in pre-lithiation additives. One attractive property of lithium metal is its high specific capacity of 3860 mAh/g. Another attractive property is that if all of the lithium ions are used in the pre-lithiation process, no residue remains after the pre-lithiation. Yet another attractive property is the ease with which the amount of lithium added may be controlled, either to pre-lithiate to compensate for initial capacity loss or to fully pre-lithiate to match a non-lithiated cathode, such as metal fluorides (e.g., FeF₃). However, due to its higher chemical reactivity, lithium metal is difficult to use in practical operations. Stabilized lithium metal powders (abbreviated as “SLMP”, which in some designs may each be a round particle of about 29 μm in diameter) formed by passivating lithium metal particles with a coating layer, e.g., Li₂CO₃, have been reported (Yangxing Li and Brian Fitch, “Effective enhancement of lithium-ion battery performance using SLMP,” Electrochemistry Communications 13 (2011) 664-667). Alternatively, an organic-coated lithium powder (an example shown is a round particle of about 50 μm in diameter) has been reported (Jennifer Heine, Steffen Kruger, Christoph Hartnig, Ulrich Wietelmann, Martin Winter, and Peter Bieker, “Coated Lithium Powder (CLiP) Electrodes for Lithium-Metal Batteries,” Adv. Energy Mater. 2014, 4, 1300815). More recently, in 2019, a safer process of making nanoscaled Li metal powders (<500 nm in diameter) by cryomilling with a high-melting point ionic liquid as a protective measure for Li during the milling has been reported (Kaichao Pu, Xiaolei Qu, Xin Zhang, Jianjiang Hu, Changdong Gu, Yongjun Wu, Mingxia Gao, Hongge Pan, and Yongfeng Liu, “Nanoscaled Lithium Powders with Protection of Ionic Liquid for Highly Stable Rechargeable Lithium Metal Batteries,” Adv. Sci. 2019, 6, 1901776). The properties and composition of the sealing material in lithium metal powder may play an essential role in optimizing the anode capacity.

In other cases, extra lithium (i.e., electrochemically-active lithium) may be added to the cathode, where the lithium is electrochemically moved from the cathode to the anode on the first charge, thereby replacing at least some of the electrochemically-active lithium which is lost to undesired chemical reactions on the anode on the first charge. Lithium that is added to the cathode is referred to as a cathode lithium supplement, or a supplemental cathode active material. Determining the amount of cathode lithium supplement to add to optimize energy density may be a complicated calculation involving many properties of the cathode and the anode. In some cases, the addition of some cathode lithium supplements may counter-intuitively result in limited performance improvements and increased costs. In some cases, the addition of some cathode lithium supplements may result in inferior performance (e.g., worse than the performance of comparable cells without the cathode lithium supplement).

Accordingly, there remains a need for improved batteries, components, and other related materials and manufacturing processes. Ultimately, the improved anodes may lead to the creation of more advanced Li-ion batteries that have the potential to transform numerous industries ranging from improved electronic devices, to ground, sea and air transportation, to grid storage.

### SUMMARY

Embodiments disclosed herein address the above-stated needs by providing improved Li-ion battery components, improved Li-ion batteries made therefrom, and methods of making and using the same.

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some embodiments, a Li-ion battery is provided that comprises (i) a cathode comprising suitable active cathode material particles, (ii) an anode comprising primary anode active particles (“PAAPs”), (iii) an electrolyte ionically coupling the anode and the cathode, a separator electrically separating the anode and the cathode, and functionalized pre-lithiation particles (“FPLiPs”) incorporated into the anode electrode. In some designs, the suitable primary anode active particles may comprise silicon. In some designs, the suitable primary anode active particles may comprise silicon and carbon. In some designs, the suitable silicon-comprising and carbon-comprising primary anode active particles may be nanocomposites (e.g., Si—C nanocomposites). In some designs, such Si—C nanocomposites may comprise Si nanoparticles with volume-average particle size in the range from about 2 nm to about 200 nm. In some designs, such Si—C nanocomposites may be porous. In some designs, such Si—C nanocomposites may comprise an active material core and a protective sealing surface layer at least partially encasing the active materials core, where the protective coating comprises a material that is impermeable to gas and/or water and/or electrolyte solvent molecules.

The FPLiP may be incorporated into the suitable anodes according to one of the following designs: (i) being disposed into an active anode powder from which the anode is formed, (ii) being part of a polymer layer coated onto the active particles, (iii) being formed into the anode electrode from the (wet or dry) slurry mixture (e.g., together with primary anode active particles, additives and a suitable binder), (iv) being deposited onto the surface of the anode electrode (e.g., with or without a suitable binder); (v) being coated onto the separator surface that faces the anode (e.g., with or without a suitable binder); (vi) being coated onto the anode current collector surface (e.g., with or without a suitable binder; with or without conductive or other additives; in some designs, being thus disposed between the current collector and the anode active material layer); (vii) or a combination thereof. In any of these designs, the FPLiP may react chemically or electrochemically with the anode material (e.g., in a battery cell) to produce lithiated silicon-comprising (e.g., Si—C nanocomposite) material.

In some embodiments, the present invention disclosure provides a suitable composition and microstructure of FPLiP to attain the most desirable characteristics in applications.

In some embodiments, the present invention disclosure provides a suitable method for the fabrication of FPLiP to attain the desirable structural and chemical characteristics and good performance in applications.

In some embodiments, a method for safely and controllably dispersing a sealed lithium powder dispersion (FPLiP) is provided.

In some embodiments, the present invention disclosure provides an aerosol jet coating method for different FPLiP, which achieves a uniform and scalable coating of FPLiP on a primary active anode surface. Polymeric dispersion agents are introduced into the coating solution in some implementations to assist and maintain a uniform FPLiP dispersion for prolonged processing time and to act as adhesion-promotive additive(s) to adhere the FPLiP onto the anode or anode current collector surface. These FPLiP coatings may be easily activated by applying calendering pressure or during battery cell filling with electrolyte or operation. The pre-lithiation effect of aerosol-jet printed FPLiP achieved with some of the implementations of the present disclosure is demonstrated through the electrochemical performance in battery cells with anodes comprising Si—C composite particle and cathodes comprising (1) lithium nickel manganese cobalt oxide (NMC), (2) lithium cobalt oxide (LCO), and (3) lithium iron phosphate (LFP). The present disclosure provides a promising method for achieving a more uniform, scalable, and efficient pre-lithiation effect using aerosol coated FPLiP in lithium-ion electrochemical devices (e.g., lithium-ion batteries).

In still other embodiments, an improved anode design addresses the challenges associated with high-capacity anode materials, such as silicon, by providing a protective coating that is impermeable to electrolyte solvent molecules. This protective coating helps to mitigate the volume expansion and contraction of the active material core during the charge cycling of the battery, thereby improving the stability and performance of the anode. The use of a flexible protective coating material allows the anode to stretch during lithiation and contract during delithiation, while the use of a mechanically stable and plastically deformable shell further enhances the mechanical stability of the anode. The presence of at least one pore between the protective coating shell and the active material core also allows for volume changes to be accommodated during lithiation, thereby further improving the stability of the anode. The addition of a carbon-based layer between the protective coating shell and the active material core also provides additional mechanical stability and helps to promote the formation of a solid-electrolyte interphase layer.

In an aspect, an anode dispersion includes primary anode active particles (PAAPs) that each comprise silicon (Si) and carbon (C); functionalized pre-lithiation particles (FPLiPs) comprising lithium (Li); and a solvent composition in which the PAAPs and FPLiPs are dispersed; wherein: a mass ratio of the PAAPs to the FPLiPs is in a range of about 10:1 to about 200:1; each of the FPLiPs comprises a core and an outer protective coating around the core, the outer protective coating comprising an oligomeric dispersant and/or a polymeric dispersant; and a viscosity of the anode dispersion is in a range of about 1 cP to about 10,000 cP (in some designs, in a range of about 1 cP to about 1000 cP).

In some aspects, an average density of the FPLiPs is within about ±20% of an average density of the solvent composition.

In some aspects, the respective core of each of the FPLiPs comprises a non-Li element that is more dense than the Li.

In an aspect, a method of making an anode includes coating the anode dispersion on an anode current collector to form the anode on the anode current collector; and activating the FPLiPs.

In some aspects, the activating comprises a heat treatment and/or a pressure treatment.

In some aspects, the activating comprises the heat treatment and the heat treatment comprises subjecting at least the anode to a temperature in a range of about 180.5° C. to about 200° C.

In some aspects, the activating comprises the pressure treatment and the pressure treatment comprises subjecting at least the anode to a pressure in a range of about 1 MPa to about 200 MPa.

In some aspects, the activating comprises reacting at least some the Li of the FPLiPs with at least some of the Si of the PAAPs.

In some aspects, an anode is made.

In some aspects, a mass fraction of the Si in the anode is in a range of about 10 wt. % to about 60 wt. %.

In an aspect, a method of making a lithium-ion battery includes making the anode; providing or making a cathode on a cathode current collector; and assembling a battery cell from the anode on the anode current collector and the cathode on the cathode current collector; and filling a space between the anode and the cathode with an electrolyte ionically coupling the anode and the cathode to form the lithium-ion battery.

In some aspects, the method further comprises carrying out formation cycling on the lithium-ion battery, wherein the formation cycling comprises transferring ions of at least some of the Li of the FPLiPs to the PAAPs.

In some aspects, a first-cycle coulombic efficiency of the PAAPs is about 80% or greater.

In an aspect, a pre-lithiation particle dispersion includes functionalized pre-lithiation particles (FPLiPs) comprising lithium (Li); and a solvent composition in which the FPLiPs are dispersed, wherein: each of the FPLiPs comprises a core and an outer protective coating around the core, the outer protective coating comprising an oligomeric dispersant and/or a polymeric dispersant; and a viscosity of the pre-lithiation particle dispersion is in a range of about 1 cP to about 1000 cP.

In some aspects, an average density of the FPLiPs is within about ±20% of a density of the solvent composition.

In some aspects, the respective core of each of the FPLiPs comprises a non-Li element that is more dense than the Li.

In an aspect, a method of making an anode includes forming an anode on an anode current collector, the anode comprising primary anode active particles (PAAPs) that each comprise silicon (Si) and carbon (C); coating the pre-lithiation particle dispersion on the anode to form a pre-lithiation particle layer comprising the FPLiPs on the anode; and activating the FPLiPs, wherein: a mass ratio of the PAAPs in the anode to the FPLiPs in the pre-lithiation particle layer is in a range of about 10:1 to about 200:1.

In some aspects, the activating comprises a heat treatment and/or a pressure treatment.

In some aspects, the activating comprises the heat treatment and the heat treatment comprises subjecting at least the pre-lithiation particle layer to a temperature in a range of about 180.5° C. to about 200° C.

In some aspects, the activating comprises the pressure treatment and the pressure treatment comprises subjecting at least the pre-lithiation particle layer to a pressure in a range of about 1 MPa to about 200 MPa.

In some aspects, the activating comprises reacting at least some of the Li of the FPLiPs with at least some of the Si of the PAAPs.

In some aspects, a mass fraction of the Si in the anode is in a range of about 10 wt. % to about 60 wt. %.

In an aspect, a method of making a lithium-ion battery includes making the anode; providing or making a cathode on a cathode current collector; assembling a battery cell from the anode on the anode current collector and the cathode on the cathode current collector; and filling a space between the anode and the cathode with an electrolyte ionically coupling the anode and the cathode to form the lithium-ion battery.

In some aspects, the method includes transferring ions of at least some of the Li of the FPLiPs to the PAAPs via formation cycling of the lithium-ion battery.

In some aspects, a first-cycle coulombic efficiency of the PAAPs is about 80% or greater.

In an aspect, a method of making an anode includes coating the pre-lithiation particle dispersion on an anode current collector to form a pre-lithiation particle layer comprising the FPLiPs on the anode current collector; coating an anode composition on the pre-lithiation particle layer to form an anode on the pre-lithiation particle layer, the anode comprising primary anode active particles (PAAPs) that each comprise silicon (Si) and carbon (C); and activating the FPLiPs, wherein: a mass ratio of the PAAPs in the anode to the FPLiPs in the pre-lithiation particle layer is in a range of about 10:1 to about 200:1.

In some aspects, the activating comprises a heat treatment and/or a pressure treatment.

In some aspects, the activating comprises the heat treatment and the heat treatment comprises subjecting at least the pre-lithiation particle layer to a temperature in a range of about 180.5° C. to about 200° C.

In some aspects, the activating comprises the pressure treatment and the pressure treatment comprises subjecting the pre-lithiation particle layer to a pressure in a range of about 1 MPa to about 200 MPa.

In some aspects, the activating comprises reacting at least some of the Li of the FPLiPs with at least some of the Si of the PAAPs.

In some aspects, a mass fraction of the Si in the anode is in a range of about 10 wt. % to about 60 wt. %.

In an aspect, a method of making a lithium-ion battery includes making the anode; providing or making a cathode on a cathode current collector; assembling a battery cell from the anode on the anode current collector and the cathode on the cathode current collector; and filling a space between the anode and the cathode with an electrolyte ionically coupling the anode and the cathode to form the lithium-ion battery.

In some aspects, the method includes transferring ions of at least some of the Li of the FPLiPs to the PAAPs via formation cycling of the lithium-ion battery.

In some aspects, a first-cycle coulombic efficiency of the PAAPs is about 80% or greater.

In an aspect, a method of making an anode-separator laminate includes forming an anode on an anode current collector, the anode comprising primary anode active particles (PAAPs) that each comprise silicon (Si) and carbon (C); coating the pre-lithiation particle dispersion on a separator to form a separator comprising a pre-lithiation particle layer comprising the FPLiPs; laminating the anode and the separator to form the anode-separator laminate, the pre-lithiation particle layer contacting the anode; and activating the FPLiPs, wherein: a mass ratio of the PAAPs in the anode to the FPLiPs in the pre-lithiation particle layer is in a range of about 10:1 to about 200:1.

In some aspects, the activating comprises a heat treatment and/or a pressure treatment.

In some aspects, the activating comprises the heat treatment and the heat treatment comprises subjecting at least the pre-lithiation particle layer to a temperature in a range of about 180.5° C. to about 200° C.

In some aspects, the activating comprises the pressure treatment and the pressure treatment comprises subjecting at least the pre-lithiation particle layer to a pressure in a range of about 1 MPa to about 200 MPa.

In some aspects, the activating comprises reacting at least some of the Li of the FPLiPs with at least some of the Si of the PAAPs.

In some aspects, a mass fraction of the Si in the anode is in a range of about 10 wt. % to about 60 wt. %.

In an aspect, a method of making a lithium-ion battery includes making the anode-separator laminate; providing or making a cathode on a cathode current collector; assembling a battery cell from the anode-separator laminate and the cathode on the cathode current collector with the separator positioned between the anode and the cathode; and filling a space comprising the separator between the anode and the cathode with an electrolyte ionically coupling the anode and the cathode to form the lithium-ion battery.

In some aspects, the method includes transferring ions of at least some of the Li of the FPLiPs to the PAAPs via formation cycling of the lithium-ion battery.

In some aspects, a first-cycle coulombic efficiency of the PAAPs is about 80% or greater.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example Li-ion battery in which the components, materials, processes, and other techniques described herein may be implemented.

FIGS. 2A and 2B are flow diagrams of processes of making a Li-ion rechargeable battery cell in accordance with certain embodiments.

FIG. 3 is a flow diagram of a process of making anode (or cathode) particles in accordance with certain embodiments including carrying out an activation process on carbon particles.

FIG. 4A illustrates a schematic diagram of a lithium-ion battery in the pre-formation state, showing the FPLiPs contained in the anode and the lithium ions contained in the cathode active material. Some fraction of the lithium that originates from FPLiPs and/or the cathode active material is utilized to form the solid electrolyte interphase (SEI).

FIG. 4B illustrates a schematic diagram of a lithium-ion battery after the first charge is performed, highlighting the loss of some lithium atoms to the solid electrolyte interphase (SEI) formed on the anode.

FIG. 5A schematically illustrates FPLiP particles (171) interspersed with silicon-carbon composite material particles (170).

FIG. 5B schematically illustrates lithiated silicon-carbon composite material particles (172) prepared by activation of the FPLiPs.

FIG. 6 schematically illustrates a conformal outer protective coating around a lithium-comprising (e.g., Li metal, Li-alloy) particle.

FIG. 7 presents Table 1 of areal loading requirements of FPLiP for different cell capacities and first cycle losses.

FIG. 8 presents Table 2 of the (estimated) amount of Li required for pre-lithiation of primary anode active particles (PAAPs) of varying specific capacities and first-cycle losses.

FIG. 9 shows graphical plots of the capacity retention as a function of the number of cycles for illustrative Li-ion battery cells with (solid line) and without FPLiPs (dashed line), showing the positive impact of including FPLiPs in the anode.

FIG. 10 shows graphical plots of the first-cycle voltage profiles of an example Li-ion battery comprising an NMC811 (lithium nickel cobalt oxide of approximate composition LiNi_{0.5}Co_{0.1}Mn_{0.1}O₂) cathode and silicon-carbon composite anode with (solid) or without (dashed) FPLiPs, showing the positive impact of including an FPLiP in the anode.

FIG. 11 shows graphical plots of the first-cycle voltage profiles of an example Li-ion battery comprising an LCO (lithium cobalt oxide) cathode and silicon-carbon composite anode with (solid) or without (dashed) FPLiPs, showing the positive impact of including an FPLiP in the anode.

FIG. 12 shows graphical plots of the first-cycle voltage profiles of an example Li-ion battery comprising an LFP (lithium iron phosphate) cathode and silicon-carbon composite anode with (solid) or without (dashed) FPLiPs, showing the positive impact of including an FPLiP in the anode.

FIG. 13 schematically illustrates a battery cell comprising a silicon-carbon nanocomposite anode containing FPLiPs paired with a high first-cycle efficiency cathode, as it undergoes stages in the formation cycling. The left-most graphic shows the battery cell before formation cycling. Subsequent stages during and after formation cycling are shown as (1), (2), (3), and (4): At (1), during the first charge, lithium and electrons from the cathode are transported to the anode. At (2), reversible and irreversible lithium/electron sites in the anode are lithiated. At (3), during the first discharge, lithium in the FPLiPs and reversible lithium in the anode are transported to the cathode. Irreversible lithium in the anode remains. At (4), close matching of anode and cathode capacities after the formation cycle.

### DETAILED DESCRIPTION

The following description and related drawings disclose certain aspects of the present invention in specific embodiments. It should be noted that the term “embodiments of the invention” does not necessarily imply that all embodiments include the particular feature, advantage, process, or mode of operation discussed, and other embodiments may be created that are still within the scope of the invention. Furthermore, certain well-known components of the invention may not be described in detail or may be left out to avoid masking more pertinent information.

Aspects of the present disclosure provide for processes of making advanced carbon-containing composite particles for use in electrodes (e.g., anode electrodes or cathode electrodes) of Li-ion or Na-ion or K-ion rechargeable batteries, among other types of batteries, electrochemical capacitors and hybrid electrochemical energy storage devices.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120° C. to about −60° C. encompasses (in ° C.) a set of temperature ranges from about −120° C. to about −119° C., from about −119° C. to about −118° C., . . . from about −61° C. to about −60° C., as if the intervening numbers (in ° C.) between −120° C. and −60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around”, “≈” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

In the following description, various material properties are described so as to characterize materials (e.g., molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types such as precursor particles (e.g., carbon particles, etc.). Hence, unless otherwise indicated, the following Table provides examples of how such material properties may be readily measured by one of ordinary skill in the art using commercially available instrumentation:

Table of Techniques and Instrumentation for Material Property Measurements

| Material | | Measurement | |
|---|---|---|---|
| Type | Property Type | Instrumentation | Measurement Technique |
| Active | Coulombic | Potentiostat | Charge (current) is passed to an |
| Material | Efficiency | | electrode containing the active |
| | | | material of interest until a given |
| | | | voltage limit is reached. Then, |
| | | | the current is reversed until a |
| | | | second voltage limit is reached. |
| | | | The ratio of the charge passed |
| | | | determines the coulombic |
| | | | efficiency. |
| Active | Partial Vapor | Manometer | The partial vapor pressure of an |
| Material | Pressure (e.g., | | active material in a mixture |
| | Torr.) at a | | (e.g., composite particle) at a |
| | Temperature | | particular temperature is given |
| | (e.g., K) | | by the known vapor pressure of |
| | | | the active material multiplied by |
| | | | its mole fraction in the mixture. |
| Active | Volume | Gas pycnometer | Gas pycnometer measures the |
| Material | | | skeletal volume of a material by |
| Particle | | | gas displacement using the |
| | | | volume-pressure relationship of |
| | | | Boyle's Law. A sample of |
| | | | known mass is placed into the |
| | | | sample chamber and maintained |
| | | | at a constant temperature. An |
| | | | inert gas, typically helium, is |
| | | | used as the displacement |
| | | | medium. |
| | | | Note: A vol. % change may be |
| | | | calculated from two volume |
| | | | measurements of the active |
| | | | material particle. |
| Active | Open Internal | nitrogen | nitrogen sorption/desorption |
| Material | Pore Volume | sorption/desorption | isotherm technique |
| Particle | (e.g., cc/g or | isotherm | |
| | cm³/g) | | |
| Active | Volume- | PSA, scanning | PSA using laser scattering, |
| Material | Average Pore | electron microscope | electron microscopy (SEM, |
| Particle | Size (e.g., nm) | (SEM), transmission | TEM, STEM), laser microscopy |
| | | electron microscope | (for larger particles), optical |
| | | (TEM), scanning | microscopy (for larger |
| | | transmission | particles), neutron scattering, X- |
| | | microscope (STEM), | ray microscopy imaging |
| | | laser microscope, | |
| | | Synchrotron X-ray, | |
| | | X-ray microscope | |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas pycnometer |
| | | | and comparing to the theoretical |
| | | | density of the individual |
| | | | material components present in |
| | | | Si-comprising particles |
| Active | Closed | Gas pycnometer | With a pycnometer, the amount |
| Material | Internal | | of a certain medium (liquid or |
| Particle | Volume- | | Helium or other analytical |
| | Average Size | | gases) displaced by a solid can |
| | (e.g., nm) | | be determined. |
| Active | Size | TEM, STEM, SEM, | Laser particle size distribution |
| Material | (e.g., nm, μm, | X-Ray, PSA, etc. | analysis (LPSA), laser image |
| Particle | etc.) | | analysis, electron microscopy, |
| | | | optical microscopy or other |
| | | | suitable techniques |
| | | | transmission electron |
| | | | microscopy (TEM), scanning |
| | | | transmission electron |
| | | | microscopy (STEM), scanning |
| | | | electron microscopy (SEM)), X- |
| | | | ray microscopy, X-ray |
| | | | diffraction, neutron scattering |
| | | | and other suitable techniques |
| Active | Composition | Balance | Note #1: A wt. % change may |
| Material | (e.g., mass | | be calculated by comparing the |
| Particle | fraction or wt. | | mass fraction of a material in the |
| | %, mg, | | particle relative to the total |
| | number of | | particle mass. |
| | atoms, etc.) | | Note #2: The capacity |
| | | | attributable to particular active |
| | | | material(s) in the particle may |
| | | | be derived from the |
| | | | composition, based on the |
| | | | known theoretical capacit(ies) of |
| | | | each active material. |
| | | | Note #3: The composition of the |
| | | | particle may be characterized in |
| | | | terms of weight (e.g., mg). The |
| | | | composition of may |
| | | | alternatively be characterized by |
| | | | a number of atoms of a |
| | | | particular element (e.g., Si, C, |
| | | | etc.). In case of atoms, the |
| | | | number of atoms may be |
| | | | estimated from the weight of |
| | | | that atom in the particle (e.g., |
| | | | based on gas chromatography) |
| Active | Specific | Potentiostat | An electrode containing an |
| Material | Capacity | | active anode or cathode material |
| Particle, | | | of interest is charged or |
| Battery Half- | | | discharged (by passing electrical |
| Cell | | | current to the electrode) within |
| | | | certain potential limits using an |
| | | | electrochemical cell with |
| | | | suitable reference electrode, |
| | | | typically lithium metal. The |
| | | | total charge passed divided by |
| | | | the active material mass gives |
| | | | this quantity. The active mass is |
| | | | computed by multiplying the |
| | | | total mass of the electrode by |
| | | | the active material mass |
| | | | fraction. Both reversible and |
| | | | irreversible capacity during |
| | | | charge or discharge may be |
| | | | calculated in this way. |
| Active | BET SSA | BET instrument | A sample is placed into a sealed |
| Material | (e.g., m²/g) | | chamber, where nitrogen is |
| Particle | | | introduced. The change in |
| | | | pressure of the nitrogen is used |
| | | | to calculate the surface area of |
| | | | the sample. |
| Active | Aspect Ratio | SEM, TEM | The dimensions and shape of the |
| Material | | | particles are measured in SEM |
| Particle | | | or TEM. |
| Active | True Density | Argon Gas | True density values may be |
| Material | of Particle | Pycnometer | measured by using an argon gas |
| Particle | (e.g., g/cc or | | pycnometer and comparing to |
| | g/cm³) | | the theoretical density of the |
| | | | individual material components |
| | | | present in the particle. |
| Active | Particle Size | Dynamic light | laser particle size distribution |
| Material | Distribution | scattering particle | analysis (LPSA) on well- |
| Particle | (e.g., nm or | size analyzer, | dispersed particle suspensions in |
| Population | μm) | scanning electron | one example or by image |
| | | microscope | analysis of electron microscopy |
| | | | images, or by other suitable |
| | | | techniques. While there are |
| | | | diverse processes of measuring |
| | | | PSDs, laser particle size |
| | | | distribution analysis (LPSA) is |
| | | | quite efficient for some |
| | | | applications. Note that other |
| | | | types of particle size distribution |
| | | | (e.g., by SEM image analysis) |
| | | | could also be utilized (and may |
| | | | even lead to more precise |
| | | | measurements, in some |
| | | | experiments). Using LPSA, |
| | | | particle size parameters of a |
| | | | population's PSD may be |
| | | | measured, such as: a tenth- |
| | | | percentile volume-weighted |
| | | | particle size parameter (e.g., |
| | | | abbreviated as D₁₀), a fiftieth- |
| | | | percentile volume-weighted |
| | | | particle size parameter (e.g., |
| | | | abbreviated as D₅₀), a ninetieth- |
| | | | percentile volume-weighted |
| | | | particle size parameter (e.g., |
| | | | abbreviated as D₉₀), and a |
| | | | ninety-ninth-percentile volume- |
| | | | weighted particle size parameter |
| | | | (e.g., abbreviated as D₉₉). |
| Active | Width (e.g., | PSA | Parameters relating to |
| Material | nm) | | characteristic widths of the PSD |
| Particle | | | may be derived from these |
| Population | | | particle size parameters, such as |
| | | | D₅₀-D₁₀ (sometimes referred to |
| | | | herein as a left width), D₉₀-D₅₀ |
| | | | (sometimes referred to herein as |
| | | | a right width), and D₉₀-D₁₀ |
| | | | (sometimes referred to herein as |
| | | | a full width). |
| Active | Cumulative | Computed via LPSA | A cumulative volume fraction, |
| Material | Volume | data | defined as a cumulative volume |
| Particle | Fraction | | of the composite particles with |
| Population | | | particle sizes of a threshold |
| | | | particle size or less, divided by a |
| | | | total volume of all of the |
| | | | composite particles, may be |
| | | | estimated by LPSA. |
| Active | Composition | Balance | The mass of active materials |
| Material | (e.g., wt. %) | | added to the electrode divided |
| Particle | | | by the total mass of the |
| Population | | | electrode. |
| Active | BET SSA | BET Isotherm | obtained from the data of |
| Material | (e.g., m2/g) | | nitrogen sorption-desorption at |
| Particle | | | cryogenic temperatures, such as |
| Population | | | about 77 K |
| Electrolyte | Salt | balance, volumetric | Total volume of the solution is |
| | Concentration | pipette | computed either via the sum of |
| | (e.g., M or | | the volume of the constituents |
| | mol. %) | | (measured by volumetric |
| | | | pipette), or by the mass of the |
| | | | constituents divided by the |
| | | | density. The molar mass of the |
| | | | salt is then used to calculate the |
| | | | total number of moles of salt in |
| | | | the solution. The moles of salt is |
| | | | then divided by the total volume |
| | | | to obtain the solvent |
| | | | concentration in M (mol/L). |
| Electrolyte | Solvent | balance, volumetric | Total volume of the solution is |
| | Concentration | pipette | computed either via the sum of |
| | (e.g., M or | | the volume of the constituents |
| | mol. %) | | (measured by volumetric |
| | | | pipette), or by the mass of the |
| | | | constituents divided by the |
| | | | density. The molar volume of |
| | | | each solvent is then used to |
| | | | calculate the total number of |
| | | | moles of solvent in the solution. |
| | | | The moles of solvent is then |
| | | | divided by the total volume to |
| | | | obtain the solvent concentration |
| | | | in M (mol/L). |
| Electrode | Composition | Balance | The mass fraction of a material |
| | (e.g., mass | | (e.g., active material, active |
| | fraction or wt. | | material particle, binder, etc.) in |
| | %) | | the electrode is calculated based |
| | | | on a measured or estimated |
| | | | mass of the material and a |
| | | | measured or estimated mass of |
| | | | the electrode, excluding the |
| | | | electrode current collector. |
| | | | Note: The mass of individual |
| | | | components (e.g., composite |
| | | | active material particles, |
| | | | graphite particles, binder, |
| | | | function additive(s), etc.) of the |
| | | | battery electrode composition |
| | | | may be measured before being |
| | | | mixed into a slurry to estimate |
| | | | their mass in a casted electrode. |
| | | | The mass of materials deposited |
| | | | onto the casted electrode may be |
| | | | measured by comparing the |
| | | | weight of the casted electrode |
| | | | before/after the material |
| | | | deposition. |
| Electrode | Areal Binder | balance | A mass fraction of the binder in |
| | Loading (e.g., | | the battery electrode, divided by |
| | mg/m²) | | a product of (1) a mass fraction |
| | | | of the active material (e.g., Si—C |
| | | | nanocomposite, etc.) particles in |
| | | | the battery electrode, and (2) a |
| | | | Brunauer-Emmett-Teller (BET) |
| | | | specific surface area of the |
| | | | population |
| Electrode | Capacity | Calculated | Measure mass (wt.) of active |
| | Attributable to | | material in electrode, and |
| | Active | | calculate electrode capacity |
| | Material | | based on known theoretical |
| | (active | | capacity of the active material. |
| | material | | For example, the average wt. % |
| | capacity | | of active material in each active |
| | fraction) | | material particle may be |
| | | | measured, and used to calculate |
| | | | the mass of the active material |
| | | | based on the mass of the active |
| | | | material particles before being |
| | | | mixed in slurry. This process |
| | | | may be repeated if the electrode |
| | | | includes two or more active |
| | | | materials to calculate the |
| | | | relative capacity attribution for |
| | | | each active material in the |
| | | | electrode. |
| Electrode | Capacity | Potentiostat and | Determine average specific |
| | Attributable to | balance | capacity (g/mAh) of active |
| | Active | | material particles. For example, |
| | Material | | the average specific capacity |
| | Particles | | may be estimated from the |
| | (active | | average wt. % of active |
| | material | | material(s) in each particle and |
| | particle | | its associated known theoretical |
| | capacity | | capacit(ies). Then, measure |
| | fraction) | | mass (wt.) of active material |
| | | | particles in electrode before |
| | | | being mixed in slurry, which |
| | | | may be used to calculate the |
| | | | capacity attributable to that |
| | | | active material. This process |
| | | | may be repeated if the electrode |
| | | | includes two or more active |
| | | | material particle types to |
| | | | calculate the relative capacity |
| | | | attribution for each active |
| | | | material particle type in the |
| | | | electrode. |
| Electrode | Mass of | balance | The average wt. % of active |
| | Active | | material in each active material |
| | Material in | | particle may be measured, and |
| | Electrode | | used to calculate the mass of the |
| | | | active material based on the |
| | | | mass of the active material |
| | | | particles before being mixed in |
| | | | slurry. |
| Electrode | Mass of | balance | Measure the active material |
| | Active | | particle before the active |
| | Material | | material particle type is mixed |
| | Particle in | | in slurry. |
| | Electrode | | |
| Electrode | Areal | Potentiostat and | Areal capacity loading is weight |
| | Capacity | balance | of the coated active material per |
| | Loading (e.g., | | unit area (g/cm²) multiplied by |
| | mAh/cm²) | | the gravimetric capacity of the |
| | | | active material (not the |
| | | | electrode, but the active material |
| | | | itself with zero binder and zero |
| | | | electrolyte; mAh/g). |
| Electrode | Coulombic | Potentiostat | The change in charge inserted (or |
| | Efficiency | | extracted) to an electrode divided |
| | | | by the charge extracted (or |
| | | | inserted) from the electrode |
| | | | during a complete |
| | | | electrochemical cycle within |
| | | | given voltage limits. Because the |
| | | | direction of charge flow is |
| | | | opposite for cathodes and |
| | | | anodes, the definition is |
| | | | dependent on the electrode. |
| | | | Coulombic Efficiency is |
| | | | measured for both materials by |
| | | | constructing a so-called half-cell, |
| | | | which is an electrochemical cell |
| | | | consisting of a cathode or anode |
| | | | material of interest as the |
| | | | working electrode and a lithium |
| | | | metal foil which functions as |
| | | | both the counter and reference |
| | | | electrode. Then, charge is either |
| | | | inserted or removed from the |
| | | | material of interest until the cell |
| | | | voltage reaches an appropriate |
| | | | limit. Then, the process is |
| | | | reversed until a second voltage |
| | | | limit is reached, and the charge |
| | | | passed in both steps is used to |
| | | | calculate the Coulombic |
| | | | Efficiency, as described above. |
| Battery Cell | Rate | Potentiostat | This is the time it takes to |
| | Performance | | charge or discharge a battery |
| | | | between a given state of charge. |
| | | | It is measured by charging or |
| | | | discharging a battery and |
| | | | measuring the time until a |
| | | | specified amount of charge is |
| | | | passed, or until the battery |
| | | | operating voltage reaches a |
| | | | specified value. |
| Battery Cell | Cell Discharge | Potentiostat | A battery consisting of a |
| | Voltage (e.g., | | relevant anode and cathode is |
| | V) | | charged and discharged within |
| | | | certain voltage limits and the |
| | | | charge-weighted cell voltage |
| | | | during discharge is computed. |
| Battery Cell | Operating | Potentiostat and | Average temperature of battery |
| | Temperature | thermocouples | cell as measured at the |
| | | | positive/negative terminal/cell |
| | | | shaft/etc. while |
| | | | charging/discharging, or at a |
| | | | certain voltage level, or while a |
| | | | load is applied, etc. |
| Battery Half- | Anode | Potentiostat | An electrode containing an |
| Cell | Discharge (de- | | active anode material (or |
| | lithiation) | | mixture of active materials) of |
| | Potential | | interest is charged and |
| | (e.g., V) | | discharged (by passing electrical |
| | | | current to the electrode) within |
| | | | certain potential limits using an |
| | | | electrochemical cell with |
| | | | suitable reference electrode, |
| | | | typically lithium metal. The |
| | | | charge-averaged cell potential |
| | | | upon discharge (corresponding |
| | | | to de-lithiation of the anode) is |
| | | | computed. |
| Battery Half- | Cathode | Potentiostat | An electrode containing an |
| Cell | Discharge | | active cathode material (or |
| | (lithiation) | | mixture of active materials) of |
| | Potential | | interest is charged and |
| | (e.g., V) | | discharged (by passing electrical |
| | | | current to the electrode) within |
| | | | certain potential limits using an |
| | | | electrochemical cell with |
| | | | suitable reference electrode, |
| | | | typically lithium metal. The |
| | | | charge-averaged cell potential |
| | | | upon discharge (corresponding |
| | | | to lithiation of the cathode) is |
| | | | computed. |
| Battery Cell | Volumetric | Potentiostat | the VED is calculated by first |
| | Energy | | calculating the energy per unit |
| | Density | | area of the battery, and then |
| | (VED) | | dividing the energy per unit area |
| | | | by the sum of the illustrative |
| | | | anode, cathode, separator, and |
| | | | current collector thicknesses |
| Battery Cell | Internal | Potentiostat | The internal resistance (also |
| | Resistance | | known as impedance in many |
| | (impedance) | | contexts) is measured by |
| | | | applying small pulses of current |
| | | | to the battery cell and recording |
| | | | the instantaneous change in cell |
| | | | voltage. |
| Any Liquid | Surface | Surface Tensiometer | Surface Tension in mN/m may |
| | Tension | (e.g., Bubble | be measured at room |
| | | Pressure | temperature |
| | | Tensiometer) | |
| Any Liquid | ViscosityP) | Viscometer (e.g., | Viscosity of a liquid may be |
| | | Brookfield | measured at room temperature |
| | | Viscometer) | |

In some embodiments described below, certain parameters (e.g., temperature, state-of-charge (SOC), etc.) may be defined in terms of relative terminology such as low, reduced, high, increased, elevated, and so on. With regard to temperature, unless otherwise stated, this relative terminology may be characterized relative to battery cell storage temperature or battery cell operating temperature, depending on the context of the relevant example. With regard to SOC, unless otherwise stated, a high SOC may be defined as higher than about 70% SOC (e.g., in some designs, about 70-80% SOC; in some designs, about 80-90% SOC; in some designs, about 90-100% SOC).

While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, dual ion batteries, alkaline or alkaline ion batteries, flow batteries, etc.) as well as electrochemical capacitors and hybrid energy storage devices.

Aspects of the present invention particularly benefit relatively large battery cells, such as cells with the energy more than about 1 Wh (in some designs, from about 1 Wh to about 20 Wh; in other designs, from about 20 Wh to about 100 Wh; in other designs, from about 100 Wh to about 250 Wh; in yet other designs, from about 250 Wh to about 500 Wh; in yet other designs, from about 500 Wh to about 2 kWh). This is because relatively large cells may become particularly sensitive to self-heating induced by large internal resistance, particularly if electrodes with relatively large areal capacity loadings are utilized. Some aspects of this disclosure describe means to reduce electrode resistance by utilizing suitable solvent-free electrode fabrication techniques.

While the description below may describe certain examples in the context of composites comprising specific (e.g., alloying-type or conversion-type) active anode materials (such as Si, among others) or specific (e.g., intercalation-type or conversion-type) active cathode materials, it will be appreciated that various aspects may be applicable to many other types and chemistries of conversion-type anode and cathode active materials, intercalation-type anode and cathode active materials, pseudocapacitive anode and cathode active materials, and materials that may exhibit mixed electrochemical energy storage mechanisms.

While the description below may also describe certain examples of the material formulations in a Li-free state (for example, as in silicon-comprising nanocomposite anodes or metal fluoride cathodes or sulfur cathodes, etc.), it will be appreciated that various aspects may be applicable to Li-comprising electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, Zr, Ti, Mg, Nb, and various other metals and metal alloys and mixtures of such and other metals, etc.) or partially or fully lithiated metal halide comprising cathode particles, partially or fully lithiated chalcogenides (such as LizS, LizS/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated intercalation-type cathode materials, partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Below, unless stated or implied otherwise, reference to such Li-dependent anode material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector.

While the description below may describe certain examples in the context of some specific alloying-type, conversion-type and intercalation-type chemistries for anode active materials and conversion-type and intercalation-type chemistries for cathode active materials for Li-ion batteries (such as silicon-comprising anodes or metal fluoride-comprising or lithium sulfide-comprising cathodes), it will be appreciated that various aspects may be applicable to other chemistries for Li-ion batteries (other conversion-type and alloying-type electrodes as well as various intercalation-type anodes and cathodes) as well as to other battery chemistries. In the case of metal-ion batteries (such as Li-ion batteries), examples of other suitable conversion-type electrodes include, but are not limited to, metal fluorides, metal oxyfluorides, metal chlorides, metal iodides, metal bromides, sulfur, metal sulfides (including, but not limited to lithium sulfide), selenium, metal selenide (including, but not limited to lithium sulfide), metal oxides, metal nitrides, metal phosphides, metal hydrides, their various mixtures, composites (including nanocomposites) and alloys and others.

During battery (such as a Li-ion battery) operation, conversion materials change (convert) from one crystal structure to another (hence the name “conversion”-type), where a material structure and composition may chemically and structurally change to one or multiple structures. This process is also accompanied by breaking chemical bonds and forming new ones. During (e.g., Li-ion) battery operation, Li ions are inserted into alloying type materials forming lithium alloys (hence the name “alloying”-type). Sometimes, “alloying”-type electrode materials may be regarded as a subclass of “conversion”-type electrode materials.

Silicon (Si) is an example of an alloying-type active material. In some designs, Si may be a part of the active material particles (e.g., composite active material particles, such as Si—C composite particles). At least one aspect is directed to a battery electrode (e.g., anode) composition comprising a population of Si-comprising particles (e.g., composite active material particles, such as Si—C composite particles) or to a battery cell with a population of Si-comprising active material particles (e.g., composite active material particles, such as Si—C composite particles) within its anode. Illustrative examples of suitable Si-comprising active material particles (e.g., for preferable use in Li-ion battery anodes) include, but are not limited to: simple (e.g., uniform) composition of silicon-comprising particles, silicon particles, particles comprising silicon nanoparticles having average size from about 1 nm to about 10 nm or from about 10 nm to about 50 nm or from about 50 nm to about 100 nm or from about 100 nm to about 500 nm range, doped or heavily doped silicon-comprising particle, particles comprising amorphous material, particles comprising nanocrystalline material, particles comprising amorphous silicon, particles comprising amorphous silicon or silicon-comprising nanoparticles, particles comprising nanocrystalline silicon or silicon-comprising particles, particles comprising silicon nanoparticles surrounded by oxygen-rich matrix material, particles comprising silicon nanoparticles surrounded by lithium-comprising matrix material, particles comprising silicon nanoparticles surrounded by magnesium-comprising matrix material, particles comprising silicon nanoparticles surrounded by aluminum-comprising matrix material, particles comprising silicon nanoparticles surrounded by iron-comprising matrix material, particles comprising silicon nanoparticles surrounded by carbon, carbon-rich or carbon-containing matrix material, particles comprising silicon nanoparticles surrounded by nitrogen-rich or nitrogen-containing matrix material, polymer comprising particles, electrically conductive polymer comprising particles, ionically conductive polymer comprising particles, silicon carbide comprising particles, silicon oxide (SiOₓ; where 0<x<2) comprising particles, silicon nitride comprising particles, silicon phosphide comprising particles, silicon hydride comprising particles, silicon alloy (with one, two, three, four or more non-Si metals or semimetals) comprising particles, silicon-magnesium alloy comprising particle, silicon-aluminum alloy comprising particles, silicon-tin alloy comprising particles, silicon-zinc alloy comprising particles, silicon lithium oxide (e.g., with composition of SiLi_{y}Oₓ, where 0<x≤4, 0<y≤4; e.g., Li₂SiO₃, Li₆Si₂O₇, Li₂Si₂O₅, Li₄SiO₄, among others) comprising particles, lithium silicate comprising particles, magnesium silicate comprising particles, silicon magnesium oxide (e.g., with composition SiMg_{y}Oₓ, where 0<x≤4, 0<y≤2) comprising particles, aluminum silicon oxide-comprising particles, aluminum silicate-comprising particles, silicon sulfide-comprising particles, oxidized silicon sulfide-comprising particles, particles comprising carbon-coated or carbon-decorated silicon, particles comprising silicon carbide-coated or silicon carbide-decorated silicon, particles comprising silicon oxide-coated silicon, particles comprising silicon oxide-decorated silicon, particles comprising silicon nitride-coated silicon, particles comprising silicon nitride-decorated silicon, core-shell particles, particles with composite shells, particles with shells comprising two or more distinct layers, particles with composite coating(s) around at least some of the silicon surface, particles with layered coating(s) around at least some of the silicon surface, dense (non-porous) particles, porous particles, microporous particles, mesoporous particles, macroporous particles, particles with internal (not accessible by nitrogen gas during nitrogen sorption measurements) pores (e.g., micropores (less than about 2 nm), mesopores (about 2 to about 50 nm) or macropores (>about 50 nm) or their various combinations, size distributions and relative volume ratios, as determined from nitrogen sorption measurements, neutron scattering, electron microscopy, and other related techniques), particles with external (accessible by nitrogen gas during nitrogen sorption measurements) pores (e.g., micropores, mesopores or macropores or their various combinations, size distributions and relative volume ratios, as determined from nitrogen sorption measurements, neutron scattering, electron microscopy and other related techniques), porous silicon-comprising particles, composite particles, nanocomposite particles, nanocomposite particles that comprise both silicon and carbon atoms, nanocomposite particles with the total wt. % of Si and C in the range from about 75% to about 100%, particles with specific reversible electrochemical lithium storage capacity in the range from about 400 to about 700 mAh/g or from about 700 to about 1000 mAh/g or from about 1000 to about 1400 mAh/g or from about 1400 to about 1700 mAh/g or from about 1700 to about 2000 mAh/g or from about 2000 to about 2400 mAh/g or from about 2400 to about 3000 mAh/g or from about 3000 to about 3700 mAh/g, as determined by electrochemical measurements in liquid electrolytes at room temperature; nanocomposite particles comprising silicon nanoparticles within carbon pores, particles comprising carbon on their surface, particles comprising polymers on their surface, particles comprising carbon-coated silicon, particles with more than one distinct coatings, particles with more than one distinct coatings on the silicon surface, milled particles, irregular-shaped particles, spherical or spheroidal particles, flattened particles, planar particles, elongated particles, fiber-shaped particles and particles with various combinations, variations and mixtures of such compositions, features and properties, among others.

In some embodiments of the present disclosure, preferred Si-comprising active material particles may also comprise carbon (C). In some embodiments, a total atomic fraction of the Si and the C in Si-comprising active anode material particles may contribute from about 75 at. % to about 100 at. % of the overall Si-comprising (e.g., composite or nanocomposite) particles. Such composite particles are sometimes referred to herein as Si—C composites (or nanocomposites). In some embodiments, Si—C composites or nanocomposites may comprise pores (e.g., micropores, mesopores, and/or macropores). At least some of such pores may be closed (inaccessible by nitrogen during nitrogen sorption measurements and inaccessible to some electrolyte solvents). In some embodiments, such composite particles comprise nano-sized or nanostructured elements (e.g., nano-sized or nanostructured Si, nano-sized or nanostructured C), which may be referred to as nanocomposite particles. In some implementations, the Si or Si-comprising material (e.g., doped and heavily doped Si, Si alloy with Li, Mg, Al, Fe, Cu, Ge and other metals or semimetals, Si oxide, Si nitride, Si oxynitride, Si phosphide, Si hydride, their various combinations, alloys and mixtures, etc.) present in such nanocomposites may be in the form of nanoparticles. In some implementations, the mass-average size of Si or Si-comprising material nanoparticles may range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering, and other suitable techniques.

While the description below may describe certain examples in the context of Si—C composite (e.g. nanocomposite) anode active materials (e.g., nanocomposite particles which comprise silicon (Si) and carbon (C) and may comprise other elements, such as nitrogen (N), phosphorus (P), boron (B), aluminum (Al), magnesium (Mg), iron (Fe), oxygen (O), hydrogen (H), sulfur (S), fluorine (F), to name a few and where a total mass of the Si and the C atoms may contribute from about 75 wt. % to about 100 wt. % of the total mass of the composite particles), it will be appreciated that various aspects may be applicable to other types of high-capacity silicon-comprising anode active materials (including but not limited to, for example, various silicon-comprising or silicon oxide-comprising or silicon nitride-comprising or silicon oxy-nitride-comprising or silicon phosphide-comprising particles or particles comprising a mixture or alloy or other combinations of such active materials, various other types of Si-comprising composites including, but not limited to core-shell or hierarchical or nanocomposite particles, etc.).

An aspect is directed to a battery anode composition comprising a population of Si-comprising particles (e.g., nanocomposite particles, among others), in which each of the Si-comprising particles comprises silicon (Si) and carbon (C) elements and may comprise other elements, such as nitrogen (N), phosphorus (P), boron (B), oxygen (O), hydrogen (H), sulfur (S), fluorine (F), aluminum (Al), magnesium (Mg), iron (Fe), to name a few. In some embodiments, the total mass of the Si and the C (on average) may contribute from about 75 wt. % to about 100 wt. % of the total mass of the Si-comprising particles. Such composite particles are sometimes referred to herein as Si—C composites (or nanocomposites, if Si and C are nanostructures, for example). In some embodiments, the total mass of O may contribute (on average) from about 0 wt. % to about 10 wt. % of the total mass of the Si-comprising particles (in some designs, from about 0 wt. % to about 1 wt. %; in other designs, from about 1 wt. % to about 2.5 wt. %; in other designs, from about 2.5 wt. % to about 5 wt. %; in other designs, from about 5 wt. % to about 10 wt. %). In some embodiments, the total mass of O may contribute (on average) to less than about 5 wt. % of the total mass of the Si-comprising particles. In some embodiments, the total mass of N may contribute (on average) from about 0 wt. % to about 10 wt. % of the total mass of the Si-comprising particles (in some designs, from about 0 wt. % to about 0.1 wt. %; in other designs, from about 0.1 wt. % to about 2 wt. %; in other designs, from about 2 wt. % to about 5 wt. %; in yet other designs, from about 5 wt. % to about 10 wt. %). In some embodiments, the total mass of P may contribute (on average) from about 0 wt. % to about 10 wt. % of the total mass of the Si-comprising particles (in some designs, from about 0 wt. % to about 0.1 wt. %; in other designs, from about 0.1 wt. % to about 1 wt. %; in other designs, from about 1 wt. % to about 5 wt. %; in yet other designs, from about 5 wt. % to about 10 wt. %). In some embodiments, the total mass of B may contribute (on average) from about 0 wt. % to about 5 wt. % of the total mass of the Si-comprising particles (in some designs, from about 0 wt. % to about 0.1 wt. %; in other designs, from about 0.1 wt. % to about 2.5 wt. %; in yet other designs, from about 2.5 wt. % to about 5 wt. %). In some embodiments, the total mass of H may contribute (on average) from about 0 wt. % to about 2 wt. % of the total mass of the Si-comprising particles (in some designs, from about 0 wt. % to about 0.5 wt. %; in other designs, from about 0.5 wt. % to about 1 wt. %; in yet other designs, from about 1 wt. % to about 2 wt. %). In some embodiments, the total mass of S may contribute (on average) from about 0 wt. % to about 2.5 wt. % of the total mass of the Si-comprising particles (in some designs, from about 0 wt. % to about 0.1 wt. %; in other designs, from about 0.1 wt. % to about 0.5 wt. %; in yet other designs, from about 0.5 wt. % to about 2.5 wt. %). In some embodiments, the total mass of F may contribute (on average) from about 0 wt. % to about 2.5 wt. % of the total mass of the Si-comprising particles (in some designs, from about 0 wt. % to about 0.1 wt. %; in other designs, from about 0.1 wt. % to about 0.5 wt. %; in yet other designs, from about 0.5 wt. % to about 2.5 wt. %). In some embodiments, the total mass of Fe may contribute (on average) from about 0 wt. % to about 2.5 wt. % of the total mass of the Si-comprising particles (in some designs, from about 0 wt. % to about 0.1 wt. %; in other designs, from about 0.1 wt. % to about 0.5 wt. %; in yet other designs, from about 0.5 wt. % to about 2.5 wt. %). In some embodiments, the total mass of Al may contribute (on average) from about 0 wt. % to about 2.5 wt. % of the total mass of the Si-comprising particles (in some designs, from about 0 wt. % to about 0.1 wt. %; in other designs, from about 0.1 wt. % to about 0.5 wt. %; in yet other designs, from about 0.5 wt. % to about 2.5 wt. %). In some embodiments, the total mass of Mg may contribute (on average) from about 0 wt. % to about 5 wt. % of the total mass of the Si-comprising particles (in some designs, from about 0 wt. % to about 0.1 wt. %; in other designs, from about 0.1 wt. % to about 0.5 wt. %; in yet other designs, from about 0.5 wt. % to about 5 wt. %).

In some embodiments, a total atomic fraction of the Si and the C may contribute from about 75 at. % to about 100 at. % of the overall composite particles. Such composite particles are sometimes referred to herein as Si—C composites. In some embodiments, such composite particles comprise nano-sized or nanostructured elements (e.g., nano-sized or nanostructured Si, nano-sized or nanostructured C), which may be referred to as nanocomposite particles. In some implementations, such Si—C composites or nanocomposites may be porous (e.g., comprise micropores, mesopores and/or macropores in various ratios). In some implementations, some of the pores in such porous Si—C composites or nanocomposites may be closed (inaccessible by nitrogen during nitrogen sorption measurements and inaccessible to some electrolyte solvents). In some implementations, some of the pores in such porous Si—C composites or nanocomposites may be open (accessible by nitrogen during nitrogen sorption measurements). In some implementations, the Si or Si-comprising material present in such nanocomposites may be in the form of nanoparticles. In some implementations, the mass-average size of Si or Si-comprising material nanoparticles may range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques. In some implementations, the Si or Si-comprising material present in such nanocomposites may be situated within carbon pores. In some implementations, the Si or Si-comprising material present in such nanocomposites may be at least partially coated with a C or C-comprising surface layer.

An aspect is directed to a battery anode composition comprising a population of Si-comprising particles (e.g., nanocomposite particles, among others), in which each of the particles comprises Si and C, and the Si-comprising particles have certain characteristics. In some embodiments, a mass fraction of the silicon in the Si-comprising particles is in a range of about 3 wt. % to about 80 wt. % (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %). In some embodiments, a Brunauer-Emmett-Teller (BET) specific surface area (SSA) of the Si-comprising particles (e.g., nanocomposite particles, among others) is in a range of about 0.5 m²/g to about 170 m²/g (in some designs, from about 0.5 to about 3 m²/g; in other designs, from about 3 m²/g to about 12 m²/g; in yet other designs, from about 12 m²/g to about 18 m²/g; in yet other designs, from about 18 m²/g to about 30 m²/g; in other designs, from about 30 m²/g to about 50 m²/g; in yet other designs, from about 50 m²/g to about 170 m²/g). In some embodiments, about 90% or more of the Si-comprising particles (e.g., nanocomposite particles, among others) in the population are characterized by aspect ratios of about 2.3 or less, or aspect ratios of about 2.1 or less. In some embodiments, about 50% or more of the composite particles in the population are characterized by aspect ratios of about 1.25 or more, or aspect ratios of about 1.35 or more.

An aspect is directed to a battery electrode composition comprising a population of Si-comprising particles (e.g., nanocomposite particles, among others). The particle size distribution (PSD) that characterizes a particle population may be determined by laser particle size distribution analysis (LPSA) on well-dispersed particle suspensions in one example or by image analysis of electron microscopy images, or by other suitable techniques. While there are diverse processes of measuring PSDs, laser particle size distribution analysis (LPSA) is quite efficient for some applications. Using LPSA, particle size parameters of a population's PSD can be measured, such as: a one-percentile volume-weighted particle size parameter (e.g., abbreviated as D₁), a tenth-percentile volume-weighted particle size parameter (e.g., abbreviated as D₁₀), a fiftieth-percentile volume-weighted particle size parameter (e.g., abbreviated as D₅₀), a ninetieth-percentile volume-weighted particle size parameter (e.g., abbreviated as D₉₀), and a ninety-ninth-percentile volume-weighted particle size parameter (e.g., abbreviated as D₉₉). Additionally, parameters relating to characteristic widths of the PSD may be derived from these particle size parameters, such as D₅₀-D₁₀ (sometimes referred to herein as a left width), D₉₀-D₅₀ (sometimes referred to herein as a right width), and D₉₀-D₁₀ (sometimes referred to herein as a full width). A cumulative volume fraction, defined as a cumulative volume of the composite particles with particle sizes of a threshold particle size or less, divided by a total volume of all of the composite particles, may be estimated by LPSA. In some embodiments, a fiftieth-percentile volume-weighted particle size parameter (D₅₀) of the PSD of Si-comprising particles may advantageously be in a range of about 0.5 to about 25.0 μm, or in a range of about 0.5 to about 4.0 μm, or in a range of about 4.0 to about 6.0 μm, or in a range of about 6.0 to about 8.0 μm or in a range of about 8.0 to about 16.0 μm or in a range of about 16.0 to about 25.0 μm. A cumulative volume fraction, defined as a cumulative volume of the composite particles with particle sizes of a threshold particle size or less, divided by a total volume of all of the composite particles, may be estimated by LPSA. In some embodiments (e.g., when the D₅₀ is in a range from about 0.5 μm to about 4.0 μm), the cumulative volume fraction, with the threshold particle size at about 5 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 4.0 μm to about 6.0 μm), the cumulative volume fraction, with the threshold particle size at 7 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 6.0 μm to about 8.0 μm), the cumulative volume fraction, with the threshold particle size at 10 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 8.0 μm to about 16.0 μm), the cumulative volume fraction, with the threshold particle size at 20 μm, may advantageously be about 99 vol. % or less, or about 95 vol. % or less, or about 90 vol. % or less, or about 85 vol. % or less, or about 80 vol. % or less. In yet other embodiments (e.g., when the D₅₀ is in a range from about 16.0 μm to about 25.0 μm), the cumulative volume fraction, with the threshold particle size at 30 μm, may advantageously be about 99 vol. % or less, or about 95 vol. % or less, or about 90 vol. % or less, or about 85 vol. % or less, or about 80 vol. % or less.

Note that in some designs the presence of excessively large Si-comprising particles (e.g., nanocomposite particles, among others) may reduce cell performance characteristics (e.g., reduce cell stability, increase its impedance, reduce rate performance, reduce packing density, reduce electrode smoothness or uniformity, reduce electrode mechanical properties, reduce volumetric capacity, increase (e.g., localized) volume expansion, etc.). In some embodiments (e.g., when the D₅₀ is in a range from about 0.5 μm to about 4.0 μm), the cumulative volume fraction, with the threshold particle size at 10 μm, may advantageously be about 80 vol. % or more, or about 85 vol. % or more, or (in some designs) even about 90 vol. % or more. In some embodiments (e.g., when the D₅₀ is in a range from about 0.5 μm to about 4.0 μm), the cumulative volume fraction, with the threshold particle size at 12 μm, may advantageously be about 90 vol. % or more, or about 95 vol. % or more, or (in some designs) even about 98 vol. % or more. In other embodiments (e.g., when the D₅₀ is in a range from about 4.0 μm to about 6.0 μm), the cumulative volume fraction, with the threshold particle size at 15 μm, may advantageously be about 80 vol. % or more, or about 85 vol. % or more, or (in some designs) even about 90 vol. % or more. In other embodiments (e.g., when the D₅₀ is in a range from about 4.0 μm to about 6.0 μm), the cumulative volume fraction, with the threshold particle size at 25 μm, may advantageously be about 90 vol. % or more, or about 95 vol. % or more, or (in some designs) even about 98 vol. % or more. In other embodiments (e.g., when the D₅₀ is in a range from about 6.0 μm to about 8.0 μm), the cumulative volume fraction, with the threshold particle size at 18 μm, may advantageously be about 80 vol. % or more, or about 85 vol. % or more, or (in some designs) even about 90 vol. % or more. In other embodiments (e.g., when the D₅₀ is in a range from about 4.0 μm to about 6.0 μm), the cumulative volume fraction, with the threshold particle size at 35 μm, may advantageously be about 90 vol. % or more, or about 95 vol. % or more, or (in some designs) even about 98 vol. % or more. In other embodiments (e.g., when the D₅₀ is in a range from about 8.0 μm to about 16.0 μm), the cumulative volume fraction, with the threshold particle size at 40 μm, may advantageously be about 80 vol. % or more, or about 85 vol. % or more, or (in some designs) even about 90 vol. % or more. In other embodiments (e.g., when the D₅₀ is in a range from about 8.0 μm to about 16.0 μm), the cumulative volume fraction, with the threshold particle size at 50 μm, may advantageously be about 90 vol. % or more, or about 95 vol. % or more, or (in some designs) even about 98 vol. % or more.

In one or more embodiments of the present disclosure, Si-comprising active material particles (e.g., composite active material particles, such as Si—C composite particles) may exhibit a true density (e.g., as measured by using an argon gas pycnometer) in the range from about 1.1 g/cc to about 2.8 g/cc (in some designs, from about 1.1 g/cc to about 1.5 g/cc; in other designs, from about 1.5 g/cc to about 1.8 g/cc; in other designs, from about 1.8 g/cc to about 2.1 g/cc; in other designs, from about 2.1 g/cc to about 2.4 g/cc; in yet other designs, from about 2.4 g/cc to about 2.8 g/cc).

In one or more embodiments of the present disclosure, Si-comprising active material particles (e.g., composite active material particles, such as Si—C composite particles) may comprise internal pores (also referred to as “closed pores” which are inaccessible by nitrogen during nitrogen sorption measurements and inaccessible to some electrolyte solvents). In some designs, the open (e.g., to nitrogen gas at 77K) pore volume (e.g., as measured by nitrogen sorption/desorption isotherm measurement technique and including the pores in the range from about 0.4 nm to about 100 nm) may range from about 0.00 cc/g to about 0.50 cc/g (assuming theoretical density of the individual material components present in Si-comprising particles)—in some designs, from about 0.00 cc/g to about 0.10 cc/g; in other designs, from about 0.10 cc/g to about 0.20 cc/g; in other designs, from about 0.20 cc/g to about 0.30 cc/g; in other designs, from about 0.30 cc/g to about 0.40 cc/g; in other designs, from about 0.40 cc/g to about 0.50 cc/g. In some designs, the closed (e.g., to nitrogen gas at 77K) pore volume (e.g., measured by analyzing true density values measured by using an argon gas pycnometer and comparing to the theoretical density of the individual material components present in Si-comprising particles) may range from about 0.00 cc/g to about 1.00 cc/g—in some designs, from about 0.00 cc/g to about 0.10 cc/g; in other designs, from about 0.10 cc/g to about 0.20 cc/g; in other designs, from about 0.20 cc/g to about 0.30 cc/g; in other designs, from about 0.30 cc/g to about 0.40 cc/g; in other designs, from about 0.40 cc/g to about 0.50 cc/g; in other designs, from about 0.50 cc/g to about 0.60 cc/g; in other designs, from about 0.60 cc/g to about 0.70 cc/g; in other designs, from about 0.70 cc/g to about 0.80 cc/g; in other designs, from about 0.80 cc/g to about 0.90 cc/g; in other designs, from about 0.90 cc/g to about 1.00 cc/g). In some designs, the volume-average size of the open (e.g., to nitrogen gas at 77K) pores may range from about 0.5 nm to about 100 nm—in some designs, from about 0.5 nm to about 5 nm; in other designs, from about 5 nm to about 20 nm; in other designs, from about 20 nm to about 50 nm; in yet other designs, from about 50 nm to about 100 nm. In some designs, the volume-average size of the closed (e.g., to nitrogen gas at 77K) pores (e.g., measured by image analysis of cross-sectional electron microscopy images such as SEM or TEM or measured by the neutron scattering or other suitable technique) may range from about 0.5 nm to about 200 nm—in some designs, from about 0.5 nm to about 5 nm; in other designs, from about 5 nm to about 20 nm; in other designs, from about 20 nm to about 50 nm; in other designs, from about 50 nm to about 100 nm; in yet other designs, from about 100 nm to about 200 nm.

In one or more embodiments of the present disclosure, Si-comprising active material particles may exhibit moderate (e.g., about 7-120 vol. %) or high (e.g., about 120-240 vol. % or about 120-200 vol. %) volume changes during initial lithiation (e.g., down to around 0.01 V vs. Li/Li⁺). In some designs, Si-comprising active material particles may exhibit volume changes in the range from about 8 vol. % to about 240 vol. % or from about 8 vol. % to about 180 vol. % during one or more charge-discharge cycles of the battery cell. In one or more embodiments of the present disclosure, Si-comprising active material particles may exhibit moderately small (e.g., about 3-7 vol. %) or moderate (e.g., about 7-120 vol. %) volume changes during electrochemical battery cycling from about 0-5% state of charge (SOC) to about 90-100% SOC and back during battery operation.

In one or more embodiments of the present disclosure, a preferred anode for a battery cell may comprise a mixture of Si-comprising active material particles (e.g., nanocomposite Si—C particles, nanocomposite Si particles, among others) and graphite active material particles (or, more broadly, carbon active material particles, which include natural graphite, synthetic graphite, hard carbon, soft carbon, etc.) as the anode active material, a so-called blended anode. In addition to the anode active material particles, an anode may comprise inactive material, such as binder(s) (e.g., polymer binder) and other functional additives (e.g., surfactants, electrically conductive additives, etc.). In some implementations, the anode active material may be in a range of about 85 wt. % to about 98 wt. % of the total weight of the anode (not counting the weight of the current collector)—in some designs, from about 85 wt. % to about 89 wt. %; in other designs, from about 89 wt. % to about 91 wt. %; in other designs, from about 91 wt. % to about 93 wt. %; in other designs, from about 93 wt. % to about 95 wt. %; in yet other designs, from about 95 wt. % to about 98 wt. %.

In some implementations, blended anodes may comprise Si-comprising particles (e.g., Si—C nanocomposite particles, among others) ranging from about 7 wt. % to about 98 wt. % of all the anode active material particles and the graphite (e.g., particles) making up the remainder of the mass (the weight) of the anode active material particles (from about 2 wt. % to about 93 wt. %). In some designs, the Si-comprising particles (e.g., Si—C nanocomposite particles, etc.) comprise from about 7 wt. % to about 15 wt. % of the blended anode active material particles; in other designs—from about 15 wt. % to about 25 wt. % of the blended anode active material particles; in other designs—from about 25 wt. % to about 40 wt. % of the blended anode active material particles; in other designs—from about 40 wt. % to about 60 wt. % of the blended anode active material particles; in other designs—from about 60 wt. % to about 80 wt. % of the blended anode active material particles; in yet other designs—from about 80 wt. % to about 98 wt. % of the blended anode active material particles.

While the descriptions below may also describe certain examples of the blended anode formulations expressed as mass (wt. %) of Si-comprising particles (e.g., Si—C nanocomposite particles, among others) among the anode active materials or as mass (wt. %) of Si-comprising particles (e.g., Si—C nanocomposite particles, etc.) in the total anode (not counting the weight of the current collector), it will be appreciated that various aspects of this disclosure may be applicable to blended anode formulations expressed as wt. % of Si in the anode (counting the weight of all the active materials, binder, conductive and other additives, but not counting the weight of the current collector). In some implementations, a blended anode composition of about 7 wt. % of Si-comprising particles (e.g., Si—C nanocomposite particles, among others) (relative to the total weight of all the active materials in the anode, binder(s), conductive and other additive(s), but not counting the weight of the current collector) may correspond, for example, to about 3 wt. % of Si in the blended anode. In some implementations, a blended anode composition of about 19 wt. % of Si-comprising particles (e.g., Si—C nanocomposite particles, among others) may correspond, for example, to about 8 wt. % of Si in the blended anode. In some implementations, a blended anode composition of about 35 wt. % of Si-comprising particles (e.g., Si—C nanocomposite particles, among others) may correspond, for example, about 15 wt. % of Si in the blended anode. In some implementations, a blended anode composition of about 50 wt. % of Si-comprising particles (e.g., Si—C nanocomposite particles, among others) may correspond, for example, to about 21 wt. % of Si in the blended anode. In some implementations, a blended anode composition of about 70 wt. % of Si-comprising particles (e.g., Si—C nanocomposite particles, among others) may correspond, for example, to about 30 wt. % of Si in the blended anode. In some implementations, a blended anode composition of about 90 wt. % of Si-comprising particles (e.g., Si—C nanocomposite particles, among others) may correspond, for example, to about 38 wt. % of Si in the blended anode. The wt. % of Si in the anode depends on the wt. % of Si in the Si-comprising particles, the wt. % of the binder and conductive additives and the wt. % of the graphite in the blended anode. Smaller fractions of inactive materials (e.g., binder and conductive or other additives), higher fraction of Si in the Si-comprising anode material particles (e.g., Si—C composite particles) and smaller fraction of graphite in the blended anode result in higher wt. % Si in the anode. For example, in some implementations, a blended anode composition of about 80 wt. % of Si-comprising particles (e.g., Si—C nanocomposite particles, among others) and about 20 wt. % of the total of binder(s), conductive or other additive(s) (if present) and graphite may correspond, for example, to about 30 wt. % of Si in the blended anode. In other implementations, a blended anode composition of also about 80 wt. % of Si-comprising particles (e.g., Si—C nanocomposite particles, among others) and about 20 wt. % of the total of binder(s), conductive or other additive(s) (if present) and graphite may correspond, for example, to about 40 wt. % of Si in the blended anode. In other implementations, a blended anode composition of also about 80 wt. % of Si-comprising particles (e.g., Si—C nanocomposite particles, among others) and about 20 wt. % of the total of binder(s), conductive or other additive(s) (if present) and graphite may correspond, for example, to about 50 wt. % of Si in the blended anode. In other implementations, a blended anode composition of also about 80 wt. % of Si-comprising particles (e.g., Si—C nanocomposite particles, among others) and about 20 wt. % of the total of binder(s), conductive or other additive(s) (if present) and graphite may correspond, for example, to about 60 wt. % of Si in the blended anode. In respective implementations, blended anodes may be obtained in which the mass (weight) of the silicon is in a range of about 3 wt. % to about 60 wt. % of a total mass of the anode (not counting the weight of the current collector) (e.g., in a range of about 3 wt. % to about 10 wt. %, or in a range of about 10 wt. % to about 25 wt. %, or in a range of about 25 wt. % to about 50 wt. %, or in a range of about 50 wt. % to about 60 wt. %, or in a range of about 10 wt. % to about 60 wt. %).

While the descriptions below may also describe certain examples of the blended anode formulations expressed as mass (wt. %) of Si-comprising particles (e.g., Si—C nanocomposite particles, etc.) in the active material blends, it will be appreciated that various aspects of this disclosure may be applicable to blended anode formulations attributing a fraction (e.g., %) of the total capacity of the blended anode to the capacity of the Si-comprising particles. In some implementations, for example, about 25% of the total capacity of the blended anode may be obtained from the Si-comprising particles (e.g., Si—C nanocomposite particles, etc.) in a blended anode composition of about 5-8 wt. % of Si-comprising particles (e.g., Si—C nanocomposite particles, etc.) relative to the total weight of active particles (both Si-comprising and graphite particles). In some other implementations, as another example, about 50% of the total capacity of the blended anode may be obtained from the Si-comprising particles (e.g., Si—C nanocomposite particles, etc.) in a blended anode composition of about 15-21 wt. % of Si-comprising particles (e.g., Si—C nanocomposite particles, etc.). In some other implementations, about 70% of the total capacity of the blended anode may be obtained from the Si-comprising particles (e.g., Si—C nanocomposite particles, etc.) in a blended anode composition of about 30-40 wt. % of Si-comprising particles (e.g., Si—C nanocomposite particles, etc.). In some other implementations, about 80% of the total capacity of the blended anode may be obtained from the Si-comprising particles (e.g., Si—C nanocomposite particles, etc.) in a blended anode composition of about 45-55 wt. % of Si-comprising particles (e.g., Si—C nanocomposite particles, etc.). In some other implementations, about 92% of the total capacity of the blended anode may be obtained from the Si-comprising particles (e.g., Si—C nanocomposite particles, etc.) in a blended anode composition of about 65-75 wt. % of Si-comprising particles (e.g., Si—C nanocomposite particles, etc.). In some other implementations, about 95% of the total capacity of the blended anode may be obtained from the Si-comprising particles (e.g., Si—C nanocomposite particles, etc.) in a blended anode composition of about 75-85 wt. % of Si-comprising particles (e.g., Si—C nanocomposite particles, etc.). In some other implementations, about 98% of the total capacity of the blended anode may be obtained from the Si-comprising particles (e.g., Si—C nanocomposite particles, etc.) in a blended anode composition of about 85-95 wt. % of Si-comprising particles (e.g., Si—C nanocomposite particles, etc.). Note that the exact % capacity provided by the Si-comprising particles in the blended anode having a specific wt. % of the Si-comprising particles depends on the specific capacity of the plurality of the Si-comprising active material particles and the specific capacity of the plurality of graphite (or, broadly, carbon) active material particles.

In some embodiments, the battery anode composition may advantageously comprise one or more carbon-comprising functional additives (e.g., additives that enhance electrical conductivity or rate performance of mechanical properties of the electrode). In some embodiments, the carbon-comprising functional additive is selected from: carbon nanotubes (e.g., single walled carbon nanotubes (SWCNTs), multi-walled carbon nanotubes (MWCNTs), carbon nanofibers, carbon black, graphite, exfoliated graphite, graphene oxide and graphene (including but not limited to defective, curved, porous and/or functionalized multi-walled (e.g., with an average of about 2-60 walls) or single-walled graphene). In some embodiments, the carbon-comprising functional additive is functionalized or coated with a thin polymer layer. In some embodiments, the functionalized carbon-comprising functional additive is pre-dispersed in a solvent (e.g., water) prior to mixing into an electrode slurry. In some embodiments, the battery electrode composition may comprise one or more binders (in some designs, two or more binder components). In some designs, the polymer layer on the surface of a carbon-comprising functional additive is essentially of the same or similar composition as the binder.

An aspect is directed to a battery anode. In some embodiments, the battery anode comprises any of the foregoing battery anode electrode compositions, disposed on or in a current collector (e.g., Cu-based or Cu-containing current collector, such as a dense or porous foil or a mesh or a foam or a nanowire-comprising or nanoflake-comprising current collector, etc.). In some embodiments, the battery anode comprises a battery electrode composition and a binder. In some embodiments, a coating density of the battery electrode is in a range of about 0.8 to about 1.7 g/cm³ (in some designs, from about 0.8 to about 0.9 g/cm³; in other designs, from about 0.9 to about 1.0 g/cm³; in other designs, from about 1.0 to about 1.2 g/cm³; in other designs, from about 1.2 to about 1.4 g/cm³, in yet other designs, from about 1.4 to about 1.7 g/cm³). Higher fraction of suitable graphite material in a blended anode may benefit from higher anode density for better performance (e.g., better stability, better rate performance, higher volumetric capacity, lower swell during cycling, etc.), although excessive density may also be detrimental for the same or other characteristics. As such, detailed optimization may be conducted for a particular battery design, electrode thickness, areal capacity loading, battery cycling environment and regime, among other factors.

An aspect is also directed to a blended battery anode, wherein both the Si-comprising primary anode active particles (e.g., nanocomposite Si—C particles, among others) and graphite (or, broadly, carbon-based) active anode material may be present. The anode may preferably comprise a binder amount optimized for the properties of both the Si-comprising active material particles' plurality and the graphite particles' plurality. For example, the anode may be characterized by an areal binder loading, defined as a mass of the binder in the battery anode (e.g., measured in mg) normalized by the surface area of the active material particles (e.g., Si-comprising (e.g., nanocomposite, etc.) active anode material particles and (if present) graphite active material particles in the same battery anode (e.g., measured in m² and defined by the mass of active material particles (in g) multiplied Brunauer-Emmett-Teller (BET) specific surface area (SSA, in m²/g)). Since a BET SSA of both the Si-comprising active material particle population and the graphite active material particle population may vary from a slurry to a slurry, the binder loading may preferably be adjusted based on the desired areal binder loading. Higher BET SSA of the active anode materials (measured in m²/g) typically require a higher mass fraction of the binder in the anode electrode. For example, the anode electrode comprising active material particle population (e.g., Si-comprising (e.g., nanocomposite, etc.) active anode material particle population or a blend of Si-comprising active material(s) and a graphite active material(s)) with BET SSA of 10 m²/g may utilize from about 20 mg to about 150 mg of the binder per 1 g of active particles (approximately 2-13 wt. % relative to the total weight of the binder+active material composition, not counting the weight of conductive or other additives or the weight of the current collector), while another anode electrode comprising another active material particle population (e.g., Si-comprising (e.g., nanocomposite, etc.) active anode material particle population or a blend of Si-comprising active material(s) and a graphite active material(s)) with BET SSA of only about 1 m²/g may utilize from about 2 mg to about 40 mg of the binder per 1 g of active particles (approximately 0.2-4 wt. % relative to the total weight of the binder+active material composition, not counting the weight of conductive or other additives or the weight of the current collector). However, in some designs, an areal binder loading of the battery anode in both cases is in the range from about 2.0 mg/m² to about 40.0 mg/m² (e.g. in some designs, from about 2.0 mg/m² to about 5.0 mg/m²; in other designs, from about 5.0 mg/m² to about 9.0 mg/m²; in yet other designs, from about 9.0 mg/m² to about 15.0 mg/m²; in yet other designs, from about 15.0 mg/m² to about 40.0 mg/m²). In some designs, a higher fraction of Si-comprising (e.g., nanocomposite, etc.) active anode material particle population in the anode (relative to the total weight of all active materials) may preferably utilize a higher areal binder loading. In some designs, a larger average size of Si-comprising (e.g., nanocomposite, etc.) active anode material particle population in the anode may preferably utilize a slightly higher areal binder loading. In some designs, a larger BET SSA of Si-comprising (e.g., nanocomposite, etc.) active anode material particle population in the anode may preferably utilize a slightly smaller areal binder loading. In some designs, the areal binder loading may also depend on the binder composition and properties (e.g., adhesion, chemical composition, hardness, elastic modulus when exposed to electrolyte, maximum elongation at break, among others). Thus, the optimal areal binder loading content within a relatively a range of about 2.0 mg/m² to about 40.0 mg/m² depends on the anode composition. So, the optimal areal binder loading content in some designs may range from about 2.0 mg/m² to about 5.0 mg/m²; in other designs, from about 5.0 mg/m² to about 9.0 mg/m²; in yet other designs, from about 9.0 mg/m² to about 15.0 mg/m²; in yet other designs, from about 15.0 mg/m² to about 40.0 mg/m²).

While the description below may describe certain examples of suitable intercalation-type graphites to be used in combination with Si-comprising (e.g., Si—C nanocomposites, etc.) active anode material particles in a blend, it will be appreciated that various aspects of this disclosure may be applicable to various soft-type synthetic graphite (or soft carbon, broadly), various hard-type synthetic graphite (or hard carbon, broadly), and various natural graphite (which may, for example, be pitch carbon coated, among others); including but not limited to those which exhibit discharge capacity from about 320 to about 372 mAh/g (e.g., in some designs, from about 320 to about 350 mAh/g; or in other designs, from about 350 to about 362 mAh/g; or in other designs, from about 362 to about 372 mAh/g); including but not limited to those which exhibit low, moderate and high swelling; including but not limited to those which exhibit good and poor compression, including but not limited to those which exhibit BET SSA of about 0.5 to about 40 m²/g (e.g., in some designs, from about 0.5 to about 2 m²/g; or in other designs, from about 2 to about 4 m²/g; or in other designs, from about 4 to about 6 m²/g; or in other designs, from about 6 to about 8 m²/g; or in other designs, from about 8 to about 10 m²/g; or in other designs, from about 10 to about 14 m²/g; or in other designs, from about 14 to about 20 m²/g; or in other designs, from about 20 to about 40 m²/g); including but not limited to those which exhibit lithiation efficiency of about 85-90% and more; including but not limited to those which exhibit true densities ranging from about 1.5 g/cm³ to about 2.3 g/cm³ (e.g., in some designs, from about 1.5 to about 1.8 g/cm³, in other designs, from about 1.8 to about 2.3 g/cm³); including but not limited to those which exhibit poor, moderate, or good cycle life when used in Li-ion battery anodes on their own (e.g., without Si-comprising or other active particles); including but not limited to those which are coated and comprise coatings with coating thickness to appreciably improve compression and springing during cycling.

An aspect is directed to a battery and an anode comprising Si-comprising particles that also comprise C (e.g., Si—C nanocomposite particles, C-coated particles, etc.), wherein the average domain size of C ranges from around 10 Å (1 nm) to around 60 Å (6 nm), as determined by Synchrotron X-ray diffraction (XRD) atomic pair distribution function (PDF) analysis.

An aspect is directed to a battery and an anode comprising Si-comprising particles that also comprise C (e.g., Si—C nanocomposite particles, C-coated particles, etc.), wherein the ratio of intensities of the carbon D band and carbon G band (I_{D}/I_{G}) in the Raman spectra of the majority of Si—and C-comprising particles (measured, for example, using the laser wavelength of about 532 nm; and analyzed, for example, in the spectral range from about 1000 to about 2000 wavenumber cm⁻¹ by fitting two Gaussian peaks after a linear background subtraction in this range) to range from I_{D}/I_{G} of about 0.7 to I_{D}/I_{G} of about 2.7 (in some designs, from about 0.7 to about 0.9; in other designs, from about 0.9 to about 1.2; in other designs, from about 1.2 to about 1.5; in other designs, from about 1.5 to about 1.8; in other designs, from about 1.8 to about 2.1; in other designs, from about 2.1 to about 2.4; in yet other designs, from about 2.4 to about 2.7).

An aspect is also directed to a Li-ion battery comprising: (i) a suitable battery anode, wherein the suitable anode may comprise one or more of the following, in some designs: (ia) Si-comprising anode comprising Si-comprising anode particles (e.g., nanocomposite Si—C particles, silicon oxide particles, silicon nitride particles, among others), which, in some designs may also be a blended battery anode (wherein both the Si-comprising primary anode active particles (e.g., nanocomposite Si—C particles or silicon oxide particles or silicon nitride particles, among others) and suitable graphite (or, broadly, carbon-based) primary anode active particles are present in the anode), (ib) intercalation-type carbon (C)—comprising anode comprising natural graphite, synthetic graphite, hard carbon or soft carbon or their various combinations or (ic) metal oxide-comprising anode (e.g., Li, Ti, Nb, Mo, V and/or W-comprising metal oxides, such as, for example, lithium titanium oxide, niobium titanium oxide, niobium molybdenum oxide, niobium molybdenum titanium oxide, niobium tungsten oxide, niobium tungsten molybdenum oxide, niobium tungsten molybdenum titanium oxide, vanadium oxide, their various combinations and mixtures, etc.) or (id) their various combinations, and (ii) a suitable battery cathode, wherein the suitable cathode may comprise one or more of the following, in some designs: (iia) intercalation-type cathode or (iib) conversion-type cathode (which may include a displacement-type cathode, a chemical transformation type cathode or a true conversion-type cathode) or (iic) a mixed intercalation/conversion type cathode (either a physical mixture of (iia) and (iib) or a cathode that exhibits both intercalation-type or conversion-type Li ion storage).

In some designs, the suitable cathode may advantageously comprise one, two or more of the following additives (e.g., in the form of particles, nanoparticles, nanofibers, flakes or nanoflakes): natural graphite, synthetic graphite, graphene, exfoliated graphite, hard carbon, soft carbon, carbon black, carbon fibers, carbon nanofibers, carbon nanotubes in the total amount from around 0.1 wt. % to about 15 wt. % relative to the total weight of the cathode layer but not counting the weight of the cathode current collector (in some designs, from about 0.1 wt. % to about 0.5 wt. %; in other designs, from about 0.5 wt. % to about 2 wt. %; in other designs, from about 2 wt. % to about 5 wt. %; in yet other designs, from about 5 wt. % to about 15 wt. %).

Illustrative examples of suitable intercalation-type cathodes to be used in preferable cells may include, but are not limited to: lithium nickel cobalt aluminum oxides (NCA), lithium nickel cobalt manganese aluminum oxides (NCMA), lithium nickel oxides (LNO), lithium manganese oxides (LMO), lithium nickel manganese cobalt oxides (NCM), lithium cobalt oxide (LCO), lithium cobalt aluminum oxides (LCAO), lithium iron phosphate (LFP), lithium cobalt phosphate (LCP), lithium manganese phosphate (LMP), lithium manganese iron phosphate (LMFP), lithium nickel phosphate (LiNiPO₄), lithium vanadium fluoro phosphate (LiVFPO₄), lithium iron fluoro sulfate (LiFeSO₄F), various Li excess materials (e.g., lithium excess (rocksalt) transition metal oxides and oxy-fluorides such as those comprising Mn, Mo, Cr, Ti, and/or Nb, such as, for example, Li_{1.211}Mo_{0.467}Cr_{0.302}, Li_{1.3}Mn_{0.4}Nb_{0.302}, Li_{1.2}Mn_{0.4}Ti_{0.4}O₂, Li_{1.2}Ni_{0.333}Ti_{0.333}Mo_{0.133}O₂ and many others), various high capacity Li-ion based materials with partial substitution of oxygen for fluorine or iodine (e.g., disordered or ordered rocksalt compositions comprising Mn, Mo, Cr, Ti and/or Nb, such as, for example, Li₂Mn_{2/3}Nb_{1/3}O₂F, Li₂Mn_{1/2}Ti_{1/2}O₂F, Li_{1.5}Na_{0.5}MnO_{2.85}I_{0.12}, among others) and many other types of Li-comprising disordered, layered, tavorite, olivine, or spinel type active materials or their mixtures comprising at least oxygen or fluorine or sulfur and at least one transition metal and other lithium transition metal (TM) oxides or phosphates or sulfates (or mixed) cathode active materials that rely on the intercalation of lithium (Li) and changes in the TM oxidation state (including, but not limited to those that may be doped or heavily doped; including, but not limited to those that have gradient in composition or core-shell morphology; including, but not limited to those that may be partially fluorinated or comprise some meaningful fraction of fluorine (e.g., about 0.001-10 at. %) in their composition, etc.). It will also be appreciated that various aspects may be applicable to high-voltage lithium transition metal oxide (or phosphate or sulfate or mixed or other) cathodes where TMs and oxygen (O) are covalently bonded and both TM and O take part in electrochemical reduction-oxidation (redox) reactions during charge and discharge (including, but not limited to, those oxides or phosphate or sulfate or mixed cathodes that may comprise at least about 0.25 at. % of Mn, Fe, Ni, Co, Nb, Mg, Cr, Mo, Zr, W, Ta, Ti, Hf, Y, La, Sb, V, Sn, Si, or Ge).

Illustrative examples of suitable conversion-type cathodes to be used in preferable cells may include, but are not limited to: metal fluorides, metal oxy-fluorides, metal chlorides, metal sulfides, metal selenides, their various mixtures, composites and others. Illustrative examples of metal fluorides, in a Li-free state, include, but are not limited to FeF₃, FeF₂, MnF₃, CuF₂, NiF₂, BiF₃, BiF₅, SnF₂, SnF₄, SbF₃, SbF₅, CdF₂, ZnF₂, TiF₃, TiF₄, AgF, AgF₂, NbF₅, NbF₄, MoF₅, MoF₄, MoF₃, ZrF₄, BaF₂, SrF₂, YF₃, LaF₃, PbF₂, PbF₄, CeF₃, CeF₄, SmF₃, CaF₂, their various mixtures, alloys and combinations, among others. In some designs, Fe may contribute to the majority (e.g., about 50-100 at. %; in some designs, about 75-100 at. %) of the transition metals in the metal fluoride cathodes. In some designs, Cu may contribute to the majority (e.g., about 50-100 at. %; in some designs, about 75-100 at. %) of the transition metals in the metal fluoride cathodes. In some designs, it may be advantageous to produce nanocomposites and/or core-shell structures comprising metal fluorides to enhance their performance and stability. In some designs, it may be advantageous to dope metal fluorides with oxygen or utilize metal oxy-fluorides. In a fully lithiated state, pure metal fluorides convert to a composite comprising a mixture of metal and LiF clusters (or nanoparticles). Examples of the overall reversible reactions of the conversion-type metal fluoride cathodes may include 2Li+CuF₂↔2LiF+Cu for CuF₂-based cathodes or 3Li+FeF₃↔3LiF+Fe for FeF₃-based cathodes. It will be appreciated that metal fluoride-based cathodes may be prepared in Li-free or partially lithiated or fully lithiated states. In addition to fluorides, other illustrative examples of conversion-type active electrode materials may include, but are not limited to, various metal oxy-fluorides, sulfo-fluorides, chloro-fluorides, oxy-chloro-fluorides, oxy-sulfo-fluorides, fluoro-phosphates, sulfo-phosphates, sulfo-fluoro-phosphates, mixtures of metals (e.g., Fe, Cu, Ni, Co, Bi, Cr, Zn, Ti, other metals, their various mixtures and alloys, partially oxidized metals and metal alloys, etc.) and salts (metal fluorides (including LiF or NaF), metal chlorides (including LiCl or NaF), metal oxy-fluorides, metal oxides, metal sulfo-fluorides, metal fluoro-phosphates, metal sulfides, metal oxy-sulfo-fluorides, their various combinations, etc.), and other salts that comprise halogen or sulfur or oxygen or phosphorous or a combination of these elements, among others. In some designs, F in metal fluorides may be fully or partially replaced with another halogen (e.g., Cl or Br or I, etc.) or their mixtures to form the corresponding metal chlorides or metal fluoride-chlorides and other metal halide compositions. Yet another example of a promising and suitable conversion-type cathode active material is sulfur (S) (in a Li-free state) or lithium sulfide (Li₂S, in a fully lithiated state). In some designs, selenium (Se) may also be used together with S or on its own for the formation of such cathode active materials. In some designs, it may be advantageous to produce nanocomposites and/or core-shell structures comprising S, LizS, Se, Li₂Se or their various mixtures and combinations to enhance their performance and stability. In some designs, conversion-type active cathode materials may also advantageously comprise metal oxides or mixed metal oxides. In some designs, such (nano)composites may advantageously comprise metal sulfides or mixed metal sulfides. In some examples, mixed metal oxides or mixed metal sulfides may comprise lithium. In some examples, mixed metal oxides may comprise titanium or vanadium or manganese or iron metal. In some examples, lithium-comprising metal oxides or metal sulfides may exhibit a layered structure. In some examples, metal oxides or mixed metal oxides or metal sulfides or mixed metal sulfides may advantageously be both ionically and electrically conductive (e.g., in the range from around 10⁻⁷ to around 10⁺⁴ S/cm). In some examples, various other intercalation-type active materials may be utilized instead of or in addition to metal oxides or metal sulfides. In some designs, such an intercalation-type active material exhibits charge storage (e.g., Li insertion/extraction capacity) in the potential range close to that of S or Li₂S (e.g., within around 1.5-3.8 V vs. Li/Li⁺). In some designs, the use of so-called Li-air cathodes (e.g., cathodes with active material in the form of Li₂O₂, Li₂O, LiGH in their lithiation state) or similar metal-air cathodes based on Na, K, Ca, Al, Fe, Mn, Zn and other metals (instead of Li) may similarly be beneficial due to their very high capacities. In some designs, such cathode active materials should ideally reversibly react with oxygen or oxygen containing species in the electrochemical cell and may fully disappear upon full de-lithiation (metal removal). These are also considered to belong to conversion-type cathodes.

In some of the preferred examples a surface of cathode active materials (e.g., intercalation-type cathode materials, such as LCO, NCM, NCMA, NCA, LMO, LMNO, LFP, LMP, LMFP, etc. or conversion-type active materials comprising S, Li₂S, metal sulfides, metal fluorides, etc.) may be coated with a layer of ceramic material. In some of the preferred examples a surface of cathode active materials may be coated with a layer of a polymeric material. Illustrative examples of a preferred coating material for such cathodes include, but are not limited to, various oxides and oxy-fluorides, such as titanium oxide (e.g., TiO₂), aluminum oxide (e.g., Al₂O₃), tungsten oxide (e.g., WO), molybdenum oxide (e.g., MoO or MoO₂), chromium oxide (e.g., Cr₂O₃), niobium oxide (e.g., NbO or NbO₂) and zirconium oxide (e.g., ZrO₂) and their various mixtures. In some designs, such ceramic materials may additionally comprise lithium (Li)—e.g., as lithium titanium oxide (or oxyfluoride), lithium aluminum oxide (or oxyfluoride), lithium tungsten oxide (or oxyfluoride), lithium chromium oxide (or oxyfluoride), lithium niobium oxide (or oxyfluoride), lithium zirconium oxide (or oxyfluoride) and their various alloys, mixtures and combinations. In other preferred examples, LCO, NCM, NCMA, NCA, LFP, LMFP, LMP, LMO or LMNO may be doped with Al, Ti, Mg, Nb, Zr, Cr, Hf, Ta, W, Mo or La. In some designs, a preferred cathode current collector material is aluminum or aluminum alloy or an aluminum-comprising composite. In some designs, a preferred battery cell includes a polymer or polymer-comprising separator membrane or a polymer-comprising separator layer. In some of the preferred examples, a polymer separator is made of or comprises polyethylene, polypropylene or a mixture thereof. In some of the preferred examples, a surface of a polymer separator (membrane or layer) is coated with a layer of ceramic material, or a polymer separator (membrane or layer) may comprise ceramic material. Examples of a preferred coating material for polymer separators may include, but not limited to titanium oxide (TiO₂), aluminum oxide (Al₂O₃), aluminum hydroxide or oxyhydroxide, zirconium oxide (ZrO₂), magnesium oxide (MgO) or magnesium hydroxide or oxyhydroxide.

An aspect is directed to a Li-ion battery with a Si-comprising anode or with a blended anode (e.g., comprising Si-comprising active material and graphite active material, etc.) that exhibits a relatively high areal capacity loadings and properly matched (by areal capacity) cathode (with slightly smaller areal capacity loadings, selected according to the desired negative (N) to positive (P) ratio, N/P in the range of around 1:01 to around 1:35—in some designs, from around 1.01 to around 1.05; in other designs, from around 1.05 to around 1.10; in other designs, from around 1.10 to around 1.15; in other designs from around 1.15 to around 1.20; in other designs from around 1.20 to around 1.25; in yet other designs, from around 1.25 to around 1.35; wherein the N/P ratio corresponds to the ratio of the reversible areal capacities of the anode to cathode). Note that both the performance characteristics and cycle stability of Li-ion battery cells may become particularly unsatisfactory for applications requiring long calendar life or long cycle life or low first cycle losses or other properties, if the electrode areal capacity loading exceeds around 1-2 mAh/cm², even more if the electrode areal capacity exceeds around 4-5 mAh/cm², more if the electrode areal capacity exceeds around 6 mAh/cm² and yet even more if the electrode areal capacity exceeds around 8 mAh/cm². Higher loading, however, is advantageous for reducing cost of energy storage devices and increasing their energy density. One or more embodiments of the present disclosure are directed to fabrication processes, compositions and various physical and chemical properties of anodes and cathodes that provide satisfactory performance for electrode areal capacity loadings in the range from around 2 mAh/cm² to around 4 mAh/cm² and more so for loadings in the range from around 4 mAh/cm² to around 8 mAh/cm² and even more so for loadings in the range from around 8 mAh/cm² to around 16 mAh/cm² (e.g., in some designs, an areal capacity loading of an electrode composition may range from around 2 mAh/cm² to around 16 mAh/cm²).

One or more aspects of the present invention are directed to battery or battery cell compositions with Si-comprising anodes, where higher energy density, higher power density, better cycle life, lower resistance and/or other improved critical battery parameters may be attained. Such improvements, as will be described in more detail below, are not trivial. Many of such improvements, as will be described in more detail below, are very unexpected. In particular as an example, attaining better cycle life or attaining lower cell resistance by the addition of functionalized pre-lithiation particles (FPLiPs) in Si-comprising anodes is counter-intuitive.

In some embodiments, the disclosed Li-ion battery cell comprises: (i) FPLiP- and Si-comprising anode (e.g., an anode comprising suitable Si-comprising anode materials, such as Si—C nanocomposites (e.g., nanocomposite particles), and FPLiPs, with suitable properties, among others) and (ii) a cathode comprising suitable primary cathode active materials.

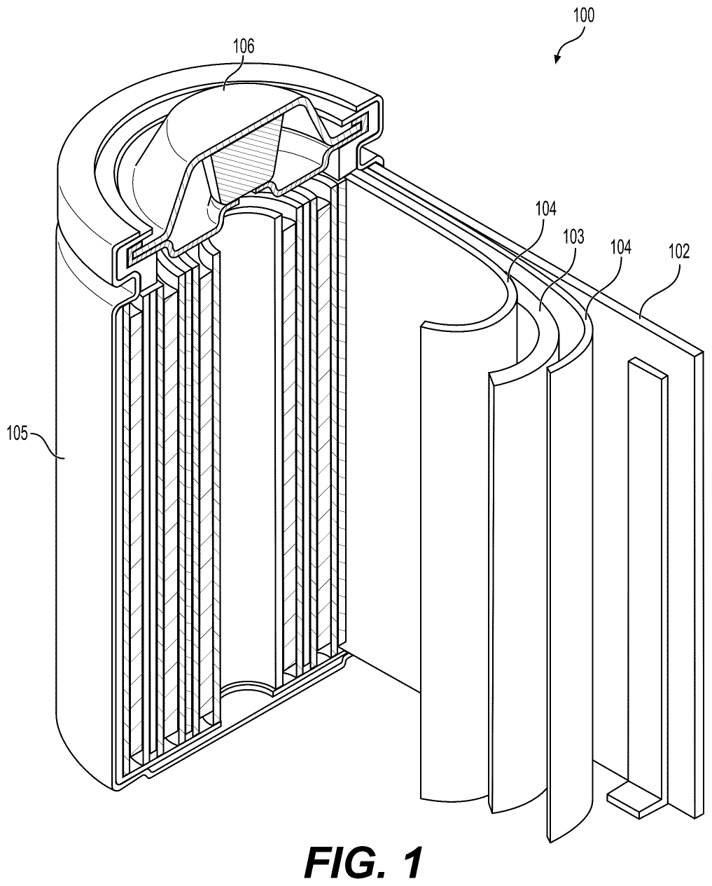

FIG. 1 illustrates an example metal-ion (e.g., Li-ion) battery in which the electrode particles, components, materials, processes, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative electrode (anode electrode or anode) 102, a positive electrode (cathode electrode or cathode) 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). The electrolyte is interposed between the anode electrode and the cathode electrode. In some implementations, battery 100 also includes an anode current collector and a cathode current collector. The anode is disposed on or in the anode current collector and the cathode is disposed on or in the cathode current collector.

In accordance with some embodiments of the present disclosure, an electrolyte for use in a Li-ion battery comprises a salt composition and an electrolyte solvent composition. The salt composition may comprise a primary salt, the primary salt being at least about 50 mol. % of the salt composition. In some implementations, the primary salt may be selected from: LiPF₆, lithium tetrafluoroborate (LiBF₄), lithium bis(fluorosulfonyl)imide (LiFSI), lithium bis(trifluoromethanesulfonyl)imide (LiTFSI), and lithium fluorosulfate (LiSO₃F). In some implementations, the salt composition additionally comprises at least one other salt (a “secondary salt”), the secondary salt being selected from: lithium bis(fluorosulfonyl)imide (LiFSI), lithium tetrafluoroborate (LiBF₄), lithium difluoro(oxalato)borate (LiDFOB), lithium bis(oxalato)borate (LiBOB), lithium difluorophosphate (LiDFP), lithium fluorosulfate (LiSO₃F), and lithium bis(trifluoromethanesulfonyl)imide (LiTFSI).

In some designs utilizing two or more salts (e.g., two salts or three salts or four salts or five salts, etc.), it may be advantageous for the salt composition to comprise LiPF₆ as a primary salt. Herein, the term “primary salt” refers to a salt that is of at least 50 wt. % of the salt composition. Herein, the term “primary salt mixture” refers to a mixture of salts in which (a) each salt in the mixture is a greater weight fraction of the salt composition than any of the other salts not in the mixture and (b) the mixture is of at least 50 wt. % of the salt composition. In some designs, the incorporation of such salts (i.e., the two or more salts) may enhance properties of the cathode electrolyte interphase (CEI) or of the anode solid electrolyte interphase (SEI), resulting in improvements in cycle stability, battery resistance, thermal stability, high-temperature performance, low-temperature performance, and/or other performance characteristics. Furthermore, in some designs, it may be advantageous for at least one other salt (i.e., secondary salt) to also be a salt of Li. Examples of some of such suitable secondary salts include: LiFSI, LiTFSI, Li bis(pentafluoroethanesulfonyl)imide (LiBETI) (and other Li imide salts), Li bis(oxalato)borate (LiBOB), Li difluoro(oxalato)borate (LiDFOB), Li 2-trifluoromethyl-4,5-dicyanoimidazolide (LiTDi), Li 4,5-dicyano-2-(pentafluoroethyl) imidazolide (LiPDi), LiDFP, and Li nitrate (LiNO₃). In some designs, it may be advantageous for the salt composition to comprise LiFSI as a primary salt. Yet, in some other designs, a mixture of LiPF₆ and LiFSI may advantageously be used as a primary salt mixture.

Li-ion batteries may benefit from the use of certain electrolyte compositions in battery cell fabrication to attain superior characteristics. In some designs, suitable electrolyte composition may comprise (i) one, two, three or more Li salts with the total concentration in the range from about 0.8M to about 2.0M (in some designs, from about 0.8M to about 1.0M; in other designs, from about 1M to about 1.1M; in other designs, from about 1.1M to about 1.2M; in other designs, from about 1.2M to about 1.3M; in other designs, from about 1.3M to about 1.4M; in other designs, from about 1.4M to about 1.5M; in other designs, from about 1.5M to about 1.6M; in other designs, from about 1.6M to about 1.7M; in other designs, from about 1.7M to about 1.8M; in other designs, from about 1.8M to about 2.0M); (ii) one, two or more cyclic carbonates (in some designs, fluorinated cyclic carbonates, such as fluoroethylene carbonate (FEC), and in some designs, vinylene carbonate (VC), among others), (iii) zero, one, two, three or more nitrogen-comprising co-solvents (in some designs, at least some of the nitrogen comprising co-solvents may advantageously comprise two or three or more nitrogen atoms per molecule), (iv) zero, one, two, three or more sulfur comprising additives, (v) zero, one, two, three or more phosphorous comprising additives (note that some co-solvents may advantageously comprise both phosphorus and sulfur), (vi) zero, one, two, three or more linear or branched esters as co-solvents, (vii) zero, one, two, or more linear carbonates as co-solvents, (viii) zero, one, two, three or more additional electrolyte co-solvents or additives.

In some designs, an electrolyte (the electrolyte solvent composition) may comprise FEC and VC. In some designs, suitable electrolyte may comprise one or more of the following SEI-building cyclic carbonate compounds, e.g.: fluoroethylene carbonate (FEC), ethylene carbonate (EC), vinylene carbonate (VC), among others.

In some implementations, the electrolyte solvent composition additionally comprises (1) at least one ester compound and/or (2) at least one linear carbonate compound; the at least one ester compound is selected from propyl propionate (PP), methyl butyrate (MB), ethyl propionate (EP), ethyl isobutyrate (EI), ethyl isovalerate (EIV), methyl acetate (MA), ethyl trimethylacetate (ET), ethyl acetate (EA), and ethyl butyrate (EB); and the at least one linear carbonate compound is selected from dimethyl carbonate (DMC), ethyl methyl carbonate (EMC), and diethyl carbonate (DEC).

In some aspects, the electrolyte solvent composition additionally comprises at least one cyclic carbonate compound; and the at least one cyclic carbonate compound is selected from ethylene carbonate (EC) and propylene carbonate (PC).

In some designs, the volume fraction of linear esters (as a fraction of all co-solvents in the electrolyte) may range from about 20 vol. % to about 85 vol. % (in some designs, from about 20 vol. % to about 40 vol. %; in other designs, from about 40 vol. % to about 60 vol. %; in yet other designs, from about 60 vol. % to about 85 vol. %). In some designs, the volume fraction of branched esters (as a fraction of all co-solvents in the electrolyte) may range from about 10 vol. % to about 80 vol. % (in some designs, from about 10 vol. % to about 30 vol. %; in other designs, from about 30 vol. % to about 60 vol. %; in yet other designs, from about 60 vol. % to about 80 vol. %). In some designs, the volume fraction of cyclic carbonates (as a fraction of all co-solvents in the electrolyte) may range from about 5 vol. % to about 40 vol. % (in some designs, from about 5 vol. % to about 10 vol. %; in other designs, from about 10 vol. % to about 20 vol. %; in yet other designs, from about 20 vol. % to about 40 vol. %). In some designs, the volume fraction of fluorinated cyclic carbonates (as a fraction of all co-solvents in the electrolyte) may range from about 1 vol. % to about 20 vol. % (in some designs, from about 1 vol. % to about 4 vol. %; in other designs, from about 4 vol. % to about 6 vol. %; in other designs, from about 6 vol. % to about 12 vol. %; in yet other designs, from about 12 vol. % to about 20 vol. %). In some designs, the volume fraction of vinylene carbonate (VC) (as a fraction of all co-solvents in the electrolyte) may range from about 0.1 vol. % to about 6 vol. % (in some designs, from about 0.1 vol. % to about 0.5 vol. %; in other designs, from about 0.5 vol. % to about 1 vol. %; in other designs, from about 1 vol. % to about 2 vol. %; in yet other designs, from about 2 vol. % to about 6 vol. %). In some designs, 50 vol. % or more of the co-solvents may advantageously exhibit a melting point below about minus (−) 60° C. (in some designs, below about minus (−) 70° C.; in other designs, below about minus (−) 80° C.).

In some designs, suitable electrolyte may additionally comprise zero, one or more of the following compounds (e.g., as part of the electrolyte solvent composition or as part of the salt composition): adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy}propanenitrile, 1-(propan-2-yl)-1H-imidazole-4,5-dicarbonitrile, pyridine-2,6-dicarbonitrile, ethylene glycol bis(propionitrile) ether (EGBE), 3-(triethoxysilyl) propionitrile, succinonitrile (SN), benzonitrile, 4-(trifluoromethyl) benzonitrile, 1,2,2,3-propanetetracarbonitrile, triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, 1,3,2-dioxathiolane 2,2-dioxide (DTD), methylene methanedisulfonate (MMDS), lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), Li difluoro(oxalato)borate (LiDFOB), and lithium bis(oxalato)borate (LiBOB).

In some designs, a suitable electrolyte may comprise one or more of the following solvents (including co-solvents): ethyl propionate, ethyl isobutyrate, ethyl acetate, methyl acetate, propyl propionate, ethyl isovalerate, ethyl trimethylacetate, methyl butyrate, γ-butyrolactone, propylene carbonate, dimethyl carbonate, ethyl methyl carbonate, diethyl carbonate, methyl phenyl carbonate, diphenyl carbonate, hexamethyl acetone, pinacolone, methyl ethyl ketone, diethyl ketone, methyl isopropyl ketone, diisopropyl ketone, ethyl isopropyl ketone, heptane, hexane, octane, cyclohexane, cycloheptane, benzene, toluene, xylene, tert-butylbenzene, fluorobenzenes, fluorotoluenes, fluoroxylenes, fluoroheptanes, fluorooctanes, fluorohexanes, fluoropentanes, benzoyl fluoride, ethyl methyl sulfite, diethyl sulfite, 1,3-propylene sulfite, 1,2-propylene sulfite, sulfolane, dimethyl sulfone, ethyl methyl sulfone, ethyl isopropyl sulfone, dimethyl sulfoxide, tetrahydrothiophene 1-oxide, trimethyl phosphate, triethyl phosphate, triphenyl phosphate, 1,1,2,2-tetrafluoroethyl 2,2,3,3-tetrafluoropropyl ether, perfluorotriethylamine, N,N-dimethylformamide, hexamethylphosphoramide, N-methyl-2-pyrrolidinone, tetramethylurea, N,N′-dimethylpropyleneurea, 1,3-dimethyl-2-imidazolidinone, nitromethane, nitropropane, acetonitrile, propionitrile, butyronitrile, valeronitrile, hexanenitrile, and trimethylacetonitrile.

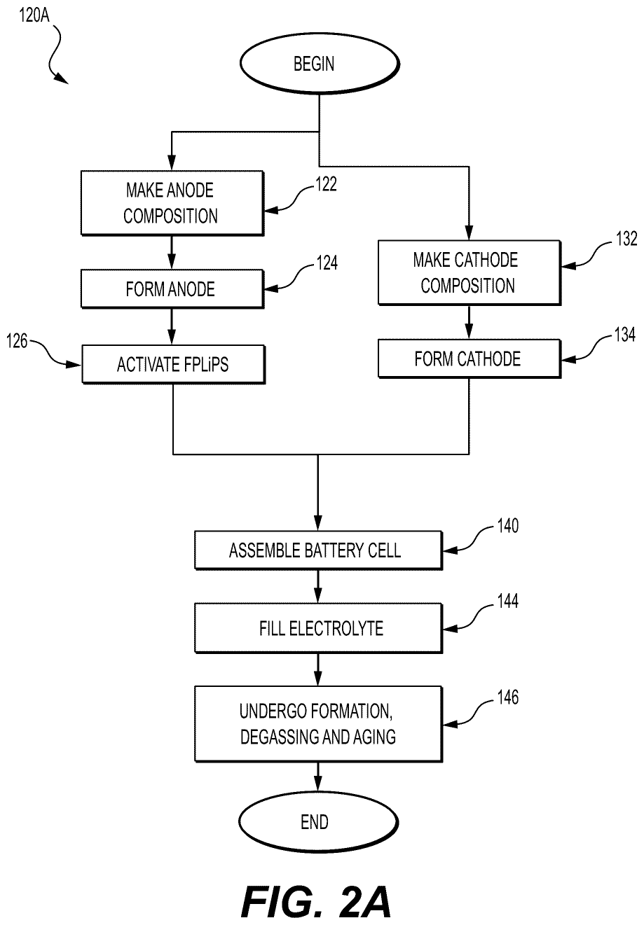

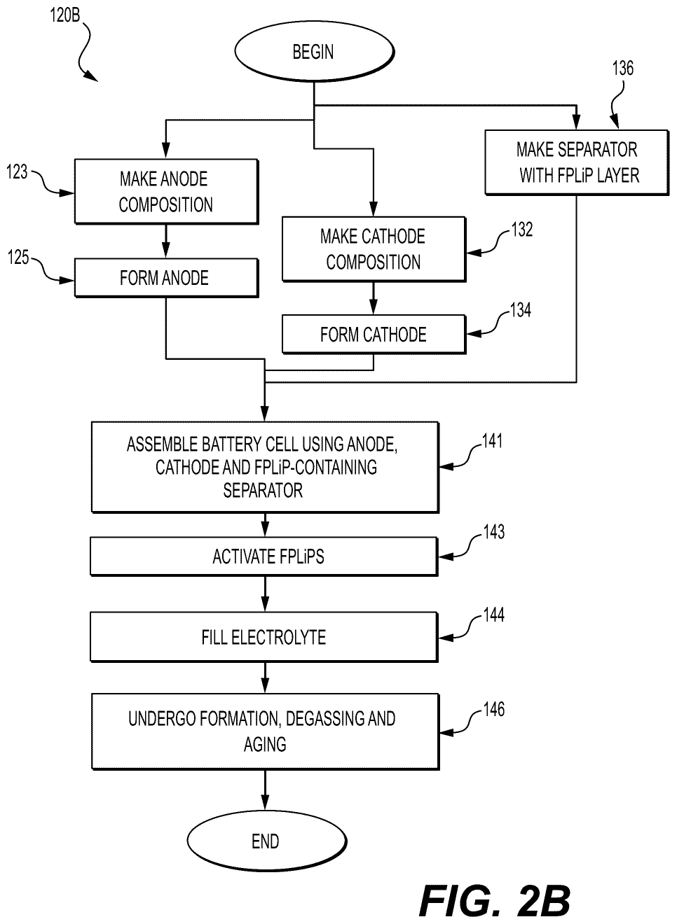

FIG. 2A shows a flow diagram of a process 120A for making a Li-ion battery, such as the example battery 100 of FIG. 1. In the example shown, process 120A includes operations 122, 124, 126, 132, 134, 140, 144, and 146. The flow diagram includes an anode branch (left branch) that includes operations 122, 124, and 126, and a cathode branch (right branch) that includes operations 132 and 134. At operation 122, anode active particles (e.g., anode particles or core-shell anode particles or composite anode particles, including, but not limited to, Si-comprising composite particles whereby Si-comprising active material is deposited within pore(s) of a particle core) are made or provided. Additionally, at operation 122, functionalized pre-lithiation particles (FPLiPs) comprising lithium (Li) are provided. At operation 124, an anode dispersion (slurry) is prepared. The anode dispersion may include the anode active particles and other components of the anode, e.g., FPLiPs, binder(s), additive(s), other components, and solvent(s). Herein, the anode active particles are sometimes referred to as primary anode active particles (“PAAPs”). In some implementations, a viscosity of the anode dispersion (slurry) may be in a range of about 1 cP to about 10,000 cP (in some designs, in a range of about 1 cP to about 1000 cP). At operation 124, an anode is formed by coating the anode dispersion on a substrate such as an anode current collector. Such an anode may comprise primary anode active particles, FPLiPs, binder(s), additive(s), and other components. The anode (including the FPLiPs) is activated at operation 126, in some designs. Similarly, at operation 132, cathode active particles (e.g., suitable intercalation-type cathode particles or core-shell cathode particles or composite cathode particles, including but not limited to, conversion-type cathode material—comprising composite particles whereby conversion-type cathode material active material is deposited within pore(s) of a particle core) are made or provided. At operation 134, a cathode slurry is prepared. The cathode slurry may include the cathode active particles and other components of the cathode, e.g., binder(s), additive(s), other components, and solvent(s) At operation 134, a cathode is formed by coating the cathode slurry on a substrate such as a cathode current collector. Such a cathode may comprise cathode active particles, binder(s), additive(s), and other components. At operation 140, a battery cell is assembled from the anode (e.g., formed on the anode current collector), the cathode (e.g., formed on the cathode current collector, and as needed, a separator between the anode and the cathode. At operation 144, a space in the battery cell, including a space between the anode and the cathode is filled with an electrolyte ionically coupling the anode and the cathode, to form a lithium-ion battery. At operation 146, the lithium-ion battery undergoes formation (formation cycling), degassing, and/or aging, to prepare the lithium-ion battery for regular charge/discharge cycling. While in this illustrative example the activation operation 126 takes place prior to cell assembling (operation 140), in other examples, the activation operation 126 may take place (1) during or after the cell assembly (operation 140), or (2) before or during electrolyte filling into the cell (operation 144) and before formation, degassing, and aging (operation 146). In yet other designs, the activation operation 126 may take place after the cell assembly (operation 140) and electrolyte filling (operation 144), but before the formation, degassing, and aging (operation 146).

FIG. 2B shows a flow diagram of a process 120B for making a Li-ion battery, such as the example battery 100 of FIG. 1. In the example shown, process 120B includes operations 123, 125, 132, 134, 136, 141, 143, 144, and 146. The flow diagram includes an anode branch (left branch) that includes operations 123 and 125, a cathode branch (middle branch) that includes operations 132 and 134, and a separator branch (right branch) that includes operation 136. At operation 123, primary anode active particles (PAAPs) (e.g., anode particles or core-shell anode particles or composite anode particles, including but not limited to Si-comprising composite particles whereby Si-comprising active material is deposited within pore(s) of a particle core) are made or provided. At operation 125, an anode dispersion (slurry) is prepared. The anode dispersion may include the primary anode active particles (PAAPs) and other components of the anode, e.g., binder(s), additive(s), other components, and solvent(s). At operation 125, an anode is formed by coating the anode dispersion on a substrate such as an anode current collector. Such an anode may comprise primary anode active particles, binder(s), additive(s), and other components. Operations 132 and 134 are as described with respect to FIG. 2A. At operation 136, a separator (e.g., separator membrane) comprising FPLiPs is formed. This operation 136 may include making or otherwise providing a pre-lithiation particle dispersion, comprising FPLiPs and a solvent composition in which the FPLiPs are dispersed. The pre-lithiation particle dispersion may additionally include binder(s), additive(s), and other components. In one example, the pre-lithiation particle dispersion may be coated on a separator (e.g., separator membrane) to form a separator comprising a pre-lithiation particle layer comprising the FPLiPs. In another example, the pre-lithiation particle dispersion may be coated to form a pre-lithiation particle layer separate from a separator (e.g., separator membrane), and the pre-lithiation particle layer may be laminated to the separator. At operation 141, a battery cell is assembled from the anode (e.g., formed on the anode current collector), the cathode (e.g., formed on the cathode current collector, and the separator comprising FPLiPs between the anode and the cathode. Operations 144 and 146 are as described with respect to FIG. 2A. The activation of the FPLiPs (operation 143) may take place before, during, or after cell assembly (operation 141). The electrolyte filling (operation 144) and the formation, degassing, and aging (operation 146) may be carried out after the FPLiPs activation (operation 143). In other designs, the FPLiPs activation (operation 143) may take place during or after electrolyte filling (operation 142).

Electrodes utilized in Li-ion batteries are typically produced by (i) formation of a slurry comprising active materials, conductive additives, binder solutions and, in some cases, surfactant or other functional additives; (ii) casting the slurry onto a metal foil (e.g., Cu or Cu-alloy foil for most anodes and Al or Al-alloy foil for most cathodes); and (iii) drying the casted electrodes to completely evaporate the solvent. Note that a metal mesh, metal foam or very rough metal foil (e.g., comprising metal nanowires or metal nanosheets on its surface) may be used in some designs (e.g., for higher areal capacity loadings or for achieving faster charge, etc.). Also note that metal coated thin polymer sheet(s) may also be used in some designs (e.g., to achieve improved safety or lower current collector weight, etc.). Also note that a porous metal foil or composite (e.g., nanocomposite) metal foils may be used in some designs (e.g., for improved properties, lower weight, etc.). In some designs, the electrodes may also be formed using a suitable dry (e.g., solvent-free) process.

Operation 124 (FIG. 2A) includes making an anode electrode, with the anode electrode including the anode particles made at operation 122. For example, this operation 124 may include (1) making an anode slurry (dispersion) that includes the anode particles (e.g., from operation 122) and other anode slurry components and (2) casting the anode slurry on an anode current collector (e.g., copper foil or copper-alloy foil current collector). For example, anode slurry components may include: dispersed FPLiPs, Si-comprising anode particles and other electrochemically-active anode active materials (e.g., natural or synthetic graphite, soft carbon or hard carbon, etc.), electrically conductive additives (e.g., carbon nanotubes or carbon black or branched carbon or carbon nanofibers or graphite flakes or exfoliated graphite or graphene or graphene oxide or soft graphite or their various combinations, to name a few), binder(s) (e.g., polymer binders), surfactant(s), other additives, and solvents (e.g., water or a suitable organic solvent if the FPLiPs are not compatible with water).

Operation 125 (FIG. 2B) includes making an anode electrode, with the anode electrode including the anode composition from operation 123. Operation 125 may be similar to operation 124 in some respects. In the example shown in FIG. 2B, the FPLiPs are provided via the separator layer (operation 136). Accordingly, in some implementations, there may be no need to include FPLiPs in the anode dispersion at operation 125. However, in some implementations, FPLiPs may be included in both the separator layer (operation 136) and in the anode layer (operation 125). A separator comprising FPLiPs may be formed by employing a pre-lithiation particle dispersion (e.g., comprising FPLiPs, binder(s), additive(s), other component(s), and solvent(s)) to form an FPLiPs-comprising coating. Alternatively, a pre-lithiation particle dispersion may be employed on the anode, e.g., coating the pre-lithiation particle dispersion on the anode to form a pre-lithiation particle layer comprising the FPLiPs on the anode. A subsequent activation process, including a heat treatment and/or a pressure treatment, may be carried out. In some implementations in which a pre-lithiation particle layer is formed on the anode, there may be no need to include FPLiPs in the anode dispersion (slurry).

Operation 134 includes making a cathode electrode, with the cathode electrode including the cathode particles made at operation 132. For example, this operation 134 may include (1) making a cathode slurry that includes the cathode particles (e.g., from operation 132) and other cathode slurry components and (2) casting the cathode slurry on a cathode current collector (e.g., aluminum foil or aluminum-alloy foil current collector). For example, other cathode slurry components may include: other electrochemically-active cathode active materials, electrically conductive additives (e.g., carbon nanotubes or carbon black or branched carbon or carbon nanofibers or graphite flakes or graphene or graphene oxide or soft graphite or their various combinations, to name a few), binders (e.g., polymer binders), surfactants, other functional additives, and solvents (e.g., water or a suitable organic solvent).

At operation 140 (FIG. 2A), the Li-ion rechargeable battery cell is assembled from at least the anode electrode and the cathode electrode with an electrolyte interposed between the anode electrode and the cathode electrode. The electrolyte provides ionic conduction between the anode and the cathode. The electrolyte ionically couples the anode and the cathode. The electrolyte may comprise a liquid electrolyte or a solid electrolyte (or a mixture of liquid and solid electrolyte) at battery operating temperatures (e.g., in some designs, the solid electrolyte may be molten or semi-molten during melt-infiltration and may subsequently solidify). In some implementations (e.g., in implementations in which a liquid electrolyte is used), a polymer or polymer-ceramic or ceramic separator may be used to maintain a space between the anode and the cathode electrodes. FIG. 2B illustrates an example in which FPLiPs are not necessarily present in the anode dispersion, hence FPLiPs are not necessarily present in the anode at the time of coating of the anode dispersion. In such cases, a separator that comprises FPLiPs may be laminated to (or otherwise attached to) the anode such that an FPLiPs-comprising layer contacts the anode layer. In some designs, an activation process may be configured such that at least some of the FPLiPs and at least some of the PAAPs contact each other (e.g., such that at least some of the Li of the FPLiPs react with at least some of the Si of the PAAPs). In some implementations, a separator composition is preferably compatible with Li metal and/or activated FPLiPs.

In another example of an implementation in which FPLiPs are not necessarily present in the anode dispersion, the FPLiPs are provided by an FPLiPs-comprising layer that is coated on the anode. A pre-lithiation particle dispersion may be coated on the anode to form a pre-lithiation particle coating on the anode. Alternatively, the FPLiPs may be provided via an FPLiPs-comprising layer that is formed separately (e.g., separate from the anode on another substrate) and then transferred to and attached to (e.g., laminated to) the anode layer. An activation process may be carried out after the FPLiPs-comprising layer contacts the anode layer (e.g., by direct coating on the anode layer, by attachment or lamination to the anode layer).

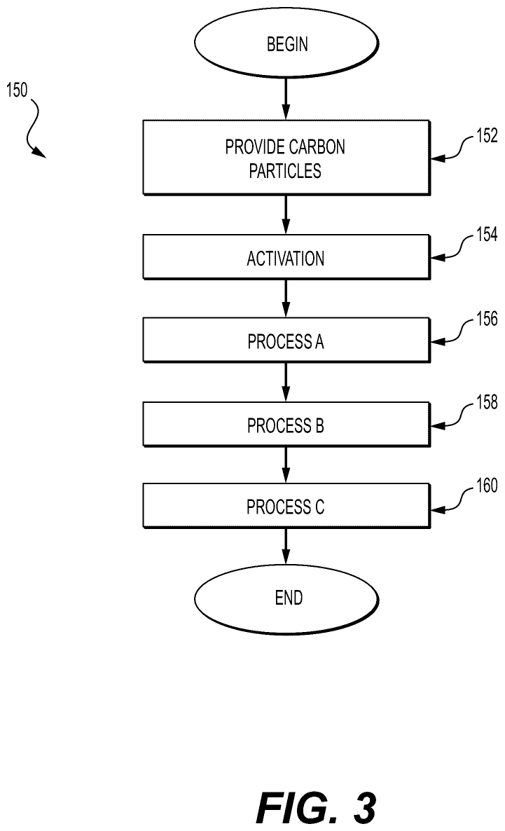

FIG. 3 is a flow diagram of a process 150 of making anode particles and illustrates an example implementation of one or more of operation 122 and/or operation 132 of FIG. 2A and/or operation 123 and/or operation 132 of FIG. 2B in greater detail. Process 150 includes operations 152, 154, 156, 158, and 160. In some designs, the processes and systems as described herein may be particularly useful when implemented as part of operation 122 (or 123) and/or operation 132. In some implementations, electrode particles are made using porous carbon or porous carbon-containing particles, with nanostructured or nano-sized active material particles (e.g., Si or Si-comprising active material particles for anode use cases) (e.g., with average diameter or linear dimensions in the range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques) being formed in the pores of the porous carbon or porous carbon-containing particles. In the case of anode particles for use in Li-ion batteries, the active material particles may be silicon-comprising particles.

At operation 152, porous carbon particles are provided. In some designs, porous carbon particles may be obtained from pyrolysis or carbonization (e.g., by heat treatment or hydrothermal treatment or their various combinations) of a suitable precursor material, such as a polymer or a biomass or biomass-derived material, followed by physical or chemical activation to enhance specific surface area and/or pore volume. In some designs, a particle size reduction operation (e.g., milling, such as jet milling, ball milling, among others) may be utilized before or after carbon activation. In some designs, carbon particles may be obtained from carbon-comprising inorganic precursor particles (e.g., carbides or oxy-carbides, etc.).

In some designs, inorganic templates (including, but not limited to various oxides or hydroxides or oxyhydroxides of various metals and semi-metals—e.g., Zn, Mg, Si, Al, Ti, Ca, Mg, Sc, etc. and their various combinations) or soft (organic) templates may be used for the formation of porous carbon particles.

In some designs, it may be preferable that the porosity of the carbon or carbon-containing particles (e.g., specific surface area and specific pore volume) be quite high before the formation of the nanostructured or nano-sized active material particles therein. In some implementations, it is preferable that the carbon or carbon-containing particles exhibit a Brunauer-Emmett-Teller (BET) specific surface area (SSA) (e.g., obtained from the data of nitrogen sorption-desorption at cryogenic temperatures, such as about 77K; in the examples described herein, the BET SSA are measured at a temperature of about 77 K) of about 500 m²/g or more, before formation of the active material particles therein. In some implementations, it is preferable that the carbon particles exhibit a BET specific surface area in a range of about 500 m²/g to about 4500 m²/g or about 4800 m²/g (in some designs, from around 500 to about 1000 m²/g; in other designs, from around 1000 to about 2000 m²/g; in other designs, from around 2000 to about 3000 m²/g; in other designs, from around 3000 to about 3800 m²/g; in yet other designs, from around 3800 to about 4500 or about 4800 m²/g), before formation of the active material particles therein. In some implementations, it is preferable that the carbon particles exhibit a total micro- and meso-pore volume (not counting macropores, above about 50 nm) in a range of about 0.5 cc/g to about 5 cc/g (in some designs, from around 0.5 to about 1 cc/g; in other designs, from around 1 to about 2 cc/g; in other designs, from around 2 to about 3.5 cc/g; in other designs, from around 3.5 to about 5 cc/g), before formation (e.g., deposition) of the active material particles therein. In some designs, such high surface areas may be obtained by carrying out physical or chemical activation of carbon or carbon-containing precursor particles, or by rapid annealing of carbon or carbon-containing precursor particles or by using temporary template materials or by other known suitable means. In some cases, the precursor particles themselves may be highly porous (e.g., aerogel particles). Nevertheless, in some designs, it may be preferable to produce or enhance porosity in carbon or carbon precursor particles (e.g., by carrying out activation on the carbon or carbon-containing particles or by leaching out non-carbon components of carbon-containing particles) before formation of the active material particles therein to tune the porosity characteristics. Accordingly, operation 154 includes carrying out a porosity enhancing (e.g., an activation) process on the carbon particles (e.g., from operation 152).

After the activation operation (operation 154), other process operations, such as process A at operation 156, process B at operation 158, and process C at operation 160, are carried out. In the example shown, there are three process operations after porosity enhancing (e.g., an activation) process (operation 154), but in other implementations there may be less than or more than three process operations after activation. For illustration, process 150 is described with respect to the formation of certain electrode (e.g., anode) particles. In some designs, the process 150 including porosity enhancing (e.g., an activation) of carbon particles may be applied to other anode particles or with cathode particles that utilize (or may benefit from) activation of carbon particles.

In the example illustrated in FIG. 3, nanostructured or nano-sized silicon (Si) or silicon alloys or silicon oxide (SiOₓ) or silicon nitride (SiN_{y}) or silicon oxy-nitride (SiOₓN_{y}) or silicon phosphide (SiP_{z}) or silicon hydride particles (0<x<2; 0<y<1.3; 0<z<1) or their various combinations, alloys and/or mixtures are formed within the pores (and/or on the surface) of porous carbon or porous carbon-containing particles. For example, process A (operation 156) includes the formation of Si-based active material particles at least in some of the pores of the porous carbon particles. The formation (e.g., by deposition or infiltration or deposition/infiltration of a Si-comprising precursor with the subsequent conversion to the final Si or Si-based material) of silicon-based active material particles in the porous carbon particles may be accomplished by solution-based or vapor-based deposition processes, in some examples, or by other suitable means. For brevity, the particles upon completion of process A are sometimes referred to as silicon-carbon (Si—C) composite particles (with an understanding that elements other than Si and C may be present within such composite particles in some designs). In some embodiments, such composite particles comprise nano-sized or nanostructured elements (e.g., nano-sized or nanostructured Si, nano-sized or nanostructured C) and may be referred to as nanocomposite particles. In some implementations, the Si or Si-comprising material present in such nanocomposites may be in the form of nanoparticles. In some implementations, the mass-average size of Si or Si-comprising material nanoparticles may range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques.

In the example shown, process B is carried out at operation 158. For example, process B includes the formation of a protective coating on and in the silicon-carbon composite particles (from operation 156). In some designs, the suitable average thickness of the protective coating may range from about 0.2 nm to about 50 nm (in some designs, from about 0.2 nm to about 2 nm; in other designs, from about 2 nm to about 5 nm; in other designs, from about 5 nm to about 10 nm; in yet other designs, from about 10 nm to about 50 nm). In some designs, the true density of the protective coating may range from about 0.8 g/cc to about 4.8 g/cc or about 5.8 g/cc (in some designs, from about 0.8 g/cc to about 1.6 g/cc; in other designs, from about 1.6 g/cc to about 3 g/cc; in other designs, from about 3 g/cc to about 4.5 g/cc; in yet other designs, from about 4.5 g/cc to about 4.8 g/cc or about 5.8 g/cc).

In some designs, the protective coating (e.g., at operation 158) may comprise or be based on electronically conductive material such as carbon. In some designs, such a carbon coating may be doped (e.g., with B, P, N, O, S and/or other elements). In some designs, the atomic fraction of individual dopants may range from about 0.01 at. % to about 10.01 at. % (in some designs, from about 0.01 at. % to about 0.1 at. %; in other designs, from about 0.1 at. % to about 1 at. %; in other designs, from about 1 at. % to about 5 at. %; in yet other designs, from about 5 at. % to about 10.01 at. %). In some designs, the protective coating may be largely impermeable to electrolyte solvent.

During operation of a Li-ion battery cell (e.g., 100 in FIG. 1), the protective coating (e.g., on the silicon-carbon composite particles, from operation 158) may reduce or prevent direct contact between the silicon nanoparticles and an electrolyte solvent composition. In some designs, direct contact between the electrolyte solvent composition and the silicon nanoparticles may undesirably accelerate degradation of the Li-ion battery cell.

In the example shown, process C is carried out at operation 160. For example, process C includes making changes to the particle size distribution (PSD). Process C may include carrying out comminution on the protected Si—C composite particles (from operation 158). Comminution may be carried out when the particle sizes are larger (on average) than a final desired (e.g., for a slurry and electrode processing) particle size distribution. Various processes of carrying out comminution are known in the art. For example, the comminution may be carried out by one or more of: ball milling, jet milling, attrition milling, pin milling, and hammer milling. In some implementations, it may be preferable to carry out particle size selection (e.g., retaining of particles of a desired size range and removal of particles of an undesired size range) during process operation C. In some cases, process C may include particle size selection (e.g., retaining of particles of a desired size range and removal of particles of an undesired size range) in addition to comminution (e.g., particle size selection after comminution). In some cases, process C may include particle size selection (e.g., retaining of particles of a desired size range and removal of particles of an undesired size range) without comminution. For example, it may be preferable to retain some or all of the larger particle sizes and discard some or all of the finer particle sizes. The particle size selection (e.g., retaining of particles of a desired size range and removal of particles of an undesired size range) may be carried out by any one of suitable processes known to those skilled in the art, such as screening, sieving, and aerodynamic size classification.

The foregoing process operation C (160) includes examples, such as comminution and particle size selection (e.g., retaining of particles of a desired size range and removal of particles of an undesired size range) to change (or tune) a particle size distribution (PSD) of a population of particles. In some cases, it may be preferable to employ additional or alternative processes for changing or adjusting (or tuning) a PSD, such as mixing two or more populations of particles wherein each of the populations has a PSD different from others of the populations. For example, particle populations of different PSDs may be obtained (e.g., obtained from a third party or made to different PSDs including employing the aforementioned processes of comminution and/or particle size selection (e.g., retaining of particles of a desired size range and removal of particles of an undesired size range) under different processing conditions).

The particle size distribution (PSD) that characterizes a particle population may be determined by laser particle size distribution analysis (LPSA), image analysis of electron microscopy images, or other suitable techniques. The particle size distribution (PSD) may be determined by laser particle size distribution analysis (LPSA) on well-dispersed particle suspensions in one example. Note that other types of particle size distribution (e.g., by SEM image analysis) could also be utilized (and may even lead to more precise measurements, in some experiments). While there are diverse processes of measuring PSDs, laser particle size distribution analysis (LPSA) is quite efficient for some applications. Using LPSA, particle size parameters of a population's PSD may be measured, such as: a tenth-percentile volume-weighted particle size parameter (e.g., abbreviated as D₁₀), a fiftieth-percentile volume-weighted particle size parameter (e.g., abbreviated as D₅₀), a ninetieth-percentile volume-weighted particle size parameter (e.g., abbreviated as D₉₀), and a ninety-ninth-percentile volume-weighted particle size parameter (e.g., abbreviated as D₉₉). Additionally, parameters relating to characteristic widths of the PSD may be derived from these particle size parameters, such as D₅₀-D₁₀ (sometimes referred to herein as a left width), D₉₀-D₅₀ (sometimes referred to herein as a right width), and D₉₀-D₁₀ (sometimes referred to herein as a full width). A cumulative volume fraction, defined as a cumulative volume of the composite particles with particle sizes of a threshold particle size or less, divided by a total volume of all of the composite particles, may be estimated by LPSA. In some embodiments, a fiftieth-percentile volume-weighted particle size parameter (D₅₀) of the PSD is in a range of about 2.0 μm to about 16.0 μm, e.g., in a range of about 2.0 to about 4.0 μm, or in a range of about 4.0 to about 6.0 μm, or in a range of about 6.0 to about 8.0 μm or in a range of about 8.0 to about 16.0 μm.

Upon completion of the operations in the process 150 (e.g., operations 152, 154, 156, 158, 160), the composite particles may be characterized by a Brunauer-Emmett-Teller (BET) specific surface area (SSA) (e.g., obtained from the data of nitrogen sorption-desorption at cryogenic temperatures, such as about 77K). In some embodiments, the BET-SSA of the composite particles is in a range of about 1 m²/g to about 50 m²/g (in some designs, from about 1 to about 3 m²/g; in other designs, from about 3 m²/g to about 12 m²/g; in yet other designs, from about 12 m²/g to about 18 m²/g; in yet other designs, from about 18 m²/g to about 30 m²/g; in yet other designs, from about 30 m²/g to about 50 m²/g).

In some designs, silicon-based anode materials (including silicon-carbon composite particles) may be partially pre-lithiated using chemical lithiation reagents, including lithium biphenyl and its derivatives, lithium naphthalene and its derivatives, alkyl and aryl lithium reagents and their derivatives, molten or gaseous lithium metal, and ammonia lithium solutions, including lithium solutions made in mono-, di-, and/or tri-substituted amines. Suitable chemical lithiation agents may include lithium 2-methylnaphthalen-1-ide, lithium anthracene, lithium phenanthrene, lithium 4,4′-di-tert-butylbiphenylide (LiDBB), lithium 2,2,6,6-tetramethylpiperidide (LiTMP), lithium bis(trimethylsilyl)amide (LiTMP), lithium 4,4′-bis(diethylamino)-2,2′-biphenylyl (LiDEAB), lithium 2,2′-dimethylbiphenyl (LiDMBP), lithium 2-tert-butyl-4,6-dimethylphenyl (LiTBDMPP), lithium 2,2′-diphenyl-4,4′-dimethyl-1,1′-biphenyl (LiDPDMBP), lithium 2,2′-diphenyl-4,4′-bis(trimethylsilyl)phenyl (LiDBTMSB), lithium 2-tert-butyl-4,6-dimethylphenyl-2′-(trimethylsilyl)biphenyl (LiTBDMPP-TMSB), lithium 2,2′-diphenyl-4,4′-dimethyl-1,1′-biphenyl-4′-yl (LiDPDMBP-4), lithium 2,2′-diphenyl-4,4′-dimethyl-1,1′-biphenyl-3,3′-diyl (LiDPDMBP-3,3′), lithium 2,2′-diphenyl-4,4′-dimethyl-1,1′-biphenyl-3-yl (LiDPDMBP-3), lithium 2-((tert-butoxycarbonyl)amino)-4,6-dimethylphenyl (LiBoc-DMPP), lithium 2-((tert-butyl)dimethylsilyl)phenyl (LiTBDMS-Ph), lithium 2-(4-tert-butylphenyl)-4,6-dimethylphenyl (LiTBPP-DMPP), lithium 1,8-diazabicyclo[5.4.0]undec-7-ene (LiDBU), lithium 1,2,3,4-tetrahydro-1-naphthalenyl (LiTHN), lithium 2,6-dimethyl-4-(trimethylsilyl)naphthalenide (LiDMTSN), lithium 1-(1-naphthyl)pyrrolidine (LiNPYR), lithium 1,4-dibenzyl-1,4-diazabicyclo[2.2.2]octane (LiDBBO), lithium 1,3-dimethyl-1,3-dihydro-2H-benzimidazole (LiDMBI), lithium 1-(2-pyridyl)piperidine (LiPyP), lithium 4,4′-di-tert-butyl-2,2′-bipyridine (LiDTBBP), lithium 1,2-diphenyl-1,2-ethanediamine (LiDPEA), lithium 2,2′-bipyridine (LiBPY), phenyllithium, p-toluenelithium, 4-bromophenyllithium, 4-trifluoromethylphenyllithium, 2-naphthyllithium, methyllithium, n-butyllithium, isopropyllithium, and t-butyllithium.

In some designs, these pre-lithiation reactions may be carried out in cyclic or linear ethereal solvents, saturated hydrocarbon solvents, and/or aromatic solvents. For example, tetrahydrofuran (THF) and diethyl ether (DME) may be utilized due to their ability to solubilize lithium reagents to form stable complexes with lithium ions. Other ether solvents that may be used include dimethoxyethane (DME), diethylene glycol dimethyl ether (DGM), 2-methyl tetrahydrofuran (2-MeTHF), ethylene glycol dimethyl ether (EGDME), ethylene glycol diethyl ether (EGDE), 1,3-dioxolane (DIOX), 1,2-dimethoxyethane (DME), ethylene glycol dibutyl ether (EGBE), 2-methyl-1,3-dioxolane (2MeDOX), propylene glycol dimethyl ether (PGDME), tetraglyme, diglyme, 1,2-dimethoxypropane (DMP), propylene glycol diethyl ether (PGDE), and/or ethylene glycol dimethyl ether acetate (EDMEA). Illustrative examples of saturated hydrocarbon solvents include, but are not limited to, hexane and heptane, which may also be used for lithiation reactions, and may be preferred when working with alkyl lithium reagents. Other examples include cyclohexane, decane, octane, pentane, nonane, dodecane, mineral oil, isooctane, isopentane, and methylcyclohexane. In some designs, aromatic solvents, including toluene and xylene, may be used for pre-lithiation reactions (e.g., in some designs, aromatic solvents may be preferred when working with bulky or sterically hindered lithium reagents). Additional examples include benzene, ethylbenzene, chlorobenzene, 1,2-dichlorobenzene, 1,3-dichlorobenzene, anisole, cumene, styrene, phenol, tetrahydronaphthalene, and biphenyl. In some designs, the choice (or pairing) of chemical lithiation reagent(s) and solvent(s) is non-trivial and may facilitate a high degree of control over the reaction conditions and lithiation of silicon-comprising anode materials.

In some designs, these chemical lithiation reagents may preferably be used to introduce lithium (and electrons) into the silicon-based or silicon-comprising anode material at loadings ranging between about 0.1 and about 10% of the theoretical capacity of silicon (theoretical capacity of silicon is approximately 3600 mAh/g), that is between about 3.6 mAh/g to about 360 mAh/g (in some designs, from about 3.6 to about 10 mAh/g; in other designs, from about 10 to about 20 mAh/g; in other designs, from about 20 to about 30 mAh/g; in other designs, from about 30 to about 40 mAh/g; in other designs, from about 40 to about 50 mAh/g; in other designs, from about 50 to about 70 mAh/g; in other designs, from about 70 to about 90 mAh/g; in other designs, from about 90 to about 110 mAh/g; in other designs, from about 110 to about 140 mAh/g; in other designs, from about 140 to about 160 mAh/g; in other designs, from about 160 to about 200 mAh/g; in other designs, from about 200 to about 240 mAh/g; in other designs, from about 240 to about 280 mAh/g; in other designs, from about 280 to about 360 mAh/g). The degree of lithiation may be chosen to balance, for example, the desired increase in lithium-ion storage capacity or the desired reduction in first cycle losses or the desired reduction in the formation losses with the potential negative effects of excess lithium on the chemical stability of the pre-lithiated Si-comprising particles (e.g., Si—C composite (e.g., composite particles) or nanocomposites (e.g., nanocomposite particles), among many others). At low levels of lithiation (e.g., up to about 10% of theoretical capacity of silicon), Si-comprising anode materials may be handled more easily processed in environments containing oxygen, water, and/or other oxidizing species without the occurrence of significant delithiation. This contrasts with highly lithiated silicon-based anode materials (lithiation greater than about 10% theoretical capacity of Si) which are susceptible to oxidation and reaction with water and air. Careful control over the pre-lithiation process, including the choice of chemical lithiation reagent and solvent, is therefore critical to achieving suitable high-performance Si-comprising anode materials for use in Li-ion batteries.

In some designs, the pre-lithiation by chemical lithiation reagents may take place (i) prior to making anode slurry or coatings, (ii) during the slurry coating process, or (iii) after the Si-comprising anode material has been coated onto the current collector. In some embodiments, the pre-lithiation may be conducted prior to the slurry coating process, wherein the slurry preparation process includes mixing a chemical lithiation agent with a Si-comprising anode material, to achieve the desired lithiation level. In other embodiments, the pre-lithiation may be carried out during the slurry coating process, wherein the chemical lithiation reagent is added to the slurry mixture to lithiate the Si-comprising anode material as the slurry is coated onto the current collector. In yet other embodiments, the lithiation may be carried out after the anode (comprising Si-comprising anode material) has been coated onto the current collector, where the chemical lithiation reagent may be applied to the anode coating to achieve the desired lithiation level.

Some implementations of Li-ion batteries may benefit from the use of certain separators or separator components in battery cell fabrication using dry electrode processing. In some designs, for example, the separator or the separator layer may comprise an initiator component to induce polymerization of polymerizable monomers and/or oligomers in a later stage of a dry electrode fabrication process (for example, (1) the separator or separator layer is attached to (e.g., laminated to) the electrode, thereby bringing the initiator component into contact with the polymerizable monomers and/or oligomers present in the electrode, and (2) upon polymerization (e.g., heat-treatment, contact heating), the polymerizable monomers and/or oligomers are converted to a binder polymer in the processed electrode). In some designs, the presence of the separator or the separator layer between a roller and the electrode may help to reduce or minimize adhesion between the rollers and the solvent-free (dry) electrode during densification (compaction) and/or contact heating.

In some designs, it may be advantageous for a separator layer to be directly deposited onto the surface of the electrode. In some designs, the stack of the dry electrode and the separator may be further jointly densified (compacted) and heated.

In some designs, it may be advantageous for the separator or a separator layer to comprise nanoparticles or, in some designs, nanofibers, nanotubes or nanowires (e.g., polymer or ceramic nanofibers or nanowires). Such one-dimensional (1D) materials (nanowires, nanofibers, nanotubes, etc.) may enhance mechanical properties and may facilitate fast electrolyte diffusion into the electrode. Because dry-processed electrodes may exhibit lower tortuosity than regularly slurry-cast electrodes, the high ionic conductivity of the separator layer (e.g., using 1D materials) becomes particularly important, in some designs. In some designs, it may be advantageous for these nanofibers and nanowires to be porous. In some designs, the pores in such fibers may be impregnated with functional additives (e.g., initiators, etc.).

Illustrative examples of suitable nanoparticle, nanofiber, nanotube or nanowire compositions may include: (i) metal oxides including mixed metal oxides (e.g., aluminum oxide (e.g., Al₂O₃) or magnesium oxide (e.g., MgO) or mixed aluminum-magnesium oxide or mixed aluminum-lithium oxide or mixed aluminum-lithium-sodium oxide or mixed aluminum-magnesium-lithium-sodium oxide or other (e.g., silicon-comprising) oxides, etc.); (ii) metal hydroxide and oxyhydroxides (e.g., Mg(OH)₂, Al(OH)₃, AlOOH, Mg₂O(OH)₂, etc.) which may comprise Li, Na, and other metals; (iii) metal oxy-fluorides and mixed metal oxy-fluorides (including those comprising Al, Mg, Si, Li, Na, etc.); (iv) ultra-high and high strength polymers (e.g., aramid polymer, polyarylate, polybenzoxazole, high and ultra-high molecular weight polyethylene, polyester, polyimide, etc.); (v) natural polymers (e.g., cellulose, chitin, etc.), to name a few.

In some designs, the suitable diameter of nanowires and nanofibers may range from about 5 nm to about 500 nm (in some designs, from about 5 nm to about 25 nm; in other designs, from about 25 nm to about 100 nm; in other designs, from about 100 nm to about 250 nm; in yet other designs, from about 250 nm to about 500 nm). In some designs, the diameter-to-length aspect ratios of these nanowires or nanofibers may be in a range from about 1:20 to about 1:100,000.

Due to factors such as large volume changes, high specific surface area, the presence of electronegative elements (such as oxygen or nitrogen), the presence of hydrogen, and slow diffusion within portions of the anode, certain high-capacity anodes may experience a significant amount of Li loss (in some cases, up to about 8-30% for some silicon-based anodes in comparison to just about 3-7% in some common graphite-based anodes) during the initial stage (e.g., formation cycling). This considerable loss of lithium may lead to lower energy densities in batteries containing silicon-based anodes.

In order to enhance the cell's capacity, lithium supplements may be utilized to increase the amount of electrochemically active lithium in the battery, which is defined herein as lithium that can be transported to the respective electrodes within the battery via externally applied electrical current. By increasing the lithium inventory, the cell's energy density may be effectively increased.

Lithium metal has attractive properties for use in pre-lithiation additives. One attractive property of lithium metal is its high specific capacity of 3860 mAh/g. Another attractive property is that if all of the lithium ions are used in the pre-lithiation process, no residue remains after the pre-lithiation. Yet another attractive property is the ease with which the amount of lithium added may be controlled, either to pre-lithiate to compensate for initial capacity loss or to fully pre-lithiate to match a non-lithiated cathode, such as metal fluorides (e.g., FeF₃). This approach requires a complicated setup due to the low potential of the lithium insertion reaction into silicon-comprising or carbon-comprising anodes (the potential being measured in an electrochemical cell with lithium metal as a reference electrode). Due to its higher chemical reactivity, lithium metal as a pre-lithiation additive is difficult to use in practical operations. Hence, improved processes are desired to obtain the benefits of added lithium inventory.

In some designs, it may be advantageous to form an outer protective coating around metal particles (e.g., Li metal particles). In some designs, a functionalized pre-lithiation particle may comprise a core (comprising Li) and an outer protective coating around the core. In some implementations, the outer protective coating may function to seal the core from the outside, until the outer protective coating is broken, e.g., by a mechanical process or a chemical process. In some implementations, the outer protective coating may be a polymeric coating or may comprise one or more polymers. In some designs, a suitable thickness of such coatings may range from about 1 nm to about 50 nm (e.g., from about 1 nm to about 5 nm; or from about 5 nm to about 10 nm; or from about 10 nm to about 25 nm; or from about 25 nm to about 50 nm). Suitable polymers for forming the outer protective coating may include but are not limited to: polyethylene (PE), polypropylene (PP), polyethylene oxide (PEO), styrene-butadiene rubber (SBR), polyisobutylene (PIB) and polystyrene (PS). In some designs, these polymers may adhere to the surface of lithium particles via Van der Waals interactions or other interactions. In some designs, when used in an outer protective coating around metal particles (e.g., Li metal particles), these polymers may function as a dispersing agent (dispersant). For example, since the density of Li metal is about 0.53 g/cm³, the density of FPLiPs may be increased to above the density of Li by incorporating certain non-Li materials in the core and/or in the outer protective layer. In some implementations, the density of the FPLiPs may be chosen to be close to the density of the solvent composition in which the FPLiPs are dispersed (e.g., within about 25% or within about 10% or within about 5% or within about 2% or within about 1%) to reduce or prevent or reduce settling of the FPLiPs in the dispersion. In some designs, the density of the FPLiPs may be adjusted (or tuned) to be within a desired or predetermined range of the density of the solvent by incorporating certain polymers (or oligomers) into an outer coating layer of the FPLiPs. In some designs, the presence of the outer coating layer incorporating a dispersant (e.g., some polymers and/or oligomers) may also prevent or reduce the aggregation of the metal particles in a dispersion. Accordingly, in some designs, if greater amounts of FPLiPs are added to a solvent without settling or aggregation, dispersions exhibiting higher viscosities may be obtained.

In some designs, the protected lithium particles (FPLiPs) may desirably have an average (D₅₀) particle size of no greater than about 50 microns (in some designs, from about 50 nm to about 200 nm; in other designs, from about 200 nm to about 500 nm; in other designs, from about 500 nm to about 2 microns; in other designs, from about 2 microns to about 5 microns; in other designs, from about 5 microns to about 10 microns; in other designs, from about 10 microns to about 25 microns; in yet other designs, from about 25 microns to about 50 microns). In some instances, the lithium metal powder has an average (D₅₀) particle size of no more than about 1 microns. Smaller particle sizes may be advantageous for uniform introduction of small amounts of Li, but may exhibit higher surface area (e.g., resulting in higher reactivity and a larger weight or volume fraction of the coating layer) and may be more difficult to handle (e.g., such a powder may undesirably behave as an inflammable dust, in some implementations). As such, Dso particle sizes smaller than about 50 nm may be less attractive in some designs. Too large particles, on the other hand, could make it hard to distribute Li uniformly within the anode, particularly if relatively small Li capacity needs to be added (e.g., about 3-10%). As such, D₅₀ particle sizes larger than about 25 to about 50 microns may be less attractive. In some designs, if the FPLiPs are deposited from an FPLiP-comprising slurry (ink) on top of an anode coating as a thin ink coating layer, average (D₅₀) and approximate maximum (e.g., D₉₀ or D₉₉) FPLiP sizes may be limiting factors in minimizing the average ink layer thickness (and hence added Li capacity). In some designs, the polymer-protected lithium powder (FPLiPs) may desirably have D₉₀ particle sizes of no greater than about 75 microns (in some designs, less than 50 microns; in other designs, less than 25 microns; in yet other designs, less than 10 microns). For example, D₉₀ may range from about 0.5 to about 2 microns; or from about 2 to about 10 microns; or from about 10 to about 25 microns; or from about 25 to about 50 microns or from about 50 to about 75 microns. In some designs, the polymer-protected lithium powder (FPLiPs) may desirably have D₉₉ particle sizes of no greater than about 100 microns (in some designs, less than about 75 microns; in other designs, less than about 50 microns; in other designs, less than about 25 microns; in yet other designs, less than about 10 microns). For example, D₉₉ may range from about 2 to about 10 microns; or from about 10 to about 25 microns; or from about 25 to about 50 microns or from about 50 to about 75 microns or from about 75 to about 100 microns. In some designs, the polymer-protected lithium powder (FPLiPs) may desirably have D₁₀ particle sizes of no less than about 10 nm. For example, D₁₀ may range from about 10 nm to about 50 nm; or from 50 nm to about 200 nm; or from 200 nm to about 500 nm; or from 500 nm to about 2 microns; or from about 2 microns to about 5 microns; or from about 5 microns to about 10 microns. In some designs, the polymer-protected lithium powder (FPLiPs) may desirably have D₁ particle sizes of no less than about 1 nm. For example, D₁ may range from about 1 nm to about 10 nm; or from about 10 nm to about 50 nm; or from about 50 nm to about 200 nm; or from about 200 nm to about 500 nm; or from about 500 nm to about 2 microns; or from about 2 microns to about 5 microns; or from about 5 microns to about 10 microns.

In some designs, the functionalized pre-lithiation particle (FPLiP) core may comprise non-Li components to tune the mechanical, physical, and/or chemical properties of the FPLiPs, such as density, elastic modulus, hardness, shape, volume changes during Li extraction, reactivity, among others. In one example, the density and elastic modulus of FPLiPs (or another type of protected lithium metal powder) may be increased by adding carbon (e.g., carbon black, graphite particles, graphene, graphene oxide, disordered carbon, soft carbon, hard carbon, carbon nanofibers, dendritic carbons, porous carbon including templated or activated carbon (e.g., microporous, mesoporous, and/or macroporous with various fractions of respective pore sizes), carbon nanotubes, etc.) or Li-alloying element(s) (such as Si, Al, Sn, Sb, P, Mg, Zn, etc., and their various combinations) or their oxides or various carbides or nitrides or hydrides of various metals (such as titanium, aluminum, iron, silicon, etc.) in the form of particles or nanoparticles in various shapes (1-dimensional (1D), 2-dimensional (2D), 3-dimensional (3D), etc.) and sizes. The density of Li metal is about 0.53 g/cm³. The density of FPLiPs may be increased to above the density of Li by incorporating certain non-Li materials. Increasing the density of FPLiPs, such that the density of the FPLiPs is close to the density of the slurry (e.g., within about 25% or within about 10% or within about 5% or within about 2% or within about 1%) may improve FPLiP slurry stability, in some designs. In some designs, it may be advantageous to attain good wetting of liquid Li onto the surface of such non-Li components (e.g., attain a wetting angle of liquid Li on the flat surface of such materials (or similar materials) in a range from about 0 to about 90 degrees (such as about 0-10 degrees or about 10-30 degrees or about 30-60 degrees or about 60 to about 90 degrees)). Note that using no or smaller amounts of electronegative elements (such as N or O) that may trap Li in such non-Li compositions may be advantageous in some designs as these may effectively reduce available Li capacity.

In some designs, forming an outer protective layer on the lithium particles (e.g., sealing the lithium particles) may significantly mitigate the safety risks associated with Li metal usage by isolating Li from moisture and oxygen in the air. There are various processes that may be employed to integrate the FPLiPs into an anode, such as: (i) mixing FPLiPs into the active anode powder (the powder comprising PAAPs) that is used to form the anode, (ii) including FPLiPs into a polymer layer applied to the active material particles, (iii) mixing FPLiPs with the wet or dry slurry mixture (dispersion) along with primary anode active particles (PAAPs), conductive and other additive(s) (including dispersants), and binder(s) to form the anode electrode, (iv) depositing (coating) FPLiPs (using a dispersion with or without binder(s)) onto the anode electrode, (v) depositing (coating) FPLiPs (using a dispersion with or without binder(s)) onto a separator, the surface of the separator with the FPLiPs thereon being brought into contact with the anode during subsequent processing (e.g., cell or component assembly), (vi) depositing (coating) FPLiPs (using a dispersion with or without binder(s), conductive additive(s), and other additive(s)) onto an anode current collector, and in some designs, subsequently depositing or otherwise attaching an anode layer onto the FPLiP-comprising layer, such that the FPLiP-comprising layer is disposed between the anode current collector and the anode active material layer, and (vii) a combination of any two or three or more of the foregoing processes (i) to (vi). In any of these designs, the FPLiPs may undergo chemical or electrochemical reactions with the anode material in a battery cell to create a material, such as a Si—C nanocomposite (particles), that contains lithiated silicon.

In some designs, a Li ink (dispersion) composition may be used in the printing, coating, or depositing (e.g., onto an electrode, onto a separator, or onto a current collector, etc.) of the FPLiPs (or other Li supplements). In some designs, FPLiPs used in the ink (dispersion) may preferably be fine powders with an average particle size (D₅₀) of no more than about 50 microns (in some designs, about 50 nm to about 200 nm; in other designs, about 200 nm to about 500 nm; in other designs, about 500 nm to 2 about microns; in other designs, about 2 microns to about 5 microns; in other designs, about 5 microns to about 10 microns; in other designs, about 10 microns to about 20 microns; in other designs, about 20 microns to about 30 microns; in other designs, about 30 microns to about 50 microns). In some cases, the average (D₅₀) particle size of the FPLiPs is no more than about 10 microns or about 5 microns. In some designs, the FPLiP inks (dispersions) described here may also be formulated with submicron-sized powers. In some designs, a submicron-sized FPLiP population has an average (D₅₀) particle size of no more than about 1 micron, which includes particles with an average particle size of no more than, for example, about 500 nanometers, about 200 nanometers, and about 50 nanometers. In some designs, using submicron-sized FPLiPs may be advantageous in some designs as smaller particles may facilitate more precise and uniform deposition on the surface when relatively small areal capacity loadings of FPLiP are desired. Note that FPLiPs may also be mixed with other compositions to form various alloys, composites, and/or physical mixtures.

In some designs, the FPLiP ink (dispersion) properties, such as wettability and viscosity, may be carefully controlled through the ink (dispersion) formulation process. In some designs, the FPLiP ink (dispersion) may include dispersants (e.g., oligomeric and/or polymeric dispersants), solvent, and other additives. Additionally, in some designs, the particle size, the particle shape, and the lithium composition (e.g., weight fraction) of the FPLiPs may be specifically tailored to the requirements of the printing (deposition) process and the resulting properties of the anode electrode or the separator. In some designs, the relative amounts of FPLiPs, polymeric or oligomeric dispersion agent (dispersant), solvent, and other additives in the ink (dispersion) formulation may be tuned to satisfy requirements of the specific printing (deposition) technique, deposition tool specifics and desired deposition conditions. The viscosity of the ink (dispersion) formulation, for example, may be adjusted by varying the amount and type of polymeric or oligomeric dispersant and solvent, while the lithium concentration may be adjusted, for example, by changing the weight fraction of the FPLiPs in the dispersion. In some designs, on a dry weight basis (i.e., excluding the solvent(s) in the dispersion), a weight fraction of the FPLiPs may preferably be in a range from about 50 wt. % to about 99.9 wt. % of the ink (dispersion) (e.g., from about wt. 50% to about 60 wt. % or about 60 wt. % to about 70 wt. % or about 70 wt. % to about 80 wt. % or about 80 wt. % to about 90 wt. % or about 90 wt. % to about 99.9 wt. %). In some designs, on a dry weight basis, a weight fraction of a polymer binder and/or a dispersing agent (e.g., oligomeric and/or polymeric dispersant) in the dispersion may preferably be in a range from about 0.1 wt. % to about 20 wt. % of the ink (dispersion) (e.g., from about 0.1 wt. % to about 2 wt. % or from about 2 wt. % to about 4 wt. % or from about 4 wt. % to about 8 wt. % or from about 8 wt. % to about 12 wt. % or from about 12 wt. % to about 16 wt. % or from about 16 wt. % to about 20 wt. %). In some designs, on a dry weight basis, a weight fraction of conductive and/or other additives may preferably be in a range from about 0 wt. % to about 30 wt. % of the ink (dispersion) (e.g., from about 0.1 wt. % to about 2 wt. % or from about 2 wt. % to about 4 wt. % or from about 4 wt. to about 8 wt. % or from about 8 wt. % to about 12 wt. % or from about 12 wt. % to about 16 wt. % or from about 16 wt. % to about 20 wt. % or from about 20 wt. % to about 30 wt. %).

In some embodiments, for example, an aerosol-jet printed ink layer may contain from about 50 wt. % to about 90 wt. % FPLiPs (or other suitable Li metal or Li metal composite or Li metal alloy powder composition) and from about 1 wt. % to about 10 wt. % polymeric dispersant(s) on a dry weight basis. In other embodiments, the FPLiP ink (dispersion) may contain from about 60 to about 99 wt. % FPLiPs and less than about 1 wt. % of polymeric dispersant. In other embodiments, the composition ranges may be adjusted based on the specific application and printing technique used. This level of control over the ink formulation may lead to greater precision and control in the manufacturing of lithium batteries, which may result in improved battery performance and durability.

In some designs, it may be advantageous for the FPLiP-comprising ink to exhibit specific properties. In some implementations, it may be advantageous for the FPLiP ink to exhibit viscosity values in a range from about 1 to about 1000 centipoise (cP) as measured using a Brookfield viscometer. In this range, it may also be advantageous for the ink to exhibit viscosities of about 2 cP or greater. In this range, it may also be advantageous for the ink to exhibit viscosities of about 100 cP or less, or about 20 cP or less. In some designs, the ink viscosity may depend on several factors, including the FPLiP particle size and concentration, the solvent used in the ink and the printing conditions. Furthermore, in some designs, a preferred surface tension of the ink may be low enough to wet and adhere to the substrate without beading up or forming satellite droplets, but high enough to prevent excessive spreading or bleeding of the ink on the substrate. In general, a preferred surface tension of FPLiP-comprising ink (for Aerojet printing) may range from about 20 to about 70 mN/m as measured using a surface tensiometer, as measured at room temperature (e.g., about 20-25° C.). For surface tension measurements of liquids of up to about 100 mN/m, a bubble pressure tensiometer may be a highly effective instrument. For implementations of FPLiP dispersions (e.g., inks) in which the surface tension is in a range of about 20 mN/m to about 70 mN/m, a bubble pressure tensiometer may be employed. It is important to note that the surface tension of the ink may be adjusted by adding surfactants or other additives to the ink composition. In some cases, the ink may be tuned by adjusting the solvent composition to achieve the ideal surface tension. Furthermore, it may be advantageous for the ink to dry in a controlled manner. If the ink dries too quickly, it may not adhere properly to the substrate, but if the ink dries too slowly, it may smear during the printing process.

In some designs, it may be advantageous for the FPLiP-comprising ink to exhibit high chemical stability. In some designs, the ink components may preferably be resistant to chemical reactions or degradation that may occur over time, which may affect the performance and quality of the printed FPLiP-comprising layer. In some designs, to ensure a stable and well-dispersed FPLiP suspension, it is important to select ink compositions that are chemically compatible with each other. In some designs, it is also important to choose ink compositions that are chemically compatible with Si-comprising active anode material particles (such as Si—C composite or nanocomposite, among others). In some designs, to measure the ink stability, the resulting ink may be analyzed using several common methods, including, but not limited to: 1) rheological analysis to measure the ink viscosity, shear stress and other ink properties, 2) sedimentation test to measure the amount of particle sedimentation or settling that may occur over time, 3) particle size analysis to measure the particle size and distribution using dynamic light scattering, and 4) Zeta potential to measure the electrostatic repulsion between particles in the suspension. In sum, the chemical stability of the ink may be an important factor to consider when designing Li ink compositions for aerosol jet printing, as chemical stability may affect the print quality, reliability and uniformity of the printed layer.

In some designs, the FPLiP ink (dispersion) composition may contain at least one non-polar solvent and a polymeric dispersion agent (dispersant) in addition to the FPLiPs. In some designs, the low density of the lithium metal may undesirably cause the FPLiP particles to float on the surface of commonly used non-polar organic solvents like dodecane and toluene. Since the density of lithium is quite low (about 0.53 g/cm³), many commonly-used solvents are more dense than lithium (e.g., density of dodecane is about 0.75 g/cm³). In some designs, the FPLiP may comprise the element carbon (e.g., in the form of lithiated carbon, carbon-comprising materials such as polymeric and/or oligomeric dispersant incorporated into an outer coating layer), lithium alloying element(s) and/or other elements (in some designs, as particles or nanoparticles of suitable size, composition and shape) to preferably tune their density to be close to or slightly higher than the density of the ink solvent used (in some designs, the particle density should ideally be within about ±20% of the solvent density; in other designs, within about ±15%, in other designs, within about ±10%; in other designs, within about ±5%; in other designs, within about ±2%, in other designs, within about +20%/−15%; in other designs, within about +20%/−10%; in other designs, within about +20%/−5%; in other designs, within about +20%/−2%; in other designs, within about +15%/−10%; in other designs, within about +15%/−5%; in other designs, within about +15%/−2%; in other designs, within about +10%/−5%; in other designs, within about +10%/−2%; in other designs, within about +5%/−2%). Furthermore, when the FPLiP particles are deposited onto the pre-coated primary active anode materials or other suitable surfaces (e.g., anode current collector, anode side of the separator, top surface of anode coating layer, etc.), their adhesion to the primary active anode surface may be unsatisfactory, and the FPLiP particles may tend to flake away after evaporation of the solvent. In some designs, the use of a suitable dispersant composition (e.g., polymeric and/or oligomeric dispersant) in the ink may enhance ink stability and adhesion of FPLiP to various surfaces. Therefore, in some designs, selecting appropriate polymeric (and/or oligomeric) dispersion agent(s) may be crucial to achieving uniform dispersion of the FPLiP particles and ensuring adhesion to the primary active anode surface. Additionally, the choice of polymeric (and/or oligomeric) dispersion agents may also help adjust or tune the viscosity of the formulations to be optimized for a given printing technique or equipment. Various suitable polymeric dispersion agents may be used in some designs, including but not limited to: polyimide (PI), polyethyleneimine (PEI), polysiloxane, polyisobutene (PIB), polyethylene wax (e.g., Evonik VESTOWAX), polyvinylpyrrolidone (PVP), polyethylene glycol (PEG), polystyrene (PS), polyvinyl (meth)acrylate (PMMA), polyvinyl chloride (PVC), polyethylene (PE), polyethylene oxide (PEO), polyvinyl acetate (PVA), polyacrylonitrile (PAN), polyvinylpyrrolidone (PVP), polyurethane (PU), polyethylene glycol (PEG), polyacrylamide (PAM), polyethyleneimine (PEI), polypropylene (PP), polyamide (PA), polyethylene (PE), polyvinylpyridine (PVPy), cellulose derivatives (e.g., carboxymethyl cellulose (CMC) and hydroxypropyl cellulose (HPC)), polyisoprene (PIso), poly ethylene vinyl acetate (PEVA), polyepichlorohydrin (PECH), styrene-butadiene rubber (SBR), polyvinylidene fluoride (PVDF), polyvinylidene fluoride-hexafluoropropylene copolymer (PVDF-HFP), fluorinated ethylene propylene (FEP), and fluorinated polyether (FPE).

In some designs, polyimides (PIs) have been found to be particularly suitable for use with the FPLiP inks described herein, which may be classified based on composition of its backbone. PIs are a class of polymers (including copolymers) that have high thermal stability, chemical resistance and mechanical strength. PIs have been used extensively in the battery industry as binders for the active materials. Suitable PIs may include: 1) aromatic PIs that are synthesized from aromatic diamines and dianhydrides, 2) aliphatic PIs synthesized with aliphatic diamines and dianhydrides, 3) semi-aromatic PIs that are a hybrid between aromatic and aliphatic PIs, 4) polyamide-imides (PAIs), 5) polyimide-siloxane copolymers, and 6) polyimide-polyamide copolymers. Selected examples of commercially available PIs and PI copolymers include: 1) P84 from EVONIK, 2) PETI-330 and PETI-340M available from Ube Corporation, 3) MATRIMID 5218 and 9725 by Huntsman, which is a soluble thermoplastic PI powder, 4) ULTEM 1000 and 2000 polyetherimide from SABIC, and 5) SIBRID TI thermoplastic silicone-polyimide block copolymer from Gelest. Some of these PIs are available in the form of pre-imidized powders that may be dissolved in organic solvents. Since these pre-imidized powders do not require further condensation reactions, the risk of producing water as a byproduct may be reduced or eliminated. Polymeric dispersants may be added not only to disperse the FPLiPs, but also to adjust the ink viscosity and improve the adhesion of the FPLiP to the target surface (e.g., anode electrode, current collector, separator layer, etc.).

In other designs, oligomeric (or polymeric) dispersion agents may be used. Illustrative examples of suitable dispersion agents include but are not limited to commercially available SILWET L-77 (polyalkyleneoxide modified heptamethyltrisiloxane), SILWET L-7001 (siloxane polyalkyleneoxide copolymer), L-7604 (siloxane polyalkyleneoxide copolymer), SILWET L-7607 (siloxane polyalkyleneoxide copolymer), BYK's BYK—P 104 (low molecular weight, unsaturated polycarboxylic acid polymer), General Electric's SF-1066 (polysiloxane-polyether copolymer), and, more generally, lauric acid, linoleic acid, linolenic acid, margaric acid, myristic acid, oleic acid, palmitic acid, palmitoleic acid, stearic acid and various co-polymers, variations, modifications, and mixtures thereof.

In some designs, the solvents used in the ink formulations may preferably be non-reactive in contact with the FPLiP. In some designs, the solvents used in the ink formulations may also preferably have low to moderate boiling points (e.g., from about 60 to about 260° C.; in some designs, from about 60 to about 80° C.; in other designs, from about 80 to about 100° C.; in other designs, from about 100 to about 120° C.; in other designs, from about 120 to about 150° C.; in other designs, from about 150 to about 180° C.; in other designs, from about 180 to about 210° C.; in other designs, from about 210 to about 260° C.) to allow the ink to dry within a reasonable time after printing, but not too volatile that the ink causes premature evaporation and/or clogs the printing machinery. Further, in some designs, the solvents used in the ink formulations may preferably also be safe and non-reactive. Illustrative classes of compounds suitable for use as solvents or in solvent mixtures may include but are not limited to: anhydrous aprotic organic solvents, such as aliphatic hydrocarbons, aromatics, ketones and fluorinated solvents. Specific examples of such solvents include, but are not limited to: hexane, undecane, dodecane, cyclohexane, toluene, xylene, petroleum ether, diethyl ether, tetrahydrofuran, methyl t-butyl ether, propylene glycol monomethyl ether acetate (PGMEA), γ-butyrolactone (GBL), caprolactone, butyrolactone, spironolactone, perfluorohexane, perfluorodecalin, fluoroethylene carbonate, hexafluoropropylene carbonate, perfluoropolyethers, and fluoromethyl ethylene carbonate. In some designs, a solvent (or a component of a solvent composition) that is employed in an FPLiP dispersion may also be used for making FPLiPs. The FPLiP ink (dispersion) slurry may be prepared in a mixing vessel (e.g., using a planetary mixer, high-speed mixer, static mixer, turbine steer, jet mixer, shaker, other mixers, or combinations of any of the foregoing mixers). In some designs, an ultrasonication process and/or a vibration process at other frequencies may also be advantageously used to break up any agglomerates and uniformly disperse the powders (e.g., FPLiPs).

In some designs, any inhomogeneous deposition of FPLiPs on the surface of suitable substrates (e.g., silicon-comprising anode electrode, anode current collector, anode side of the separator, etc.) may negatively impact the performance and safety of Li-ion batteries in various ways. Firstly, the uneven distribution of FPLiPs on the electrode surface may result, for example, in uneven lithiation, leading to capacity fading, premature aging, reduced cycle life and other negative attributes of the battery performance characteristics. Additionally, the accumulation of excess Li metal at localized spots due to uneven FPLiP distribution may increase the probability of short circuits, thermal runaway, and even explosions, which may pose a serious safety risk to the battery. Furthermore, the lack of sufficiently uniform coverage of FPLiP on the electrode surface may reduce the overall energy density of the battery, which may affect its performance and competitiveness in the market. Therefore, in some designs, it may be highly advantageous to ensure the proper dispersion and uniform deposition of FPLiPs on the anode electrode.

FPLiP ink formulations may be deposited or printed using various suitable printing (coating) techniques, including but not limited to: screen printing, offset lithography printing, gravure printing, flexographic printing, pad printing, slot-die coating, inkjet printing, and Aerojet printing. Among these techniques, offset lithography, gravure, flexographic, pad printing, inkjet printing, and Aerojet printing, in particular, are advantageously capable of high-speed, high-volume production of various printed surfaces (substrates). Additionally, printing allows the FPLiP inks to be applied precisely in desired shapes and locations. In some designs, inkjet or aerosol jet printing may facilitate formation of very thin layers of FPLiP ink on a wide variety of substrates, including primary anode electrode layer comprising active materials (e.g., PAAPs). In some cases, FPLiP-comprising layers with an average thickness of about 3-5 microns, or less, may be produced. While inkjet printing is typically limited to a relatively narrow range of FPLiP ink viscosities, e.g., between about 5 cP to about 40 cP, aerosol jet printing may accommodate a wider range of FPLiP ink viscosities, from about 1 to about 1,000 cP, facilitating the use of many materials in an FPLiP ink (dispersion) formulation, including those with polymeric and/or oligomeric dispersion agents. This versatility in ink viscosity may allow for greater flexibility in material choices and formulation of the FPLiP inks for aerosol jet printing. Overall, the ability to print lithium ink formulations optimized for various printing techniques provides greater flexibility, precision, and efficiency in the manufacturing of lithium batteries, facilitating the production of higher quality and more efficient batteries.

In some designs, the dry thickness of the coating (or amount of FPLiP or lithium deposited) may be controlled or tuned by adjusting the tool parameters or the lithium (or lithium metal-comprising or lithium alloy-comprising) powder concentration. In case of using an aerosol printing technique, the FPLiP slurry may be fed into an aerosol generator, which may produce a stream of fine droplets in the range of about 1 to about 10 microns in diameter. The droplets may then be directed towards a suitable substrate surface (e.g., separator, anode current collector, anode surface, etc.) using a nozzle or a spray gun. The droplets collide with the substrate and stick to its surface, forming a layer of lithium metal (or lithium metal-comprising or lithium alloy-comprising) powder.

After printing, the FPLiP-coated substrate (e.g., separator, anode current collector, anode coating layer, etc.) may then be dried to remove the solvent and may be additionally sintered in some designs to consolidate the lithium metal (or lithium metal-comprising or lithium alloy-comprising) powder particles. In some designs, the sintering process may involve heating the coated substrate to a sufficiently high temperature to melt the lithium powders in a controlled atmosphere. In some designs, the sintering process may involve compressing the coated substrate at a suitable applied pressure in a controlled atmosphere. For example, the coated substrate may undergo a sintering process from about 180.5° C. to about 200° C. (melting point of Li is about 180.5° C.), with an applied pressure in a range of about 1-200 MPa. In some cases in which the substrate is a negative electrode (anode), the applied pressure on the negative electrode may range from about 10 MPa to about 40 MPa. In some designs, the sintering process may help to improve the adhesion between the FPLiPs and the substrate and among the FPLiPs, and may also improve the electrode's mechanical properties. Furthermore, in some designs, this sintering process may facilitate the activation of the FPLiP particles, leading to the exposure of the underlying lithium metal or lithium metal alloy.

In some designs, the coated anode substrate may undergo a separate calendering process (e.g., in a controlled environment) to activate the FPLiP particles to expose the Li metal or Li metal alloy. Calendering may involve passing the FPLiP coated substrate (e.g., anode current collector/anode layer comprising PAAPs and FPLiPs) or multiple layers comprising the FPLiP-coated layer (e.g., anode current collector/FPLiP-comprising layer/anode active material layer, or anode current collector/anode active material layer/FPLiP-comprising layer, or anode current collector/anode active material layer/FPLiP-coated separator, etc.) through a set of rollers to compress and breach (e.g., crack) the outer coating materials in FPLiPs (e.g., expose Li or Li alloy). In some designs, this activation step may lead to a pre-lithiation of suitable Si-comprising active anode material (e.g., Si—C composite or nanocomposites, among others), reducing formation losses of Li from the cathode and provide other positive attributes (in some designs, may reduce the volume expansion of the Si-comprising anode during the initial charge and discharge cycles, leading to improved cycling performance and energy density, etc.). Alternatively, in other designs, the activation process may result in the FPLiPs becoming electrochemically active (e.g., becoming susceptible to delithiation) when or after being assembled into a suitable battery (e.g., filled with a suitable electrolyte, etc.). In some designs, the activation process may at least partially take place during the first charge or so-called formation cycling process. For example, the first charge may induce compression forces within the battery—in some designs, for example, Si-comprising anode may increase in volume (increase thickness and/or densify), inducing stresses within the FPLiP powders that may lead to FPLiP activation. In some designs, the electrolyte may induce swelling or partial dissolution of the organic (e.g., polymeric) outer coating layer of one or more of the FPLiPs, making the affected FPLiP(s) permeable to electrolyte solvents and Li ions. In some designs, the organic (e.g., polymeric) outer coating layer in FPLiPs may comprise conductive additives that electrically connect the Li metal or Li metal alloy within the FPLiP with neighboring particles and may facilitate the Li from FPLiP to be a reactant in desirable electrochemical reactions (e.g., at least partial lithiation of suitable Si-comprising or other suitable anode materials, such as anode particles).

Some aspects are directed to the direct addition of FPLiP powders to the anode slurry formulation. Typically, polar solvents are used in conventional electrode slurry processing. In implementations in which FPLiPs are to be added to an anode slurry comprising polar solvents, the compatibility of the organic material (e.g., a polymeric and/or an oligomeric dispersant) of the outer coating layer of the FPLiPs to the polar solvents may be beneficial. In some designs, the outer coating layer preferably does not dissolve or does not swell significantly (e.g., by no more than about 20 vol. %; in some designs, by no more than about 15%; in some designs, by no more than about 10%; in some designs, by no more than about 5%; in some designs, by no more than about 2%; in some designs, by no more than about 1%) in polar solvents or water or water vapors. Furthermore, in some designs, additional polymeric dispersing agents and other additives may be advantageously added (e.g., in the dispersion) to disperse the FPLiPs more uniformly in the slurry formulation. In some designs, it may be desirable to reduce or minimize the mass and volume fraction of the binder(s) within the electrodes to enhance volumetric and gravimetric energy densities, lower electrode impedance and improve rate capability. It may be particularly advantageous, for example, for the electrode to comprise less than about 25-30 vol. % binder relative to the total volume of the electrode including the binder, conductive and other additives, and active material particles, but excluding the volume of the pores left within the electrode during or after its fabrication and also excluding the current collector (in some designs, less than about 25 vol. %; in other designs, less than about 20 vol. %; in other designs, less than about 16 vol. %; in other designs, less than about 12 vol. %; in other designs, less than about 8 vol. %; in yet other designs, less than about 6 vol. %). It may also be advantageous, in some designs, for the electrode to comprise less than about 14-16 wt. % binder relative to the total weight of the electrode including the binder, conductive and other additives, and active material particles, but excluding the mass of the current collector (in some designs, less than about 14 wt. %; in other designs, less than about 12 wt. %; in other designs, less than about 10 wt. %; in other designs, less than about 8 wt. %; in other designs, less than about 6 wt. %; in other designs, less than about 5 wt. %; in other designs, less than about 4 wt. %; in other designs, less than about 3 wt. %).

In some designs, it may be preferable to use a solvent-free electrode fabrication process to improve one or more Li-ion battery performance characteristics (e.g., charge/discharge rate, high-temperature stability, energy density, specific energy, etc.). An aspect is directed to the advantageous use of a suitable binder precursor—such as (e.g., reactive) liquid monomers and/or oligomers (e.g., as binder precursor(s) or binder component precursor(s)) in the solvent-free fabrication of electrodes. In some designs, such suitable (in some designs, liquid) monomers or oligomers may be advantageously mixed with primary active electrode materials (e.g., PAAPs), FPLiPs, conductive (or other functional) additives, and (optionally) additional (liquid or solid) binder component(s) to form a so-called “electrode mass,” which is deposited on a surface of suitable current collectors by suitable means. In some designs, the binder precursor may then be converted into corresponding polymers to serve as effective binders in the produced electrodes (in some designs, prior to battery assembly or prior to electrolyte infiltration).

In some designs, the reactive (e.g., polymerizable) binder precursor(s) for the final binder formation may be one of the following: (i) a liquid, (ii) a mixture of two or more liquids, (iii) a mixture of solid(s) and liquid component(s). In some designs, the use of at least one liquid component as a binder precursor may be particularly advantageous to facilitate uniform mixing and improves tribological properties of the electrode mixture prior to full electrode solidification.

In some designs, the formation of polymer binder(s) from the polymerizable binder precursor (e.g., liquid monomer or oligomer precursor(s)) may include: (i) homo-polymerization reactions or (ii) hetero-polymerization reactions or (iii) both homo- and hetero-polymerization reactions. Illustrative examples for the formation of polymer binder(s) from polymerizable binder precursor include, but are not limited to, one or more of the following reactions: (i) free radical polymerization (e.g., acrylate/(meth)acrylates), (ii) ring opening copolymerization of epoxies with anhydrides or amines, (iii) condensation polymerization of amino acids (e.g., glutamic acid), (iv) condensation of isocyanates with polyols or amines (e.g., polyurethane and polyurea, respectively), (v) olefin metathesis polymerization reaction, (vi) acid (including both Lewis and Bronsted acids) or base (including both Lewis and Bronsted bases) mediated condensation polymerization, (vii) Friedel-Crafts polymerization, (viii) heat mediated condensation hetero-polymerization (e.g., between amine/alcohol and carboxylic acids/carboxylic acid anhydrides/esters/boronic acids), and (ix) heat mediated homocondensation polymerization (e.g., boronic acid condensation).

Note that, in some designs, the binder curing (polymerization) procedure may be chemistry-specific. For example, in case of acrylate chemistry, it may be advantageous to use one or more of the following: (i) application of heat with thermal initiators, (ii) application of ultraviolet (UV) light with UV initiators, (iii) a combination of both heat and UV light, including use of respective initiators.

Acrylate chemistry involves polymerization of unsaturated ester monomers/oligomers. Examples of acrylate precursor include, but are not limited to, methyl acrylate, methyl methacrylate, ethyl acrylate, ethyl methacrylate, n-propyl acrylate, n-propyl methacrylate, isopropyl acrylate, isopropyl methacrylate, lauryl acrylate, stearyl acrylate, butyl acrylate, 2-hydroxyethyl acrylate, 2-hydroxyethyl methacrylate, 3-hydroxypropyl methacrylate, 3-glycidylpropylmethacrylate, trimethylolpropane triacrylate, polyethylene glycol diacrylate, 1,6-hexanediol diacrylate, ethoxylated bisphenol A dimethacrylate, isobornyl acrylate, polyurethane acrylate, epoxy acrylate, polyethylene glycol monomethacrylate, aliphatic urethane acrylate oligomers, and aromatic urethane acrylate oligomers. Examples of suitable commercially available acrylates include, but are not limited to various ARKEMA's SARTOMER products, such as SR-307, SR-306, SR-454, SR-9053, CN-131B, CN-502, CN-975, CN-986 and CN-301. Examples of thermal initiators include, but are not limited to, azobisisobutyronitrile (AIBN), 2,2′-azobis(2-methylpropionamidine) dihydrochloride (V-50), 2,2′-azobis(2,4-dimethylvaleronitrile) (ADMVN), benzoyl peroxide (BPO), di-tert-butyl peroxide (DTBP), diisopropyl peroxydicarbonate (DIPC), cumyl hydroperoxide (CHP), 2,2′-azobis(2-amidinopropane) dihydrochloride (V-511), and 2,2′-Azobis[2-(2-imidazolin-2-yl)propane]dihydrochloride (VA-044). Some examples of UV initiators are 2,2-dimethoxy-1,2-diphenylethan-1-one, 2-hydroxy-2-methyl-1-phenylpropanone, 1-hydroxy-cyclohexylphenylketone, benzophenone, and isopropyl thioxanthone. Suitable commercially available photoinitiators include DAROCUR 1173, DAROCUR 4265, IRGACURE 184, IRGACURE 369, IRGACURE 651, IRGACURE 819, IRGACURE 907, IRGACURE 1700, ESACURE KIP 150, ESACURE TZT, and LUCIRIN TPO-L.

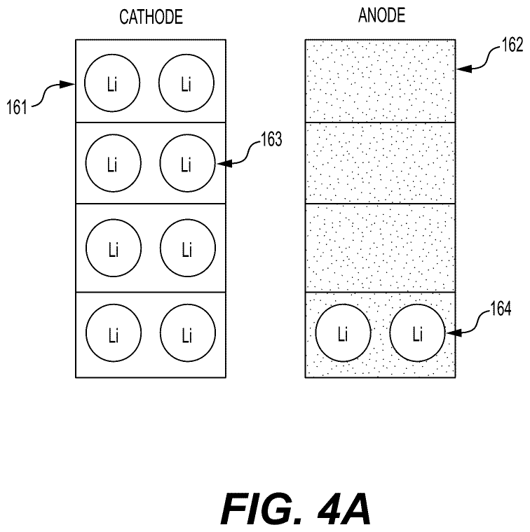

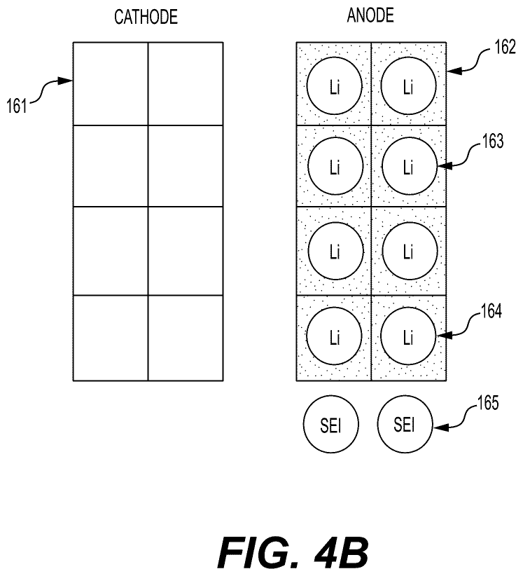

FIG. 4A depicts a schematic diagram of a lithium-ion battery in the pre-formation state, where FPLiPs are present in the anode. The illustrated example battery includes a positive electrode (cathode) (161) and a negative electrode (anode) (162), where boxes schematically denote sites that may be occupied by lithium atoms and circles denote lithium atoms present in the cathode active material (163) and FPLiPs in the anode (164). In the example shown in FIG. 4A, the FPLiPs may have been previously activated or may be activated during the formation cycling. FIG. 4B depicts a schematic diagram of a lithium-ion battery after the first charge has been performed. The formation of a solid electrolyte interphase (SEI) at the anode side leads to the loss of a small fraction of active lithium, resulting in a decrease in the amount of active lithium during subsequent cycles. Instantiations of this protective SEI layer containing lithium atoms are labeled as 165 in FIG. 4B. The active lithium that is consumed in the formation of this SEI originates from the cathode active material (163) and/or the FPLiPs (164). The pre-lithiation process (e.g., inclusion of FPLiPs in the anode and their subsequent activation) may compensate for the loss of active lithium in the anode, thereby enhancing the energy density of the battery system.

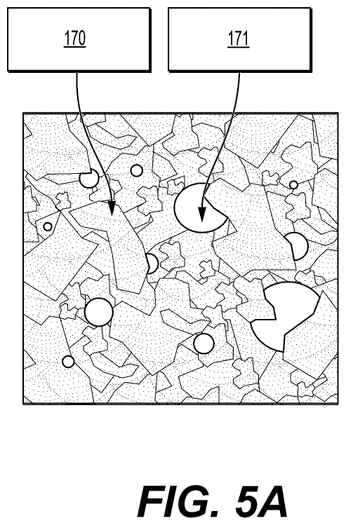

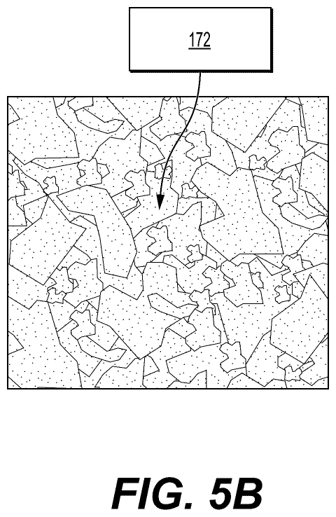

FIG. 5A illustrates example FPLiP particles 171 (in this example having a spherical or spheroidal shape) interspersed with suitable active material particles 170 (e.g., including those comprising Si, such as silicon-carbon composite material particles, in some designs). In some designs, FPLiP may chemically react to produce, for example, lithiated Si-comprising particles (e.g., silicon-carbon composite material particles). In some designs, such a reaction may proceed before Si comprising particles are assembled into the electrode. In other designs, such a reaction may proceed after Si-comprising particles are assembled into the electrode or after the electrode is assembled into a cell or when the cell is undergoing formation cycling, etc. FIG. 5B illustrates lithiated silicon-carbon composite materials (172).

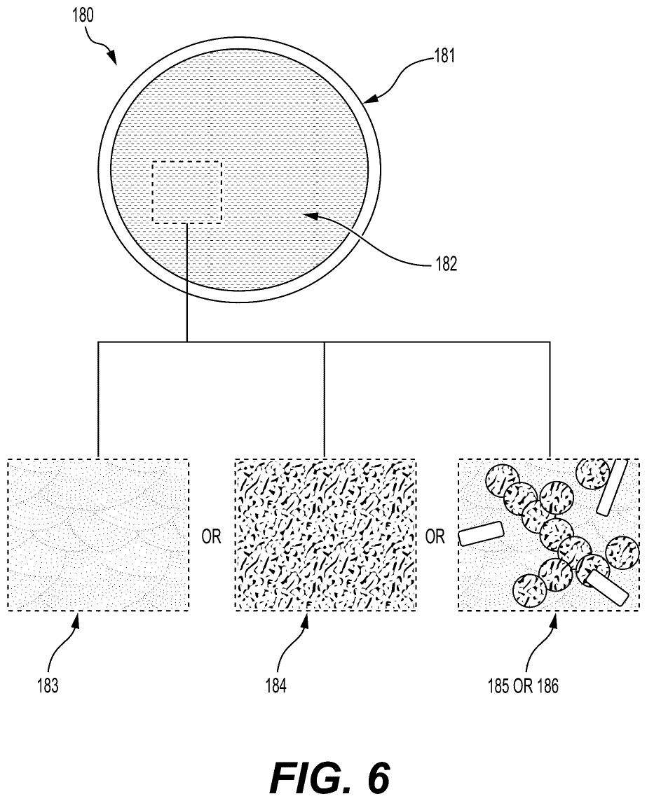

FIG. 6 illustrates a functionalized pre-lithiation particle (FPLiP) (180), comprising a conformal outer protective layer (181) around a lithium-comprising material (182), which may be a lithium metal (183) or lithium metal alloy (184) or lithium metal composite (185) or lithium metal alloy composite particle (186). Note that the conformal outer protective layer (181) may be a composite material. In some designs, the conformal outer protective layer (181) may comprise one, two or more suitable conductive additives (e.g., conductive carbon or conductive carbon-comprising particles). In some designs, the conformal outer protective layer (181) may comprise one, two or more suitable polymer components. In some designs, the conformal outer protective layer may be a seal, i.e., sealing the interior material (182) from the outside.

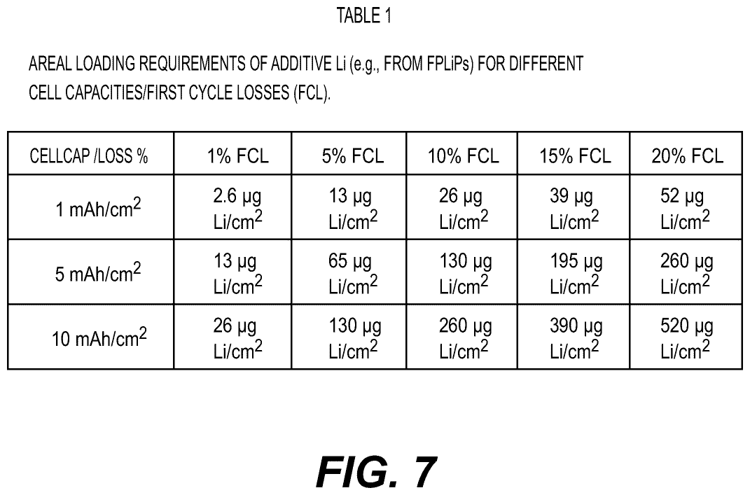

FIG. 7 presents Table 1, which outlines examples of areal loading requirements for FPLiPs or similar Li or Li-alloy compositions across various cell capacities (anode capacity per unit area) and irreversible first-cycle losses (FCLs). In the example shown in Table 1 (FIG. 7), irreversible first-cycle losses (FCLs) of 1%, 5%, 10%, 15%, and 20% and cell capacities (anode capacity per unit area) of 1 mAh/cm², 5 mAh/cm², and 10 mAh/cm² are considered. In the example shown, the irreversible first-cycle loss capacity loss is expressed as a percentage of the total anode capacity (anode capacity per unit area). The estimated amount of FPLiP needed (e.g., to compensate for irreversible capacity losses) to pre-lithiate the anode in lithium-ion batteries may depend on various factors, including the cell capacities and irreversible first cycle losses. To estimate the amount of FPLiPs needed (e.g., to compensate for irreversible capacity losses), the capacity of the anode material and the expected irreversible capacity loss during the first cycle may be estimated. For example, if the areal cell capacity (anode capacity) is 10 mAh/cm² and the irreversible first cycle loss (FCL) is estimated to be 10%, then it is estimated that 260 μg of Li (obtained from FPLiPs or otherwise) is needed per cm² of anode (e.g., to compensate for irreversible capacity losses). Due to the higher first cycle efficiencies observed in silicon/carbon composite-based anode materials (e.g., irreversible first-cycle loss of about 20% or less, equivalent to first-cycle coulombic efficiency of about 80% or greater), in some designs, the required amount of FPLiP (e.g., to compensate for irreversible capacity losses) may be relatively low as exemplified in FIG. 7. Therefore, achieving a uniform dispersion of FPLiP within the anode slurry may be advantageous to ensure a uniform coating for effective pre-lithiation. Note that the foregoing discussion has used the term first-cycle loss (FCL) to characterize primary anode active particles.

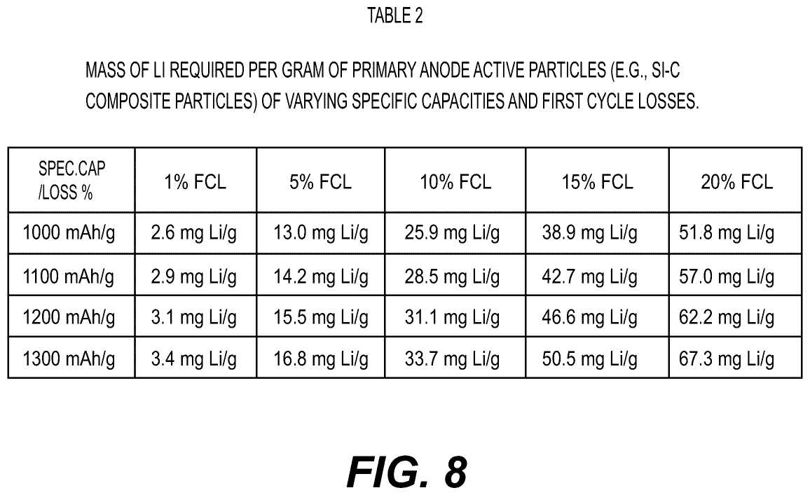

FIG. 8 presents Table 2, which outlines examples of mass of Li used to conduct pre-lithiation of suitable primary anode active particles (PAAPs) comprising (e.g., that each comprise) Si and C (e.g., Si—C nanocomposites) of respective specific capacities of the PAAPs and irreversible first-cycle losses (FCLs) of the PAAPs. In the example shown in Table 2 (FIG. 8), irreversible first-cycle losses (FCLs) of 1%, 5%, 10%, 15% and 20% and specific capacities of 1000 mAh/g, 1100 mAh/g, 1200 mAh/g, and 1300 mAh/g are considered. In some designs, a target amount of lithium (obtained from FPLiPs or otherwise) for pre-lithiation of PAAPs may be calculated from the theoretical specific capacity of the PAAPs and the anticipated first cycle losses as a percentage of the specific capacity. For example, a silicon-carbon composite material with a theoretical specific capacity of 1300 mAh/g and an estimated FCL of 5% may utilize 16.8 mg of Li (e.g., obtained from FPLiP) to compensate for the loss, per gram of Si—C composite material. As shown in FIG. 7 and FIG. 8, the amount of FPLiPs varies depending on the areal capacity loading and/or specific capacity and the first cycle losses of the silicon-carbon composite material used.

Mass ratios of the PAAPs (e.g., Si—C composite particles) to the additive Li (e.g., obtained from FPLiPs) utilized for pre-lithiation may be approximated from the example values listed in Table 2 (FIG. 8). For example, in the case of a first-cycle loss of 5% and a PAAP specific capacity of 1000 mAh/g, the PAAP to Li mass ratio would be 1000:13 or approximately 77:1. By similar calculations, for a first-cycle loss of 5%, the PAAP to Li mass ratio would range between about 60:1 (for PAAP specific capacity of 1300 mAh/g) and about 77:1 (for PAAP specific capacity of 1000 mAh/g). For a first-cycle loss of 1%, the PAAP to Li mass ratio would range between about 294:1 (for PAAP specific capacity of 1300 mAh/g) and about 385:1 (for PAAP specific capacity of 1000 mAh/g). For a first-cycle loss of 10%, the PAAP to Li mass ratio would range between about 30:1 (for PAAP specific capacity of 1300 mAh/g) and about 39:1 (for PAAP specific capacity of 1000 mAh/g). For a first-cycle loss of 15%, the PAAP to Li mass ratio would range between about 20:1 (for PAAP specific capacity of 1300 mAh/g) and about 26:1 (for PAAP specific capacity of 1000 mAh/g). For a first-cycle loss of 20%, the PAAP to Li mass ratio would range between about 15:1 (for PAAP specific capacity of 1300 mAh/g) and about 19:1 (for PAAP specific capacity of 1000 mAh/g). In some implementations, a mass ratio of the PAAPs to the additive Li may be in a range of about 400:1 to about 10:1 (e.g., in a range of about 10:1 to about 100:1, or in a range of about 100:1 to about 200:1, or in a range of about 200:1 to about 300:1, or in a range of about 300:1 to about 400:1). Note that in the foregoing discussion, the mass ratios have been expressed in terms of the masses of the PAAPs and the Li. However, it may be convenient to express the mass ratios in terms of the masses of the PAAPs and the FPLiPs. A mass fraction of the Li in the FPLiPs may vary depending on factors such as the outer protective coating that is employed or whether the particle core comprises Li metal or an alloy of Li. Nevertheless, it may be preferable for the mass fraction of the Li in the FPLiPs to be quite high, such as at least about 50 wt. %. In some implementations, a mass ratio of the PAAPs to the FPLiPs may be in a range of about 400:1 to about 10:1 (e.g., in a range of about 10:1 to about 200:1, or in a range of about 10:1 to about 100:1, or in a range of about 100:1 to about 200:1, or in a range of about 200:1 to about 300:1, or in a range of about 300:1 to about 400:1).

In some implementations, the irreversible first-cycle loss of the PAAPs is about 20% or less (e.g., in a range of about 1% to about 5%, or in a range of about 5% to about 10%, or in a range of about 10% to about 15%, or in a range of about 15% to about 20%). In some implementations, first-cycle coulombic efficiency of the PAAPs is about 80% or greater (e.g. in a range of about 80% to about 85%, or in a range of about 85% to about 90%, or in a range of about 90% to about 95%, or in a range of about 95% to about 99%).

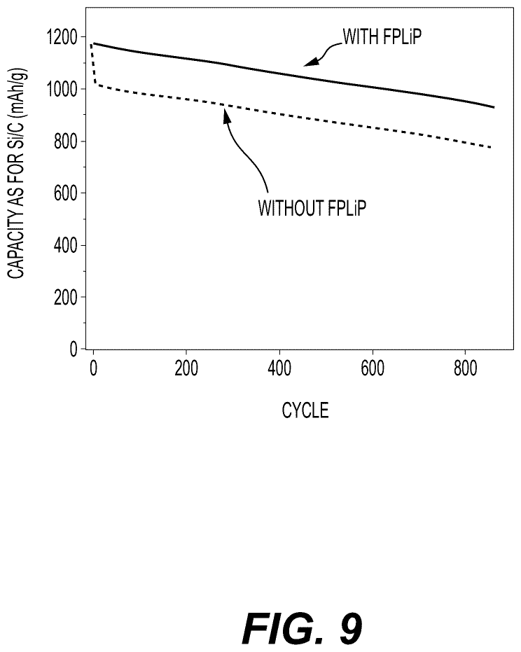

FIG. 9 shows graphical plots of the capacity retention as a function of the number of cycles (the number of cycles shown is up to 80% of cycling-start capacity (N80) of the cells with FPLiPs added at 0.5 wt. %) for the example Li-ion battery cells for (1) single-layer pouch cells with 100 wt. % (as fraction of anode actives) of Si—C nanocomposite and about 0.5 wt. % FPLiP (as a fraction of the cathode actives), and LCO as the cathode, and (2) single-layer pouch cells with 100 wt. % (as fraction of anode actives) of Si—C nanocomposite as the anode (no additive FPLiP), and LCO as the cathode. Results highlight the improvement in volumetric energy density for cells including an-FPLiP. (The N80 quantity indicates the number of complete charge-discharge cycles a battery may undergo before its capacity decreases to 80% of its cycling-start capacity, during cycling at about 25° C.)

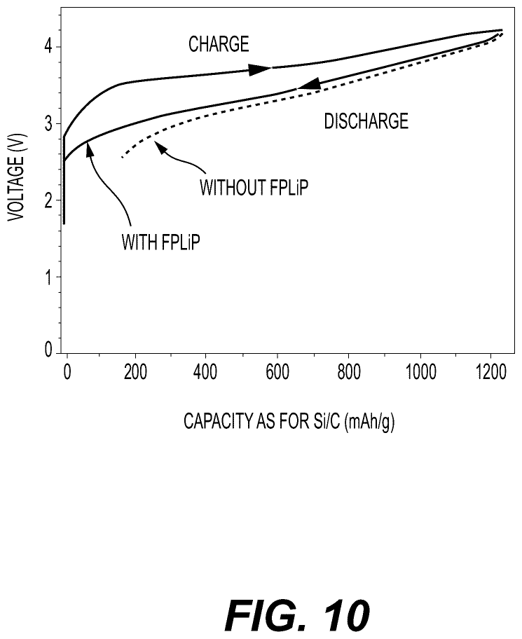

FIG. 10 shows a graphical plot of the first-cycle voltage profile of an example full cell for (1) single-layer pouch cells with 100 wt. % (as fraction of anode actives) of Si—C nanocomposite and about 0.5 wt. % FPLiP (as a fraction of the cathode actives), and NMC811 as the cathode, and (2) single-layer pouch cells with 100 wt. % (as fraction of anode actives) of Si—C nanocomposite as the anode (no additive FPLiP), and NMC811 as the cathode. These plots demonstrate the advantageous effect of incorporating an FPLiP into the anode, in accordance with one or more implementations of the present invention.

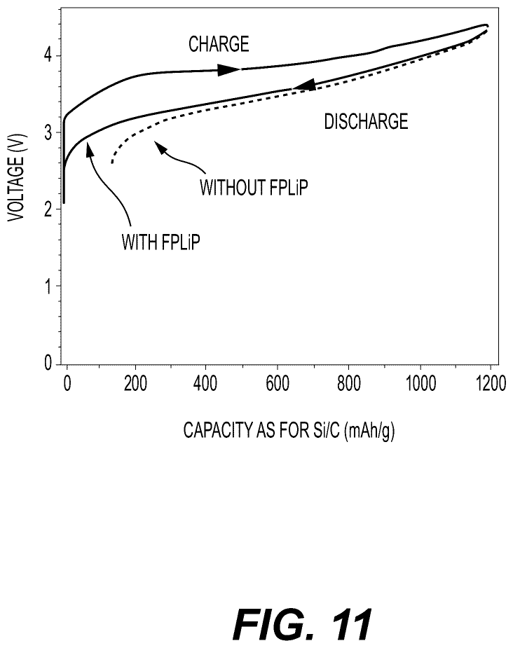

FIG. 11 shows a graphical plot of the first-cycle voltage profile of an example full cell for (1) single-layer pouch cells with 100 wt. % (as fraction of anode actives) of Si—C nanocomposite and about 0.5 wt. % FPLiPs (as a fraction of the cathode actives), and LCO as the cathode, and (2) single-layer pouch cells with 100 wt. % (as fraction of anode actives) of Si—C nanocomposite as the anode (no additive FPLiP), and LCO as the cathode. These plots demonstrate the advantageous effect (increase in capacity) of incorporating FPLiPs into the anode, in accordance with one or more implementations of the present invention.

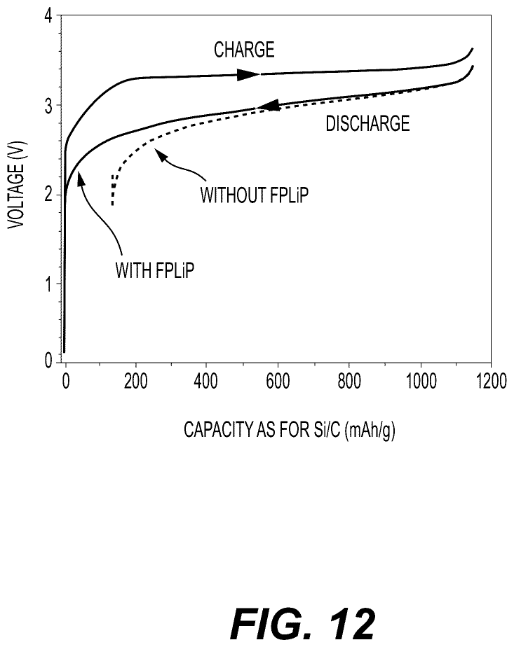

FIG. 12 shows a graphical plot of the first-cycle voltage profile of an example full cell for (1) single-layer pouch cells with 100 wt. % (as fraction of anode actives) of Si—C nanocomposite and about 0.5 wt. % FPLiP (as a fraction of the cathode actives), and LFP as the cathode, and (2) single-layer pouch cells with 100 wt. % (as fraction of anode actives) of Si—C nanocomposite as the anode (no additive FPLiP), and LFP as the cathode. These plots demonstrate the advantageous effect of incorporating FPLiPs into the anode, in accordance with one or more implementations of the present invention.

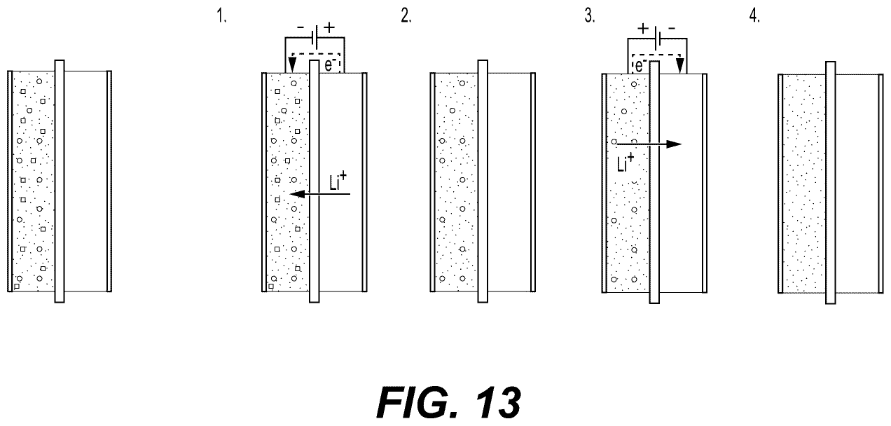

FIG. 13 schematically illustrates a battery cell comprising a silicon-carbon nanocomposite anode containing FPLiPs paired with a high first-cycle efficiency cathode, as it undergoes stages in the formation cycling. The left-most graphic shows the battery cell before formation cycling. Subsequent stages during and after formation cycling are shown as (1), (2), (3), and (4): At (1), during the first charge, lithium and electrons from the cathode are transported to the anode. At (2), reversible and irreversible lithium/electron sites in the anode are lithiated. At (3), during the first discharge, lithium in the FPLiPs and reversible lithium in the anode are transported to the cathode. Irreversible lithium in the anode remains. At (4), close matching of anode and cathode capacities after the formation cycle.

In some designs, high first-cycle or formation losses in suitable Si-comprising anodes (in some designs, in suitable Si—C composite or nanocomposite particles' comprising anodes) may lead to incomplete capacity utilization of the paired cathode material or undesirably increase the required mass and volume of the cathode material. In some designs, to supplement these losses, FPLiPs may be combined with the suitable Si-comprising anode material (e.g., particles, such as suitable silicon-carbon composite or nanocomposite material particles, among others) prior to cycling, so that the FPLiP may chemically react with the suitable Si-comprising anode active material(s) (e.g., silicon-carbon composite or nanocomposite material) prior to electrochemical delithiation during the first discharge cycle. In some example methods, FPLiPs may be mixed with suitable Si-comprising anode active materials (e.g., composite active material particles, such as Si—C composite particles) and heated to elevated temperatures (e.g., within the temperature range from about 100 to about 800° C.; in some designs, from about 100 to about 250° C.; in other designs, from about 250 to about 400° C.; in other designs, from about 400 to about 650° C.; in other designs, from about 650 to about 800° C. In some designs, it may be preferable for the FPLiPs mixed with Si-comprising anode active material (e.g., composite active material particles, such as Si—C composite particles) to be compressed (e.g., via calendering) to ensure a good intimate contact. In some designs, the FPLiP mixed with the Si-comprising anode active material (e.g., composite active material particles, such as Si—C composite particles) may be made into granules to enhance lithiation uniformity and improve powder handling (in some designs, from about 100 microns to about 10 mm in average size; in some designs, from about 100 microns to about 0.5 mm or from about 0.5 mm to about 2 mm or from about 5 mm or from about 5 mm to about 10 mm) prior to heating. In some designs, the FPLiP particles may be plastically deformed during such a compression (e.g., calendering). In some designs, the coating may at least partially break or decompose during such a compression or a heating process. In some designs, the environment in the heating chamber (vessel) may be controlled to reduce or avoid undesirable reactions (e.g., with CO₂ or H₂O or oxygen or hydrogen or other undesirable species which may impede the reaction or induce undesirable Li losses, etc.). In some designs, the heating chamber may be evacuated. In some designs, the initial pressure in the heating chamber may be below atmospheric (e.g., vacuum). In some designs, the heating chamber may be filled with an inert or relatively inert gas. In some designs, lithiated Si-comprising anode active material may be milled prior to use in electrodes.

In some designs, FPLiP may be directly delithiated (oxidized) during the first discharge cycle. In some designs, the lithium equivalents may advantageously be added from FPLiP to offset the irreversible lithium consumed at the anode (e.g., in the SEI or within the active material particles, etc.) during the initial charge or formation protocol. In some designs, this allows much closer capacity matching of anode and cathode post-formation cycle and overall improved energy densities.

In some designs, battery cell modules or battery cell packs may advantageously comprise cells with FPLiP, electrode, separators and/or electrolyte compositions provided in this disclosure. In some designs, such cell modules or packs may offer improved performance characteristics, simplified designs, better safety features or lower cost. In some designs, ground, sea and aerial electric vehicles as well as other devices may similarly attain superior characteristics and improved features and capabilities if they comprise such battery modules or packs.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. An anode dispersion, comprising: primary anode active particles (PAAPs) that each comprise silicon (Si) and carbon (C); functionalized pre-lithiation particles (FPLiPs) comprising lithium (Li); and a solvent composition in which the PAAPs and FPLiPs are dispersed; wherein: a mass ratio of the PAAPs to the FPLiPs is in a range of about 10:1 to about 200:1; each of the FPLiPs comprises a core and an outer protective coating around the core, the outer protective coating comprising an oligomeric dispersant and/or a polymeric dispersant; and a viscosity of the anode dispersion is in a range of about 1 cP to about 10,000 cP (in some designs, in a range of about 1 cP to about 1,000 cP).

Clause 2. The anode dispersion of clause 1, wherein: an average density of the FPLiPs is within about ±20% of an average density of the solvent composition.

Clause 3. The anode dispersion of any of clauses 1 to 2, wherein: the respective core of each of the FPLiPs comprises a non-Li element that is more dense than the Li.

Clause 4. A method of making an anode, the method comprising: coating the anode dispersion of clause 1 on an anode current collector to form the anode on the anode current collector; and activating the FPLiPs.

Clause 5. The method of clause 4, wherein: the activating comprises a heat treatment and/or a pressure treatment.

Clause 6. The method of clause 5, wherein: the activating comprises the heat treatment and the heat treatment comprises subjecting at least the anode to a temperature in a range of about 180.5° C. to about 200° C.

Clause 7. The method of any of clauses 5 to 6, wherein: the activating comprises the pressure treatment and the pressure treatment comprises subjecting at least the anode to a pressure in a range of about 1 MPa to about 200 MPa.

Clause 8. The method of any of clauses 4 to 7, wherein: the activating comprises reacting at least some the Li of the FPLiPs with at least some of the Si of the PAAPs.

Clause 9. The anode made according to the method of any of clauses 4 to 8.

Clause 10. The anode of clause 9, wherein a mass fraction of the Si in the anode is in a range of about 10 wt. % to about 60 wt. %.

Clause 11. A method of making a lithium-ion battery, the method comprising: making the anode according to the method of clause 4; providing or making a cathode on a cathode current collector; and assembling a battery cell from the anode on the anode current collector and the cathode on the cathode current collector; and filling a space between the anode and the cathode with an electrolyte ionically coupling the anode and the cathode to form the lithium-ion battery.

Clause 12. The method of clause 11, wherein: the method further comprises carrying out formation cycling on the lithium-ion battery, wherein the formation cycling comprises transferring ions of at least some of the Li of the FPLiPs to the PAAPs.

Clause 13. The lithium-ion battery made according to the method of any of clauses 11 to 12.

Clause 14. The lithium-ion battery of clause 13, wherein: a first-cycle coulombic efficiency of the PAAPs is about 80% or greater.

Clause 15. A pre-lithiation particle dispersion, comprising: functionalized pre-lithiation particles (FPLiPs) comprising lithium (Li); and a solvent composition in which the FPLiPs are dispersed, wherein: each of the FPLiPs comprises a core and an outer protective coating around the core, the outer protective coating comprising an oligomeric dispersant and/or a polymeric dispersant; and a viscosity of the pre-lithiation particle dispersion is in a range of about 1 cP to about 1000 cP.

Clause 16. The pre-lithiation particle dispersion of clause 15, wherein: an average density of the FPLiPs is within about ±20% of a density of the solvent composition.

Clause 17. The pre-lithiation particle dispersion of any of clauses 15 to 16, wherein: the respective core of each of the FPLiPs comprises a non-Li element that is more dense than the Li.

Clause 18. A method of making an anode, the method comprising: forming an anode on an anode current collector, the anode comprising primary anode active particles (PAAPs) that each comprise silicon (Si) and carbon (C); coating the pre-lithiation particle dispersion of clause 15 on the anode to form a pre-lithiation particle layer comprising the FPLiPs on the anode; and activating the FPLiPs, wherein: a mass ratio of the PAAPs in the anode to the FPLiPs in the pre-lithiation particle layer is in a range of about 10:1 to about 200:1.

Clause 19. The method of clause 18, wherein: the activating comprises a heat treatment and/or a pressure treatment.

Clause 20. The method of clause 19 wherein: the activating comprises the heat treatment and the heat treatment comprises subjecting at least the pre-lithiation particle layer to a temperature in a range of about 180.5° C. to about 200° C.

Clause 21. The method of any of clauses 19 to 20, wherein: the activating comprises the pressure treatment and the pressure treatment comprises subjecting at least the pre-lithiation particle layer to a pressure in a range of about 1 MPa to about 200 MPa.

Clause 22. The method of any of clauses 18 to 21, wherein: the activating comprises reacting at least some of the Li of the FPLiPs with at least some of the Si of the PAAPs.

Clause 23. The anode made according to the method of any of clauses 18 to 22.

Clause 24. The anode of clause 23, wherein a mass fraction of the Si in the anode is in a range of about 10 wt. % to about 60 wt. %.

Clause 25. A method of making a lithium-ion battery, the method comprising: making the anode according to the method of clause 18; providing or making a cathode on a cathode current collector; assembling a battery cell from the anode on the anode current collector and the cathode on the cathode current collector; and filling a space between the anode and the cathode with an electrolyte ionically coupling the anode and the cathode to form the lithium-ion battery.

Clause 26. The method of clause 25, further comprising: transferring ions of at least some of the Li of the FPLiPs to the PAAPs via formation cycling of the lithium-ion battery.

Clause 27. The lithium-ion battery made according to the method of any of clauses 25 to 26.

Clause 28. The lithium-ion battery of clause 27, wherein: a first-cycle coulombic efficiency of the PAAPs is about 80% or greater.

Clause 29. A method of making an anode, the method comprising: coating the pre-lithiation particle dispersion of clause 15 on an anode current collector to form a pre-lithiation particle layer comprising the FPLiPs on the anode current collector; coating an anode composition on the pre-lithiation particle layer to form an anode on the pre-lithiation particle layer, the anode comprising primary anode active particles (PAAPs) that each comprise silicon (Si) and carbon (C); and activating the FPLiPs, wherein: a mass ratio of the PAAPs in the anode to the FPLiPs in the pre-lithiation particle layer is in a range of about 10:1 to about 200:1.

Clause 30. The method of clause 29, wherein: the activating comprises a heat treatment and/or a pressure treatment.

Clause 31. The method of clause 30, wherein: the activating comprises the heat treatment and the heat treatment comprises subjecting at least the pre-lithiation particle layer to a temperature in a range of about 180.5° C. to about 200° C.

Clause 32. The method of any of clauses 30 to 31, wherein: the activating comprises the pressure treatment and the pressure treatment comprises subjecting the pre-lithiation particle layer to a pressure in a range of about 1 MPa to about 200 MPa.

Clause 33. The method of any of clauses 29 to 32, wherein: the activating comprises reacting at least some of the Li of the FPLiPs with at least some of the Si of the PAAPs.

Clause 34. The anode made according to the method of any of clauses 29 to 33.

Clause 35. The anode of clause 34, wherein a mass fraction of the Si in the anode is in a range of about 10 wt. % to about 60 wt. %.

Clause 36. A method of making a lithium-ion battery, the method comprising: making the anode according to the method of clause 29; providing or making a cathode on a cathode current collector; assembling a battery cell from the anode on the anode current collector and the cathode on the cathode current collector; and filling a space between the anode and the cathode with an electrolyte ionically coupling the anode and the cathode to form the lithium-ion battery.

Clause 37. The method of clause 36, further comprising: transferring ions of at least some of the Li of the FPLiPs to the PAAPs via formation cycling of the lithium-ion battery.

Clause 38. The lithium-ion battery made according to the method of any of clauses 36 to 37.

Clause 39. The lithium-ion battery of clause 38, wherein: a first-cycle coulombic efficiency of the PAAPs is about 80% or greater.

Clause 40. A method of making an anode-separator laminate, the method comprising: forming an anode on an anode current collector, the anode comprising primary anode active particles (PAAPs) that each comprise silicon (Si) and carbon (C); coating the pre-lithiation particle dispersion of clause 15 on a separator to form a separator comprising a pre-lithiation particle layer comprising the FPLiPs; laminating the anode and the separator to form the anode-separator laminate, the pre-lithiation particle layer contacting the anode; and activating the FPLiPs, wherein: a mass ratio of the PAAPs in the anode to the FPLiPs in the pre-lithiation particle layer is in a range of about 10:1 to about 200:1.

Clause 41. The method of clause 40, wherein: the activating comprises a heat treatment and/or a pressure treatment.

Clause 42. The method of clause 41 wherein: the activating comprises the heat treatment and the heat treatment comprises subjecting at least the pre-lithiation particle layer to a temperature in a range of about 180.5° C. to about 200° C.

Clause 43. The method of any of clauses 41 to 42, wherein: the activating comprises the pressure treatment and the pressure treatment comprises subjecting at least the pre-lithiation particle layer to a pressure in a range of about 1 MPa to about 200 MPa.

Clause 44. The method of any of clauses 40 to 43, wherein: the activating comprises reacting at least some of the Li of the FPLiPs with at least some of the Si of the PAAPs.

Clause 45. The anode-separator laminate made according to the method of any of clauses 40 to 44.

Clause 46. The anode-separator laminate of clause 45, wherein a mass fraction of the Si in the anode is in a range of about 10 wt. % to about 60 wt. %.

Clause 47. A method of making a lithium-ion battery, the method comprising: making the anode-separator laminate according to the method of clause 40; providing or making a cathode on a cathode current collector; assembling a battery cell from the anode-separator laminate and the cathode on the cathode current collector with the separator positioned between the anode and the cathode; and filling a space comprising the separator between the anode and the cathode with an electrolyte ionically coupling the anode and the cathode to form the lithium-ion battery.

Clause 48. The method of clause 47, further comprising: transferring ions of at least some of the Li of the FPLiPs to the PAAPs via formation cycling of the lithium-ion battery.

Clause 49. The lithium-ion battery made according to the method of any of clauses 47 to 48.

Clause 50. The lithium-ion battery of clause 49, wherein: a first-cycle coulombic efficiency of the PAAPs is about 80% or greater.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. An anode dispersion, comprising:
primary anode active particles (PAAPs) that each comprise silicon (Si) and carbon (C);
functionalized pre-lithiation particles (FPLiPs) comprising lithium (Li); and
a solvent composition in which the PAAPs and FPLiPs are dispersed;
wherein:
a mass ratio of the PAAPs to the FPLiPs is in a range of about 10:1 to about 200:1;
each of the FPLiPs comprises a core and an outer protective coating around the core, the outer protective coating comprising an oligomeric dispersant and/or a polymeric dispersant; and
a viscosity of the anode dispersion is in a range of about 1 cP to about 10,000 cP.

2. The anode dispersion of claim 1, wherein:
an average density of the FPLiPs is within about ±20% of an average density of the solvent composition.

3. The anode dispersion of claim 1, wherein:
the respective core of each of the FPLiPs comprises a non-Li element that is more dense than the Li.

4. The anode dispersion of claim 1, wherein the viscosity of the anode dispersion is in a range of about 1 cP to about 1,000 cP.

5. A method of making an anode, the method comprising:
coating the anode dispersion of claim 1 on an anode current collector to form the anode on the anode current collector; and
activating the FPLiPs.

6. The method of claim 5, wherein:
the activating comprises a heat treatment and/or a pressure treatment.

7. The method of claim 6, wherein:
the activating comprises the heat treatment and the heat treatment comprises subjecting at least the anode to a temperature in a range of about 180.5° C. to about 200° C.

8. The method of claim 6, wherein:
the activating comprises the pressure treatment and the pressure treatment comprises subjecting at least the anode to a pressure in a range of about 1 MPa to about 200 MPa.

9. The method of claim 5, wherein:
the activating comprises reacting at least some the Li of the FPLiPs with at least some of the Si of the PAAPs.

10. The anode made according to the method of claim 5.

11. The anode of claim 10, wherein a mass fraction of the Si in the anode is in a range of about 10 wt. % to about 60 wt. %.

12. A method of making a lithium-ion battery, the method comprising:
making the anode according to the method of claim 5;
providing or making a cathode on a cathode current collector; and
assembling a battery cell from the anode on the anode current collector and the cathode on the cathode current collector; and
filling a space between the anode and the cathode with an electrolyte ionically coupling the anode and the cathode to form the lithium-ion battery.

13. The method of claim 12, further comprising:
carrying out formation cycling on the lithium-ion battery,
wherein the formation cycling comprises transferring ions of at least some of the Li of the FPLiPs to the PAAPs.

14. The lithium-ion battery made according to the method of claim 12.

15. The lithium-ion battery of claim 14, wherein:
a first-cycle coulombic efficiency of the PAAPs is about 80% or greater.

16. A pre-lithiation particle dispersion, comprising:
functionalized pre-lithiation particles (FPLiPs) comprising lithium (Li); and
a solvent composition in which the FPLiPs are dispersed,
wherein:
each of the FPLiPs comprises a core and an outer protective coating around the core, the outer protective coating comprising an oligomeric dispersant and/or a polymeric dispersant; and
a viscosity of the pre-lithiation particle dispersion is in a range of about 1 cP to about 1000 cP.

17. The pre-lithiation particle dispersion of claim 16, wherein:
an average density of the FPLiPs is within about ±20% of a density of the solvent composition.

18. The pre-lithiation particle dispersion of claim 16, wherein:
the respective core of each of the FPLiPs comprises a non-Li element that is more dense than the Li.

19. A method of making an anode, the method comprising:
forming an anode on an anode current collector, the anode comprising primary anode active particles (PAAPs) that each comprise silicon (Si) and carbon (C);
coating the pre-lithiation particle dispersion of claim 16 on the anode to form a pre-lithiation particle layer comprising the FPLiPs on the anode; and
activating the FPLiPs,
wherein:
a mass ratio of the PAAPs in the anode to the FPLiPs in the pre-lithiation particle layer is in a range of about 10:1 to about 200:1.

20. The method of claim 19, wherein:
the activating comprises a heat treatment and/or a pressure treatment.

21. The method of claim 20 wherein:
the activating comprises the heat treatment and the heat treatment comprises subjecting at least the pre-lithiation particle layer to a temperature in a range of about 180.5° C. to about 200° C.

22. The method of claim 20, wherein:
the activating comprises the pressure treatment and the pressure treatment comprises subjecting at least the pre-lithiation particle layer to a pressure in a range of about 1 MPa to about 200 MPa.

23. The method of claim 19, wherein:
the activating comprises reacting at least some of the Li of the FPLiPs with at least some of the Si of the PAAPs.

24. The anode made according to the method of claim 19.

25. The anode of claim 24, wherein a mass fraction of the Si in the anode is in a range of about 10 wt. % to about 60 wt. %.

26. A method of making a lithium-ion battery, the method comprising:
making the anode according to the method of claim 19;
providing or making a cathode on a cathode current collector;
assembling a battery cell from the anode on the anode current collector and the cathode on the cathode current collector; and
filling a space between the anode and the cathode with an electrolyte ionically coupling the anode and the cathode to form the lithium-ion battery.

27. The method of claim 26, further comprising:
transferring ions of at least some of the Li of the FPLiPs to the PAAPs via formation cycling of the lithium-ion battery.

28. The lithium-ion battery made according to the method of claim 26.

29. The lithium-ion battery of claim 28, wherein:
a first-cycle coulombic efficiency of the PAAPs is about 80% or greater.

30. A method of making an anode, the method comprising:
coating the pre-lithiation particle dispersion of claim 16 on an anode current collector to form a pre-lithiation particle layer comprising the FPLiPs on the anode current collector;
coating an anode composition on the pre-lithiation particle layer to form an anode on the pre-lithiation particle layer, the anode comprising primary anode active particles (PAAPs) that each comprise silicon (Si) and carbon (C); and
activating the FPLiPs,
wherein:
a mass ratio of the PAAPs in the anode to the FPLiPs in the pre-lithiation particle layer is in a range of about 10:1 to about 200:1.

31. The method of claim 30, wherein:
the activating comprises a heat treatment and/or a pressure treatment.

32. The method of claim 31, wherein:
the activating comprises the heat treatment and the heat treatment comprises subjecting at least the pre-lithiation particle layer to a temperature in a range of about 180.5° C. to about 200° C.

33. The method of claim 31, wherein:
the activating comprises the pressure treatment and the pressure treatment comprises subjecting the pre-lithiation particle layer to a pressure in a range of about 1 MPa to about 200 MPa.

34. The method of claim 30, wherein:
the activating comprises reacting at least some of the Li of the FPLiPs with at least some of the Si of the PAAPs.

35. The anode made according to the method of claim 30.

36. The anode of claim 35, wherein a mass fraction of the Si in the anode is in a range of about 10 wt. % to about 60 wt. %.

37. A method of making a lithium-ion battery, the method comprising:
making the anode according to the method of claim 30;
providing or making a cathode on a cathode current collector;
assembling a battery cell from the anode on the anode current collector and the cathode on the cathode current collector; and
filling a space between the anode and the cathode with an electrolyte ionically coupling the anode and the cathode to form the lithium-ion battery.

38. The method of claim 37, further comprising:
transferring ions of at least some of the Li of the FPLiPs to the PAAPs via formation cycling of the lithium-ion battery.

39. The lithium-ion battery made according to the method of claim 37.

40. The lithium-ion battery of claim 39, wherein:
a first-cycle coulombic efficiency of the PAAPs is about 80% or greater.

41. A method of making an anode-separator laminate, the method comprising:
forming an anode on an anode current collector, the anode comprising primary anode active particles (PAAPs) that each comprise silicon (Si) and carbon (C);
coating the pre-lithiation particle dispersion of claim 16 on a separator to form a separator comprising a pre-lithiation particle layer comprising the FPLiPs;
laminating the anode and the separator to form the anode-separator laminate, the pre-lithiation particle layer contacting the anode; and
activating the FPLiPs,
wherein:
a mass ratio of the PAAPs in the anode to the FPLiPs in the pre-lithiation particle layer is in a range of about 10:1 to about 200:1.

42. The method of claim 41, wherein:
the activating comprises a heat treatment and/or a pressure treatment.

43. The method of claim 42 wherein:
the activating comprises the heat treatment and the heat treatment comprises subjecting at least the pre-lithiation particle layer to a temperature in a range of about 180.5° C. to about 200° C.

44. The method of claim 42, wherein:
the activating comprises the pressure treatment and the pressure treatment comprises subjecting at least the pre-lithiation particle layer to a pressure in a range of about 1 MPa to about 200 MPa.

45. The method of claim 41, wherein:
the activating comprises reacting at least some of the Li of the FPLiPs with at least some of the Si of the PAAPs.

46. The anode-separator laminate made according to the method of claim 41.

47. The anode-separator laminate of claim 46, wherein a mass fraction of the Si in the anode is in a range of about 10 wt. % to about 60 wt. %.

48. A method of making a lithium-ion battery, the method comprising:
making the anode-separator laminate according to the method of claim 41;
providing or making a cathode on a cathode current collector;
assembling a battery cell from the anode-separator laminate and the cathode on the cathode current collector with the separator positioned between the anode and the cathode; and
filling a space comprising the separator between the anode and the cathode with an electrolyte ionically coupling the anode and the cathode to form the lithium-ion battery.

49. The method of claim 48, further comprising:
transferring ions of at least some of the Li of the FPLiPs to the PAAPs via formation cycling of the lithium-ion battery.

50. The lithium-ion battery made according to the method of claim 48.

51. The lithium-ion battery of claim 50, wherein:
a first-cycle coulombic efficiency of the PAAPs is about 80% or greater.
